(19) United States
(12) Patent Application Publication
(10) Pub. No.: US 2025/0253910 A1
(43) Pub. Date: Aug. 7, 2025

(54) METHOD AND DEVICE FOR CHANNEL STATE INFORMATION REPORTING IN WIRELESS COMMUNICATION

(71) Applicant: Samsung Electronics Co., Ltd., Gyeonggi-do (KR)

(72) Inventors: Zhe CHEN, Beijing (CN); Sa ZHANG, Beijing (CN); Feifei SUN, Beijing (CN)

(21) Appl. No.: 19/046,994

(22) Filed: Feb. 6, 2025

(30) Foreign Application Priority Data
Feb. 6, 2024 (CN) 202410172109.7
Apr. 29, 2024 (CN) 202410533417.8
May 16, 2024 (CN) 202410612283.9
Aug. 8, 2024 (CN) 202411087927.3

(51) Int. Cl. H04B 7/06; H04W 24/10; H04W 72/0446

(52) U.S. Cl. CPC H04B 7/0626; H04B 7/06968; H04W 24/10; H04W 72/0446

(57) ABSTRACT

The disclosure relates to a fifth generation (5G) or sixth generation (6G) communication system for supporting a higher data transmission rate. The present disclosure provides a method and apparatus by which a channel state information (CSI) report is implemented with different parameters in a subband non-overlapping full duplex (SBFD) time domain resource and a non-SBFD time domain resource, respectively, to reduce performance degradation caused by the SBFD devices or the interference associated with the SBFD, and improve the efficiency of the communication system.

### CROSS-REFERENCE TO RELATED APPLICATION(S)

This application is based on and claims priority under 35 U.S.C. § 119 (a) to Chinese patent application numbers 202410172109.7, 202410533417.8, 202410612283.9, and 202411087927.3, filed on Feb. 6, 2024, Apr. 29, 2024, May 16, 2024, and Aug. 8, 2024, respectively, in the Chinese Patent Office, the disclosures of each of which are incorporated herein by reference in their entireties.

### BACKGROUND

### 1. Field

The disclosure relates generally to a wireless communication system, and more particularly, to a method and device for improving the performance of channel state information (CSI) for receiving and transmitting information in a wireless communication system.

### 2. Description of Related Art

5th generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands including 28 GHz and 39 GHz. It has been considered to implement 6th generation (6G) mobile communication technologies referred to as beyond 5G systems in terahertz (THz) bands (for example, 95 GHz to 3 THz bands) to realize transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave bands, supporting numerologies (e.g., operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio-unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there is ongoing standardization in air interface architecture/protocol regarding technologies, such as industrial Internet of things (IIoT), for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access (RA) channel (2-step RACH) for NR to simplify RA procedures. There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

To meet the increasing demand for wireless data communication services since the deployment of 4G communication systems, efforts have been made to develop improved 5G or pre-5G communication systems. Therefore, 5G or pre-5G communication systems are referred to as beyond 4G networks or post-long term evolution (LTE) systems.

To achieve a higher data rate, 5G communication systems are implemented in higher frequency mm Wave bands. To reduce propagation loss of radio waves and increase a transmission distance, technologies such as beamforming, MIMO, full-dimensional MIMO (FD-MIMO), array antenna, analog beamforming and large-scale antenna are discussed in 5G communication systems.

In 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc. Hybrid frequency shift keying (FSK) and quadrature amplitude modulation (QAM) modulation (FQAM) and sliding window superposition coding (SWSC) as advanced coding modulation (ACM), and filter bank multicarrier (FBMC), non-orthogonal a plurality of access (NOMA) and sparse code a plurality of access (SCMA) as advanced access technologies have been developed.

To enhance the scheduling efficiency of the 5G wireless communication system, the base station needs to obtain CSI to schedule according to the CSI fed back by the terminal equipment. There is a need in the art to further enhance the performance of CSI reporting is a problem to be solved.

### SUMMARY

The disclosure has been made to address at least the above-mentioned problems and/or disadvantages and to provide at least the advantages described below.

Accordingly, an aspect of the disclosure is to provide a method and device capable of effectively providing a service in a mobile communication system.

An aspect of the disclosure is to provide a method and apparatus that may improve the performance of CSI and the scheduling efficiency of the communication system.

An aspect of the disclosure is to provide a method and apparatus by which the CSI report is implemented with different parameters in a subband non-overlapping full duplex (SBFD) time domain resource(s) and the non-SBFD time domain resource(s), respectively, to reduce performance degradation caused by the SBFD devices or the interference associated with the SBFD, and improve the efficiency of the communication system.

In accordance with an aspect of the disclosure, a method performed by user equipment UE in a wireless communication system includes receiving configuration information for a subband non-overlapping full duplex (SBFD), the configuration information indicating SBFD time domain resources; and receiving a channel state information (CSI) reporting configuration, wherein, when a serving cell where the CSI reporting configuration is located and a first cell associated with the configuration information are in the same frequency band, parameters associated with an uplink (UL) channel for carrying CSI associated with the CSI reporting configuration are determined based on first time domain resources; or wherein, when a serving cell where a CSI resource setting associated with the CSI reporting configuration is located and the first cell are in the same frequency band, at least one of the following operations is performed based on the first time domain resources: obtain measurement result based on reference signal resource associated with the CSI resource setting; do not receive the reference signal resource associated with the CSI resource setting; and determine and/or reporting the CSI associated with the CSI reporting configuration, and wherein the first time domain resources include the SBFD time domain resources and/or non-SBFD time domain resources.

In accordance with an aspect of the disclosure, a method performed by a base station in a wireless communication system includes transmitting configuration information for a subband non-overlapping full duplex (SBFD), wherein the configuration information indicates SBFD time domain resources; transmitting a channel state information (CSI) reporting configuration; and receiving CSI determined based on the CSI reporting configuration and the configuration information, wherein, when a serving cell where the CSI reporting configuration is located and a first cell associated with the configuration information are in a same frequency band, parameters associated with an uplink (UL) channel for carrying CSI associated with the CSI reporting configuration are determined based on first time domain resources, and wherein the first time domain resources include the SBFD time domain resources and/or non-SBFD time domain resources.

### BRIEF DESCRIPTION OF THE DRAWINGS

The above and other aspects, features and advantages of the present disclosure will become more apparent from the following detailed description when taken in conjunction with the accompanying drawings, in which:

FIG. 1 illustrates a structure of a wireless communication network according to an embodiment;

FIG. 2A illustrates a transmission path in a wireless communication network according to an embodiment;

FIG. 2B illustrates a reception path in a wireless communication network according to an embodiment;

FIG. 3A illustrates the structures of a UE in a wireless communication network according to an embodiment;

FIG. 3B illustrates the structures of a base station in a wireless communication network according to an embodiment;

FIG. 4 illustrates a method performed by a UE according to an embodiment;

FIG. 5 illustrates a method performed by a base station according to an embodiment;

FIG. 6 illustrates a structure of a user equipment according to an embodiment; and

FIG. 7 illustrates a structure of a base station according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may cause the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete, and are provided to fully inform the scope of the disclosure to those of ordinary skill in the art to which the disclosure pertains. Like reference numerals refer to like components herein.

Herein, a couple refers to any direct or indirect communication between two or more elements, irrespective of whether those elements are in physical contact with one another. The terms transmit, receive, and communicate, as well as derivatives thereof, encompass both direct and indirect communication. The terms include and comprise, as well as derivatives thereof, mean inclusion without limitation, and or is inclusive, meaning and/or. The phrase associated with, as well as derivatives thereof, may also be expressed as to include, be included within, interconnect with, contain, be contained within, connect to or with, couple to or with, be communicable with, cooperate with, interleave, juxtapose, be proximate to, be bound to or with, have, have a property of, have a relationship to or with, or the like. A controller indicates any device, system or part thereof that controls at least one operation. Such a controller may be implemented in hardware or a combination of hardware and software and/or firmware. The functionality associated with any particular controller may be centralized or distributed, whether locally or remotely. The phrase at least one of, when used with a list of items, indicates that different combinations of one or more of the listed items may be used, and only one item in the list may be needed. For example, at least one of: A, B, and C includes any of A, B, C, A and B, A and C, B and C, and A and B and C.

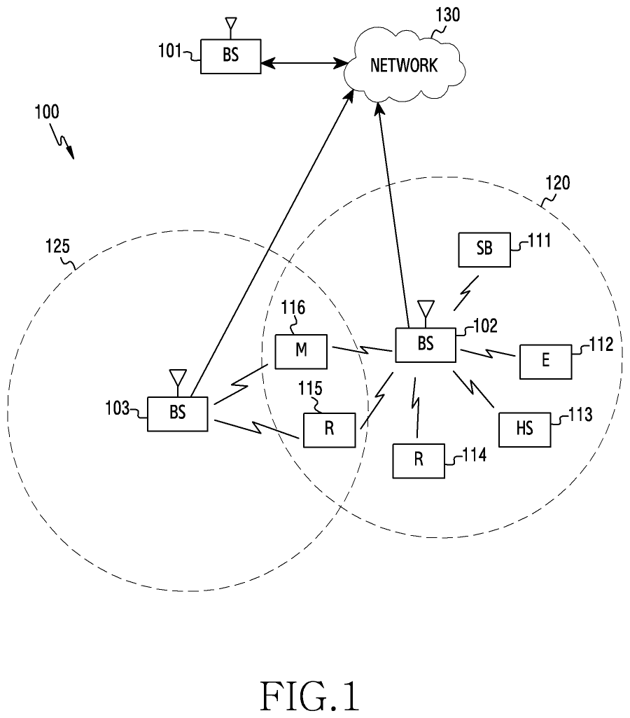

FIG. 1 illustrates a wireless network 100 according to an embodiment. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms such as base station or access point can be used instead of gNodeB or gNB. For convenience, the terms gNodeB and gNB are used in this patent document to refer to network infrastructure components that provide wireless access for remote terminals. And, depending on the type of the network, other well-known terms such as mobile station, user station, remote terminal, wireless terminal or user apparatus can be used instead of user equipment or UE. For convenience, UE is used herein to refer to remote wireless devices that wirelessly access the gNB, no matter whether the UE is a mobile device (such as a mobile or smart phone) or a fixed device (such as a desktop computer or a vending machine).

The gNB 102 provides wireless wideband access to the network 130 for a first plurality of UEs within a coverage area 120 of gNB 102. The first plurality of UEs include a UE 111, which may be located in a small business (SB), a UE 112, which may be located in an enterprise (E), a UE 113, which may be located in a WiFi Hotspot (HS), a UE 114, which may be located in a first residence (R), a UE 115, which may be located in a second residence (R), a UE 116, which may be a mobile device (M), such as a cellular phone, a wireless laptop computer, a wireless personal data assistant (PDA), etc. GNB 103 provides wireless wideband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, LTE, LTE-LTE advanced (LTE-A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on Configurations of the gNBs and changes in the radio environment associated with natural obstacles and man-made obstacles.

One or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates a of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless wideband access to the network 130 for those UEs. Similarly, each gNB 102-103 can directly communicate with the network 130 and provide direct wireless wideband access to the network 130 for the UEs. In addition, gNB 101, 102 and/or 103 can provide access to other or additional external networks, such as external telephone networks or other types of data networks.

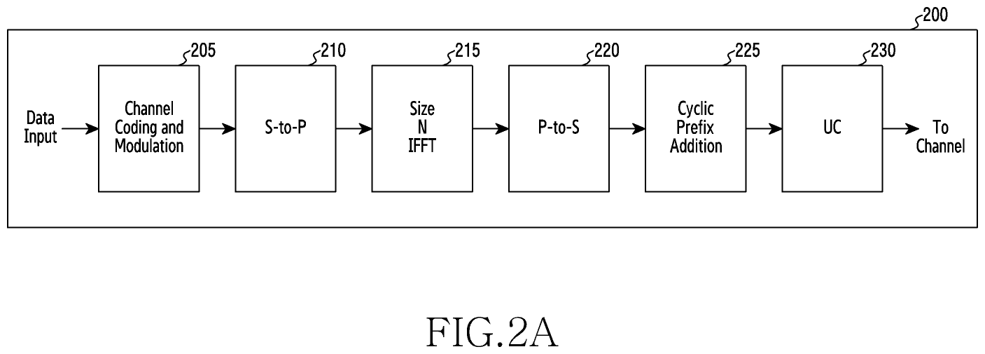

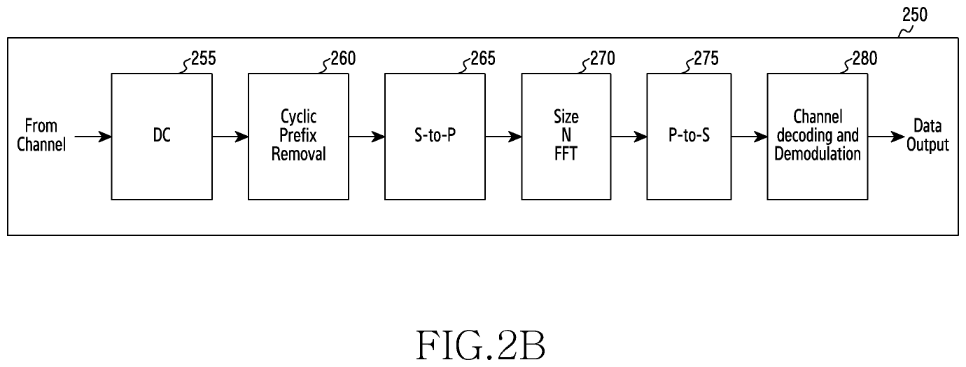

FIG. 2A illustrates a wireless transmission path according to an embodiment. FIG. 2B illustrates a wireless reception path according to an embodiment. The transmission path 200 can be described as being implemented in a gNB, such as gNB 102, and the reception path 250 can be described as being implemented in a UE, such as UE 116. However, the reception path 250 can be implemented in a gNB and the transmission path 200 can be implemented in a UE. The reception path 250 is configured to support codebook designs and structures for systems with 2D antenna arrays as described in embodiments of the present disclosure.

Referring to FIG. 2A, the transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix (CP) addition block 225, and an up-converter (UC) 230. Referring to FIG. 2B, the reception path 250 includes a down-converter (DC) 255, a CP removal block 260, an S-to-P block 265, a size N fast Fourier transform (FFT) block 270, a P-to-S block 275, and a channel decode and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or QAM) to generate a sequence of frequency-domain modulated symbols. The S-to-P block 210 converts serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The P-to-S block 220 converts parallel time domain output symbols from the Size N IFFT block 215 to generate a serial time domain signal. The CP addition block 225 inserts a CP into the time domain signal. The up-converter 230 modulates (such as up-converts) the output of the CP addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the CP removal block 260 removes the CP to generate a serial time domain baseband signal. The S-to-P block 265 converts the time domain baseband signal into a parallel time domain signal. The Size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the DL and may implement a reception path 250 similar to that for receiving from UEs 111-116 in the UL. Similarly, each of UEs 111-116 may implement a transmission path 200 for transmitting to gNBs 101-103 in the UL, and may implement a reception path 250 for receiving from gNBs 101-103 in the DL.

Each of the components in FIGS. 2A and 2B can be implemented using only hardware, or using a combination of hardware and software/firmware. As a specific example, at least some of the components in FIGS. 2A and 2B may be implemented in software, while other components may be implemented in Configurable hardware or a combination of software and configurable hardware. For example, the FFT block 270 and IFFT block 215 may be implemented as configurable software algorithms, in which the value of the size N may be modified according to the implementation.

Although described as using FFT and IFFT, this is only illustrative and should not be interpreted as limiting the scope of the present disclosure. Other types of transforms can be used, such as discrete Fourier transform (DFT) and inverse DFT (IDFT) functions, in which the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements.

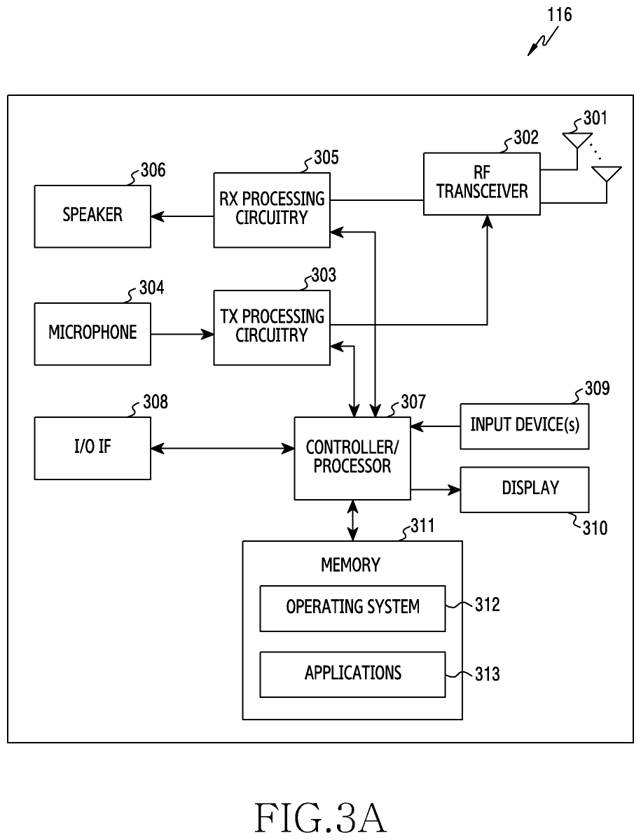

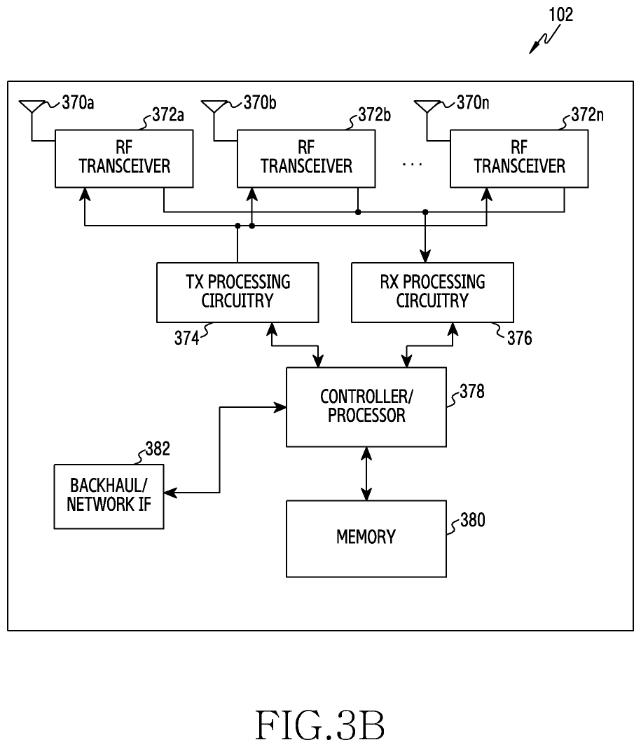

FIG. 3A illustrates a UE 116 according to an embodiment. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

Referring to FIG. 3A, the UE 116 includes an antenna 301, a radio frequency (RF) transceiver 302, a transmission (TX) processing circuit 303, a microphone 304, and a reception (RX) processing circuit 305. UE 116 also includes a speaker 306, a controller/processor 307, an input/output (I/O) interface (IF) 308, an input device(s) 309, a display 310, and a memory 311. The memory 311 includes an operating system (OS) 312 and one or more applications 313.

The RF transceiver 302 receives an incoming RF signal transmitted by a gNB of the wireless network 100 from the antenna 301. The RF transceiver 302 down-converts the incoming RF signal to generate an intermediate frequency (IF) or baseband signal. The IF or baseband signal is transmitted to the RX processing circuit 305, where the RX processing circuit 305 generates a processed baseband signal by filtering, decoding and/or digitizing the baseband or IF signal. The RX processing circuit 305 transmits the processed baseband signal to speaker 306 (such as for voice data) or to controller/processor 307 for further processing (such as for web browsing data).

The TX processing circuit 303 receives analog or digital voice data from microphone 304 or other outgoing baseband data (such as network data, email or interactive video game data) from controller/processor 307. The TX processing circuit 303 encodes, multiplexes, and/or digitizes the outgoing baseband data to generate a processed baseband or IF signal. The RF transceiver 302 receives the outgoing processed baseband or IF signal from the TX processing circuit 303 and up-converts the baseband or IF signal into an RF signal transmitted via the antenna 301.

The controller/processor 307 can include one or more processors or other processing devices and execute an OS 312 stored in the memory 311 to control the overall operation of UE 116. For example, the controller/processor 307 can control the reception of forward channel signals and the transmission of backward channel signals through the RF transceiver 302, the RX processing circuit 305 and the TX processing circuit 303 according to well-known principles. The controller/processor 307 includes at least one microprocessor or microcontroller.

The controller/processor 307 is also capable of executing other processes and programs residing in the memory 311, such as operations for channel quality measurement and reporting for systems with 2D antenna arrays as described in embodiments of the present disclosure. The controller/processor 307 can move data into or out of the memory 311 as required by an execution process. The controller/processor 307 is configured to execute the application 313 based on the OS 312 or in response to signals received from the gNB or the operator. The controller/processor 307 is also coupled to an I/O interface 308, where the I/O interface 308 provides UE 116 with the ability to connect to other devices such as laptop computers and handheld computers. I/O interface 308 is a communication path between these accessories and the controller/processor 307.

The controller/processor 307 is also coupled to the input device(s) 309 and the display 310. An operator of UE 116 can input data into UE 116 using the input device(s) 309. The display 310 may be a liquid crystal display or other display capable of presenting text and/or at least limited graphics (such as from a website). The memory 311 is coupled to the controller/processor 307. A part of the memory 311 can include a random access memory (RAM), while another part of the memory 311 can include a flash memory or other read-only memory (ROM).

Although FIG. 3A illustrates a of UE 116, various changes can be made to FIG. 3A. For example, various components in FIG. 3A can be combined, further subdivided or omitted, and additional components can be added according to specific requirements. As a specific example, the controller/processor 307 can be divided into a plurality of processors, such as one or more central processing units and one or more graphics processing units (GPUs). Although FIG. 3A illustrates that the UE 116 is configured as a mobile phone or a smart phone, UEs can be configured to operate as other types of mobile or fixed devices.

FIG. 3B illustrates a gNB 102 according to an embodiment. The gNB 102 shown in FIG. 3B is for illustration only, and other gNBs of FIG. 1 can have the same or similar configuration. However, a gNB has various Configurations, and gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. One or more of the plurality of antennas 370a-370n includes a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by the UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-converts the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in gNB 102. The controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with two-dimensional (2D) antenna arrays as described in embodiments of the present disclosure. The controller/processor 378 supports communication between entities such as web real-time communications (RTCs). The controller/processor 378 can move data into or out of the memory 380 as required by an execution process.

The controller/processor 378 is also coupled to the backhaul or network interface 382. The backhaul or network interface 382 enables the gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can enable the gNB 102 to communicate with other gNBs through wired or wireless backhaul connections. When gNB 102 is implemented as an access point, the backhaul or network interface 382 can enable the gNB 102 to communicate with a greater network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. A plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

The transmission and reception paths of gNB 102 (implemented using RF transceivers 372a-372n, TX processing circuit 374 and/or RX processing circuit 376) support aggregated communication with frequency division duplex (FDD) and time division duplex (TDD) cells.

Although FIG. 3B illustrates a gNB 102, various changes may be made to FIG. 3B. For example, gNB 102 can include any number of each component shown in FIG. 3A. For example, the access point can include many backhaul or network interfaces 382, and the controller/processor 378 can support routing functions to route data between different network addresses. Although shown as including a single instance of the TX processing circuit 374 and a single instance of the RX processing circuit 376, gNB 102 can include a plurality of instances of each (such as one for each RF transceiver).

Herein, CSI reporting configuration may be used interchangeably with the terms CSI reporting configuration information and information for CSI reporting configuration and information for configuring CSI report. Herein, CSI may be used interchangeably with the terms CSI parameter or CSI quantity. Herein, mapping order of CSI may be used interchangeably with the terms order of CSI or order of CSI information bits or order of CSI field. Herein, CSI transmission occasion may be used interchangeably with CSI reference signal (CSI-RS) occasion. Herein, CSI interference measurement (CSI-IM) occasion may be used interchangeably with CSI-IM transmission occasion. The CSI may include at least one of the following:
CSI-RS resource indicator (CRI);
Rank indicator (RI);
Precoding matrix indicator (PMI);
Channel quality indicator (CQI);
Layer indicator (LI);
Synchronization signal/physical broadcast channel (SSB) block resource indicator (SSBRI);
Layer 1—reference signal received power (L1-RSRP);
Layer 1—Signal to interference and noise ratio (L1-SINR);
CapabilityIndex.

In some cases, the base station may enhance the coverage of the communication system or reduce the latency through duplex, which may include subband non-overlapping full duplex (SBFD). For example, SBFD mode may be adopted in a TDD frequency band (for example, in an unpaired spectrum). Subband non-overlapping duplex may refer to dividing the bandwidth (e.g., carrier bandwidth) of a communication node (e.g., a base station) into more than one subband (e.g., without overlapping between subbands), and UL and DL communication may be performed simultaneously on different subbands.

Herein, SBFD configuration information may be used interchangeably with configuration information for SBFD, and subband non-overlapping duplex may be used interchangeably with subband full duplex.

Herein, frequency domain resource corresponding to UL subband may be used interchangeably with frequency domain position corresponding to UL subband, frequency domain resource of UL subband, frequency domain resource for UL, frequency domain position for UL, frequency domain position for UL transmission or frequency domain position for UL transmission.

Herein, frequency domain resource corresponding to DL subband may be used interchangeably with the terms frequency domain position corresponding to DL subband, frequency domain resource of DL subband, frequency domain resource for DL, frequency domain position for DL, frequency domain position for DL reception or frequency domain position for DL reception.

Herein, frequency domain resource corresponding to guardband may be used interchangeably with the terms frequency domain position corresponding to guardband, frequency domain resource of guardband, frequency domain resource between (boundaries of) UL and DL subbands, frequency domain position between (boundaries of) UL and DL subbands or frequency domain resource for protecting/isolating UL subband and DL subband.

A TDD configuration information may be used interchangeably with TDD UL/downlink configuration information or information for configuring slot format.

The frequency domain resource(s) may include/correspond to several frequency domain units. The frequency domain unit may be at least one of a subcarrier, a carrier, a frequency band, a frequency range (FR), a cell, and a serving cell, and the frequency domain unit is not limited by the disclosure. The frequency range may be frequency range 1, frequency range 2 (for example, frequency range 2-1 and/or frequency range 2-2).

A time domain unit may be at least one of a symbol, a sub-slot, a slot, a subframe, a frame, a millisecond, and a second.

The term BWP may be used interchangeably with active BWP and BWP on SBFD cell.

SBFD cell may be used interchangeably with first cell, but the name of SBFD cell is not limited thereto.

Determining measurement may be determining the result of the measurement, or obtaining the result of the measurement, or obtaining the measurement based on the reference signal, or obtaining the measurement based on measurement resources, or obtaining the measurement for determining CSI.

Determining channel measurement may be determining the result of the channel measurement, or obtaining the result of the channel measurement, or obtaining the channel measurement based on the reference signal, or obtaining the channel measurement based on measurement resources, or obtaining the channel measurement for determining CSI.

Determining interference measurement may be determining the result of the interference measurement, or obtaining the result of the interference measurement, or obtaining the interference measurement based on the reference signal, or obtaining the interference measurement based on measurement resources, or obtaining the interference measurement for determining CSI.

UL channel associated with CSI report may be used interchangeably with uplink channel associated with/corresponding to CSI report or uplink channel carrying CSI report.

SBFD cell may be used interchangeably with SBFD serving cell.

The UE may receive/obtain/be configured with SBFD configuration information. The UE may receive/obtain/be configured with the SBFD configuration information via common signaling (e.g., common radio link control (RRC) signaling) or specific signaling (e.g., specific RRC signaling). The SBFD configuration information may be configuration information associated with the SBFD. For example, the SBFD configuration information may be configuration information for the SBFD. For example, the SBFD configuration information may be configuration information associated with SBFD operation (of the base station). For example, the SBFD configuration information may be configuration information for indicating time domain resource(s) and/or frequency domain resource(s) associated with the SBFD operation. The UE receives the SBFD configuration information in RRC_CONNECTED state. The UE may receive the SBFD configuration information in RRC_IDLE/RRC_INACTIVE state.

Alternatively, a serving cell corresponding to/associated with the SBFD configuration information/where the SBFD configuration information is located/for may be an SBFD cell.

The cell corresponding to/associated with the SBFD configuration information may be a cell that performs the SBFD operation associated with the SBFD configuration. The cell corresponding to/associated with the SBFD configuration information may be a primary cell (PCell) or a special cell (SpCell). The cell corresponding to/associated with the SBFD configuration information may be a secondary cell (SCell). The cell corresponding to/associated with the SBFD configuration information may be a cell where the time domain resource(s) and/or frequency domain resource(s) associated with the SBFD configuration information are located/correspond to. The cell corresponding to/associated with the SBFD configuration information may be a cell where time domain resource configuration and/or frequency domain resource configuration associated with the SBFD configuration information are applied/used.

The SBFD configuration information may indicate/correspond to/be associated with frequency domain resource(s) and/or (corresponding/associated) time domain resource(s). The time domain resource(s) corresponding to/associated with the frequency domain resource(s) refers to the time domain resource(s) on which the frequency domain resource(s) configured by the SBFD configuration information is applicable/effective/workable. The time domain resource(s) corresponding to/associated with the frequency domain resource(s) refers to the time domain resource(s) on which the frequency domain resource(s) configured by the SBFD configuration information is applicable/usable (by the UE).

The SBFD configuration information may indicate the frequency domain resource(s) (associated with/corresponding to SBFD time domain resource(s)). The frequency domain resource(s) indicated by/configured by/associated with the SBFD configuration information may be called SBFD frequency domain resource(s). The SBFD configuration information may indicate at least one of frequency domain resource(s) corresponding to the UL subband, frequency domain resource(s) corresponding to the DL subband(s), and frequency domain resource(s) corresponding to the guardband. The SBFD frequency domain resource(s) may include at least one of frequency domain resource(s) corresponding to a UL subband, frequency domain resource(s) corresponding to DL subband(s), and frequency domain resource(s) corresponding to the guardband(s). The frequency domain resource(s) corresponding to the UL subband may include one or more consecutive PRBs, or a group of consecutive PRBs. The frequency domain resource(s) corresponding to the DL subband(s) may include one or more PRBs, or one or two groups of consecutive PRBs. The frequency domain resource(s) corresponding to the guardband may include one PRB or a group of consecutive PRBs or two groups of consecutive PRBs. The UL subband may be a subband for UL (e.g., UL transmission. The UL subband may be frequency domain resource(s) for UL transmission. The DL subband(s) may be a subband for DL reception. The DL subband(s) may be frequency domain resource(s) for DL reception. The UE may determine the frequency domain resource(s) corresponding to the guardband based on the frequency domain resource(s) corresponding to the UL subband and/or the frequency domain resource(s) corresponding to the DL subband(s) (and the carrier bandwidth of the SBFD cell). The UE may determine the frequency domain resource(s) corresponding to the DL subband(s) based on the frequency domain resource(s) corresponding to the UL subband and/or the frequency domain resource(s) corresponding to the guardband (and the carrier bandwidth of the SBFD cell). The frequency domain resource(s) corresponding to the DL subband(s) may include one or more PRBs, or one or two groups of consecutive PRBs.
The SBFD frequency domain resource(s) are determined based on the SBFD configuration information and a reference subcarrier spacing parameter indicated by TDD configuration information (for example, the reference subcarrier spacing parameter referenceSubcarrierSpacing included in the TDD configuration information). For example, the SBFD frequency domain resource(s) are determined based on (a parameter associated with the frequency domain resource(s) indicated by) the SBFD configuration information and the reference subcarrier spacing parameter (for example, referenceSubcarrierSpacing) included in the TDD configuration information (for the cell). This method may reuse the parameter indicated by the TDD configuration information to determine the SBFD frequency domain resource(s), thus saving signaling overhead and improving the efficiency of the communication system.
The SBFD frequency domain resource(s) are determined based on the reference subcarrier spacing parameter indicated by the SBFD configuration information (for example, the reference subcarrier spacing parameter included in the SBFD configuration information). For example, the SBFD time domain resource(s) are determined based on the reference subcarrier spacing parameter (e.g., referenceSubcarrierSpacing) included in the SBFD configuration information. This method may use the SBFD configuration information to determine the SBFD frequency domain resource(s), to facilitate the base station to perform the SBFD operation flexibly and improve the efficiency of the communication system.

On the SBFD time domain resource(s), the part of the UL BWP in the frequency domain resource(s) corresponding to the UL subband associated with the SBFD frequency domain resource(s) may be/is allowed for UL transmission. Optionally, on the SBFD time domain resource(s), the part of the UL BWP not in the frequency domain resource(s) corresponding to the UL subband associated with the SBFD frequency domain resource(s) may not be/is not allowed for UL transmission. This method clarifies scheduling restrictions based on the SBFD configuration, to facilitate the base station to schedule flexibly and improve the efficiency of the communication system.

On the SBFD time domain resource(s), the part of the DL BWP in the frequency domain resource(s) corresponding to the DL subband(s) associated with the SBFD frequency domain resource(s) may be/is allowed for DL reception. Optionally, on the SBFD time domain resource(s), the part of the DL BWP not in the frequency domain resource corresponding to the DL subband(s) associated with the SBFD frequency domain resource(s) may not be/is not allowed for DL reception. This method clarifies scheduling restrictions based on the SBFD configuration, to facilitate the base station to schedule flexibly and improve the efficiency of the communication system.

The SBFD configuration information may indicate/configure/be associated with the time domain resource(s). The time domain resource(s) indicated by/configured by/associated with the SBFD configuration information may be called the SBFD time domain resource(s). Time domain resource(s) other than SBFD time domain resource(s) (or a part of time domain resource(s) other than SBFD time domain resource(s)) may be called the non-SBFD time domain resource(s); Time domain resource(s) that are not the SBFD time domain resource(s) may be called the non-SBFD time domain resource(s); The time domain resource(s) outside the SBFD time domain resource(s) and within the DL slots/symbols and/or flexible slots/symbols indicated/configured by the base station are called the non-SBFD time domain resource(s), or the time domain resource(s) within the UL slots/symbols indicated/configured by the base station are called the non-SBFD time domain resource(s). The SBFD time domain resource(s) may include several time domain units. The SBFD time domain resource(s) are not on the UL slots and/or UL symbols indicated by the common information. The SBFD time domain resource(s) are on the DL slots and/or DL symbols indicated by the base station, and/or the SBFD time domain resource(s) are on the flexible slots and/or flexible symbols indicated/configured by the base station. The non-SBFD time domain resource(s) are not on the UL slots or UL symbols indicated by the common information. The non-SBFD time domain resource(s) are on the DL slots and/or DL symbols indicated by the base station, and/or the non-SBFD time domain resource(s) are on the flexible slots and/or flexible symbols indicated/configured by the base station. The UE may obtain at least one of the UL symbols, UL slots, DL symbols, DL slots, flexible symbols and flexible slots indicated by the base station via the TDD configuration information. The TDD configuration information includes: cell specific TDD configuration information (for example, tdd-UL-DL-ConfigurationCommon) and/or UE-specific TDD configuration information (tdd-UL-DL-ConfigurationDedicated).

The SBFD time domain resource(s) are determined based on the SBFD configuration information and the reference subcarrier spacing parameter indicated by the TDD configuration information (for example, the reference subcarrier spacing parameter referenceSubcarrierSpacing included in the TDD configuration information). For example, the SBFD time domain resource(s) are determined based on (the parameter associated with the time domain resource(s) indicated by) the SBFD configuration information and the reference subcarrier spacing parameter (for example, referenceSubcarrierSpacing) included in the TDD configuration information (for the cell). This method can reuse the parameter indicated by the TDD configuration information to determine the SBFD time domain resource(s), thus saving signaling overhead and improving the efficiency of the communication system.

The SBFD time domain resource(s) are determined based on the reference subcarrier spacing parameter indicated by the SBFD configuration information (for example, the reference subcarrier spacing parameter referenceSubcarrierSpacing included in the SBFD configuration information). For example, the SBFD time domain resource(s) are determined based on the reference subcarrier spacing parameter (e.g., referenceSubcarrierSpacing) included in the SBFD configuration information. This method may use the SBFD configuration information to determine the SBFD time domain resource(s), to facilitate the base station to perform SBFD operation flexibly and improve the efficiency of the communication system.

On a BWP, if a symbol/slot partially overlaps with the SBFD time domain resource(s), the symbol/slot may not be used/allowed for transmission/reception. Optionally, on a BWP, if a symbol/slot completely overlaps with the SBFD time domain resource(s), the symbol/slot may be used/allowed for transmission/reception. This method clarifies scheduling restrictions based on the SBFD configuration, to facilitate the base station to schedule flexibly and improve the efficiency of the communication system.

Herein, CSI may be used interchangeably with CSI value, SBFD time resources may be used interchangeably with SBFD time resources, and CSI resource setting associated with CSI reporting configuration may be used interchangeably with CSI resource setting corresponding to CSI reporting configuration, resources associated with CSI reporting configuration, measurement associated with CSI reporting configuration, measurement resources associated with CSI reporting configuration, resources for channel measurement and/or interference measurement associated with CSI reporting configuration, resources for channel measurement associated with CSI reporting configuration, resources associated with CSI resource setting, reference signal resource associated with CSI resource setting, resources in resource set associated with CSI resource setting, reference signal resource in resource set associated with CSI resource setting or reference signal resource in resource set associated with CSI reporting configuration.

Herein, cell discontinuous transmission (DTX) is activated may be used interchangeably with cell DTX is configured or cell DTX is configured and/or activated. Quasi-co-location (QCL) parameter may be used interchangeably with transmission configuration indication (TCI) state, QCL assumption or QCL type D parameter. Herein, L1-RSRP may be used interchangeably with L1-RSRP value, and discontinuous reception (DRX) may be used interchangeably with UE DRX or connected state DRX (C-DRX).

Herein, reference signal resource may be used interchangeably with reference signal, reference signal occasion or reference signal resource occasion. The reference signal may be at least one of CSI-RS, CSI-IM, SSB, non-zero power (NZP) CSI-RS, CSI-IM and SSB.

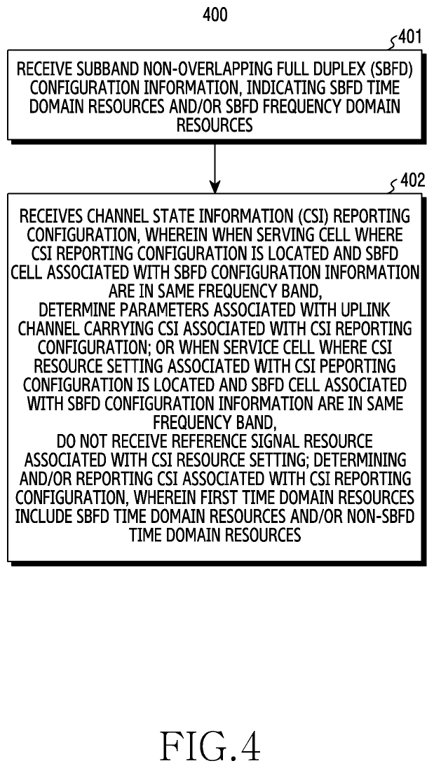

FIG. 4 illustrates a method 400 performed by a UE according to an embodiment. Referring to FIG. 4, in step 401, the UE receives SBFD configuration information from a base station, wherein the SBFD configuration information indicates SBFD time domain resource(s) and/or SBFD frequency domain resource(s). In step 402, the UE receives a CSI reporting configuration from the base station, wherein when a serving cell where the CSI reporting configuration is located and a SBFD cell associated with the SBFD configuration information are in the same frequency band, performing the following operation based on first time domain resource(s): determining parameters associated with a UL channel carrying CSI associated with the CSI reporting configuration, or when a serving cell where CSI resource setting associated with the CSI reporting configuration is located and the SBFD cell associated with the SBFD configuration information are in the same frequency band, performing at least one of the following operations based on the first time domain resource(s): do not receive reference signal resource associated with the CSI resource setting, and determining and/or reporting the CSI associated with the CSI reporting configuration, wherein the first time domain resource(s) include the SBFD time domain resource(s) and/or the non-SBFD time domain resource(s).

The UE may receive/be configured with the CSI reporting configuration (e.g., CSI-ReportConfig), wherein the CSI reporting configuration may be associated with one or more CSI resource settings (e.g., CSI-ResourceConfig). The CSI resource setting may include CSI resource setting for channel measurement and/or CSI resource setting for interference measurement. The CSI resource setting may correspond to/include/be associated with one or more resource sets such as CSI-RS resources, CSI-IM resources and SSB resources. The resource set may include several resources. The resource set may include/correspond to at least one of CSI-RS resources, CSI-IM resources and SSB resources. For example, the UE may determine and/or report the CSI associated with the CSI reporting configuration based on the measurement of the resources associated with the CSI resource setting associated with the CSI reporting configuration. For example, the UE may determine and/or report the CSI associated with the CSI reporting configuration based on the measurement of the resources in the resource set associated with the CSI reporting configuration.

In some cases, the UE may be configured with several serving cells. One/each of the several serving cells may be configured with the CSI reporting configuration. The serving cell where the UE transmits a CSI report is the same as the serving cell where the CSI reporting configuration corresponding to the CSI report is located. For example, if the UE intends to transmit the CSI report on a serving cell, the UE determines the CSI report based on the CSI reporting configuration associated with the serving cell. The serving cell where the UE transmits the CSI report is the same as the frequency domain unit corresponding to the serving cell where the CSI reporting configuration corresponding to the CSI report is located. For example, if the UE intends to transmit the CSI report on a serving cell, the UE determines the CSI report based on the CSI reporting configuration in the frequency domain unit (e.g., frequency band) associated with the serving cell. When the serving cell where the CSI reporting configuration (or the CSI report corresponding to the CSI reporting configuration) is located and the SBFD cell are in the same frequency domain unit, the CSI report may be affected by SBFD operation. For example, on the SBFD time domain resource(s) and the non-SBFD time domain resource(s), corresponding interference caused by SBFD is different or components performing SBFD operation are different. Thus, corresponding transmission/reception parameters are required to overcome the interference or adapt the components performing SBFD operation. The method disclosed below may implement the CSI report with different parameters in the SBFD time domain resource(s) and the non-SBFD time domain resource(s), respectively, to reduce performance degradation caused by the SBFD devices or the interference associated with the SBFD, and improve the efficiency of the communication system. Herein, if two cells are in the same frequency band, they may be considered as corresponding to two cells in an intra-band carrier aggregation.

A method for the UE to determine and/or report the CSI based on the CSI reporting configuration and/or determine the parameters associated with the UL channel carrying the CSI report corresponding to/associated with the CSI reporting configuration will be discussed below when the CSI reporting configuration (or the CSI report corresponding to the CSI reporting configuration) is in the SBFD cell, the serving cell where the CSI reporting configuration (or the CSI report corresponding to the CSI reporting configuration) is located and the SBFD cell are in the same frequency domain unit, or when the serving cell where the UE transmits the CSI report (or, the UL channel carrying the CSI report) and the SBFD cell are in the same frequency unit. For example, when the serving cell where the CSI reporting configuration is located (or the serving cell where the CSI report associated with the CSI reporting configuration is located) and the SBFD cell are in the same frequency domain unit, the UE determines the parameters associated with the UL channel carrying the CSI report corresponding to the CSI reporting configuration based on the first time domain resource(s) associated with the SBFD time domain resource(s). The first time domain resource(s) may be/may include one of the following: the SBFD time domain resource(s) and/or the non-SBFD time domain resource(s), refer above for definitions of the SBFD time domain resource(s) and the non-SBFD time domain resource(s). The UE may determine that the first time domain resource(s) are at least one of the SBFD time domain resource(s) and the non-SBFD time domain resource(s) based on the UL channel associated with the CSI report. For example, when the UL channel associated with/corresponding to the CSI report is in the SBFD time domain resource(s), the first time domain resource(s) are the SBFD time domain resource(s). For example, when the UL channel associated with the CSI report is in the non-SBFD time domain resource(s), the first time domain resource(s) are the non-SBFD time domain resource(s). Specifically, the base station indicates/configures, to the UE, the UL channel to be used to carry the CSI report associated with/corresponding to the CSI reporting configuration, determines specific content of the first time domain resource(s) (i.e., the first time domain resource(s) being the SBFD time domain resource(s) and/or the non-SBFD time domain resource(s)) based on the configured/indicated UL channel (e.g., the type of the UL channel or the time domain position corresponding to the UL channel), and then determines that the parameters of the UL channel for carrying the CSI report will be applied in reporting the CSI based on the determined first time domain resource(s). The UE may receive two configurations or two groups of configurations from the base station, wherein the two configurations or two groups of configurations are respectively for the case that the first time domain resource(s) are the SBFD time domain resource(s) and for the case that the first time domain resource(s) are the non-SBFD time domain resource(s).

When the CSI reporting configuration corresponds to periodic CSI report, or semi-persistent CSI report on the physical UL control channel (PUCCH), or corresponding CSI report is on the PUCCH, or a report configuration type parameter reportConfigType included in the CSI reporting configuration is set to periodic or semi-persistent, the CSI reporting configuration may include two groups of parameters/two parameters for indicating PUCCH (transmission). For example, the first group of parameters/first parameter is for the first time domain resource(s) being the SBFD time domain resource(s). For example, the second group of parameters/second parameter is for the first time domain resource(s) being the non-SBFD time domain resource(s). When the PUCCH corresponding to the CSI report corresponding to the CSI reporting configuration is to be transmitted on the SBFD time domain resource(s), the parameter(s) of the PUCCH (transmission) may be the first group of parameters/first parameter or is determined to be the first group of parameters/first parameter. When the PUCCH corresponding to the CSI report corresponding to the CSI reporting configuration is to be transmitted on the non-SBFD time domain resource(s), the parameter(s) of the PUCCH (transmission) may be the second group of parameters/second parameter or is determined to be the second group of parameters/second parameter. The parameter(s) associated with the PUCCH (transmission) includes/corresponds to at least one of the following: a power parameter/uplink power control parameter (for example, p0alpha) for the PUCCH (transmission), a QCL parameter for the PUCCH (transmission), a frequency hopping parameter for the PUCCH (transmission), and a parameter for indicating the PUCCH resources corresponding to/used by the PUCCH (transmission) (e.g., pucch-CSI-ResourceList). Because the strongness of interference on the SBFD time domain resource(s) and the non-SBFD time domain resource(s) may be different, using different parameters on the SBFD time domain resource(s) and the non-SBFD time domain resource(s) may be for different interference on the SBFD time domain resource(s) and the non-SBFD time domain resource(s), and improve the performance of the UL transmission.

When the CSI reporting configuration corresponds to semi-persistent CSI report on the PUSCH, or the CSI report corresponding to the CSI reporting configuration is on the PUSCH, or the report configuration type parameter reportConfigType included in the CSI reporting configuration is set to semiPersistentOnPUSCH, the CSI reporting configuration may include two groups of parameters/two parameters for indicating the PUSCH (transmission). For example, the first group of parameters/first parameter may be for the first time domain resource(s) being the SBFD time domain resource(s), and the second group of parameters/second parameter may be for the first time domain resource(s) being the non-SBFD time domain resource(s). When the PUSCH corresponding to the CSI report corresponding to the CSI reporting configuration is to be transmitted on the SBFD time domain resource(s), the parameter(s) of the PUSCH (transmission) is the first group of parameters/first parameter or is determined to be the first group of parameters/first parameter. When the PUSCH corresponding to the CSI report corresponding to the CSI reporting configuration is to be transmitted on the non-SBFD time domain resource(s), the parameter(s) of the PUSCH (transmission) is the second group of parameters/second parameter or is determined to be the second group of parameters/second parameter. The parameter(s) associated with PUSCH includes at least one of a power parameter (e.g., p0alpha) for the PUSCH (transmission), a QCL parameter for the PUSCH (transmission), a frequency hopping parameter for the PUSCH (transmission), and a parameter for indicating the PUSCH resources corresponding to/used by the PUSCH (transmission). Because the interference intensity on the SBFD time domain resource(s) and the non-SBFD time domain resource(s) may be different, using different parameters on the SBFD time domain resource(s) and the non-SBFD time domain resource(s) may be for different interference on the SBFD time domain resource(s) and the non-SBFD time domain resource(s), and improve the performance of the UL transmission.

The above determination method for determining the parameters of the UL channel carrying the CSI report takes the UL channel carrying the CSI report as an example, and the disclosure is not limited thereto, for example, this method may be for determining the parameters associated with UL signals (for example, sounding reference signal (SRS), demodulation reference signal (DM-RS) of the PUSCH, DM-RS of the PUCCH, phase tracking reference signal (PT-RS) and reference signal for positioning) and/or UL channels (for example, PUSCH, PUCCH, physical random access channel (PRACH)). For example, this method may be for determining the parameters of DL signals (for example, SSB, DM-RS of the PDSCH, DM-RS of the PDCCH, PT-RS, reference signal for positioning) and/or DL channels (for example, PDSCH, PDCCH, physical broadcast channel (PBCH)).

In some cases, the UE may be configured with several serving cells. One/each of the several serving cells may be configured with the CSI resource setting. The cell where the CSI reporting configuration is located and the cell where the CSI resource setting associated with the CSI reporting configuration is located may be the same or different. The CSI reporting configuration may include a higher-layer parameter carrier for indicating the cell where the associated CSI resource setting is located. The UE may determine the cell where the corresponding measurement resources are located based on the higher-layer parameter carrier included in the CSI reporting configuration. The UE may determine which cell to perform measurement on based on the higher-layer parameter carrier that may be included in the CSI reporting configuration. When the CSI reporting configuration does not include the higher-layer parameter carrier, the cell where the corresponding/associated CSI resource setting is located is the same as the cell where the CSI reporting configuration is located. When the CSI reporting configuration does not include the higher-layer parameter carrier, the associated CSI resource setting is in the cell where the CSI reporting configuration is located. The UE generally needs to determine the cell where the CSI resource setting associated with the CSI reporting configuration is located. When the cell where the CSI resource setting associated with the CSI reporting configuration is located is the SBFD cell, or when the cell where the CSI resource setting associated with the CSI reporting configuration is located and the SBFD cell are in the same frequency domain unit, CSI measurement and/or CSI reporting associated with the CSI resource setting may be affected by SBFD operation of the base station. Corresponding methods are required to optimize CSI-related processes, thereby improving the reliability of the communication system.

A method for the UE to measure the CSI and/or determine the CSI and/or report the CSI based on the CSI reporting configuration when the CSI reporting configuration is in the SBFD cell, or the CSI resource setting associated with the CSI reporting configuration and the SBFD cell are in the same frequency domain unit will be discussed below. When a first condition is satisfied, the method for the UE to measure CSI and/or determine CSI and/or report the CSI based on the CSI reporting configuration is performed, wherein the first condition includes at least one of the CSI reporting configuration is in the SBFD cell, the CSI resource setting associated with the CSI reporting configuration is in the SBFD cell, the serving cell where the CSI reporting configuration is located and the SBFD cell are in the same frequency domain unit, and the serving cell where the CSI resource setting associated with the CSI reporting configuration is located and the SBFD cell are in the same frequency domain unit. The UE performs at least one of the following operations based on the first time domain resource(s) that may be associated with the SBFD time domain resource(s):
Step 1: obtain the measurement based on the reference signal associated with the CSI resource setting;
Step 2: do not receive (i.e., refrain from receiving) the reference signal associated with the CSI resource setting;
Step 3: determine and/or reporting the CSI based on the CSI reporting configuration.

When the serving cell where (the CSI resource setting associated with) the CSI reporting configuration is located and the SBFD cell are in the same frequency domain unit, the UE performs at least one of steps 1, 2 and 3 based on the first time domain resource(s) associated with the SBFD time domain resource(s). The first time domain resource(s) may be/may include the SBFD time domain resource(s) and/or the non-SBFD time domain resource(s). For example, the first time domain resource(s) may be at least one of the SBFD time domain resource(s) and the non-SBFD time domain resource(s).

The UE may determine that the first time domain resource(s) are at least one of the SBFD time domain resource(s) and the non-SBFD time domain resource(s) based on the UL channel associated with the CSI report. For example, when the UL channel associated with/corresponding to the CSI report is in the SBFD time domain resource(s), the first time domain resource(s) are the SBFD time domain resource(s). When the UL channel associated with the CSI report is in the non-SBFD time domain resource(s), the first time domain resource(s) are the non-SBFD time domain resource(s). When the UL channel associated with the CSI report is in the SBFD time domain resource(s) and in the non-SBFD time domain resource(s), the first time domain resource(s) are the SBFD time domain resource(s). When the UL channel associated with the CSI report is in the SBFD time domain resource(s) and in the non-SBFD time domain resource(s), the first time domain resource(s) are the non-SBFD time domain resource(s). When the UL channel associated with the CSI report is in the SBFD time domain resource(s) and in the non-SBFD time domain resource(s), the UE determines that the first time domain resource(s) are the SBFD time domain resource(s) or the non-SBFD time domain resource(s) based on the number of slots/symbols of the UL channel in the SBFD time domain resource(s) and the number of slots/symbols of the UL channel in the non-SBFD time domain resource(s). When the UL channel associated with the CSI report is in the SBFD time domain resource(s) and in the non-SBFD time domain resource(s), the first time domain resource(s) are the SBFD time domain resource(s) if the number of slots/symbols of the time domain resource(s) in the SBFD time domain resource(s) are greater than or equal to the number of slots/symbols of the time domain resource(s) of the UL channel in the non-SBFD time domain resource(s). When the UL channel associated with the CSI report is in the SBFD time domain resource(s) and in the non-SBFD time domain resource(s), the first time domain resource(s) are the non-SBFD time domain resource(s) if the number of slots/symbols of the time domain resource(s) in the SBFD time domain resource(s) is less than the number of slots/symbols of the time domain resource(s) of the UL channels in the non-SBFD time domain resource(s). When the UL channel associated with the CSI report is in the SBFD time domain resource(s) and in the non-SBFD time domain resource(s), the UE determines that the first time domain resource(s) are the SBFD time domain resource(s) or the non-SBFD time domain resource(s) based on the starting slot/ending slot/starting symbol/ending symbol of the UL channel. When the UL channel associated with the CSI report is in the SBFD time domain resource(s) and in the non-SBFD time domain resource(s), the first time domain resource(s) are the SBFD time domain resource(s) if the starting slot/ending slot/starting symbol/ending symbol of the UL channel is in the SBFD time domain resource(s). When the UL channel associated with the CSI report is in the SBFD time domain resource(s) and in the non-SBFD time domain resource(s), the first time domain resource(s) are the non-SBFD time domain resource(s) if the starting slot/ending slot/starting symbol/ending symbol of the UL channel is in the non-SBFD time domain resource(s). This method may determine specific content of the first time domain resource(s) through the time domain position of the CSI report, which saves the signaling overhead and improves the efficiency of the communication system.

The UE may determine that the first time domain resource(s) are at least one of the SBFD time domain resource(s) and the non-SBFD time domain resource(s) based on the CSI reporting configuration. The CSI reporting configuration includes/is configured a parameter for selecting the time domain resource(s), which is referred to as time domain resource selection parameter herein, but the name of the parameter is not limited by the disclosure, where it is used to indicate that the first time domain resource(s) correspond to at least one of the SBFD time domain resource(s) and the non-SBFD time domain resource(s). The CSI reporting configuration includes/is configured with the time domain resource selection parameter, which is used to indicate that the first time domain resource(s) correspond to at least one of the SBFD time domain resource(s) and the non-SBFD time domain resource(s). The CSI reporting configuration includes/is configured with the time domain resource selection parameter, and the UE determines that the first time domain resource(s) are at least one of the SBFD time domain resource(s) and the non-SBFD time domain resource(s) based on the time domain resource selection parameter. This method may indicate specific content of the first time domain resource(s) via the time domain resource selection parameter, which improves the flexibility of indication and the performance of the communication system.

The UE may determine that the first time domain resource(s) are at least one of the SBFD time domain resource(s) and the non-SBFD time domain resource(s) based on a sub-configuration included in the CSI reporting configuration. The CSI reporting configuration includes one or more sub-configurations. The UE may determine the CSI corresponding to the sub-configuration. The UE may perform the above steps 1, 2, and 3 based on the sub-configuration. The sub-configuration included in the CSI reporting configuration includes/is configured with the time domain resource selection parameter, wherein the time domain resource selection parameter indicates that the first time domain resource(s) associated with/corresponding to the sub-configuration correspond to at least one of the SBFD time domain resource(s) and the non-SBFD time domain resource(s). The sub-configuration included in the CSI reporting configuration includes/is configured with the time domain resource selection parameter, and the UE determines that the first time domain resource(s) corresponding to the sub-configuration is at least one of the SBFD time domain resource(s) and the non-SBFD time domain resource(s) based on the time domain resource selection parameter. The sub-configuration may also include/indicate a resource parameter, an antenna port subset parameter and a power parameter. The UE determines the CSI based on at least one of the resource parameter, the antenna port subset parameter, the power parameter and a parameter associated with the frequency domain indicated by the sub-configuration. The resource parameter of the sub-configuration is used to indicate the resources or a resource subset in the resource set associated with the sub-configuration associated with the CSI reporting configuration. The antenna port subset parameter of the sub-configuration is used to indicate a port subset (for CSI computation/CSI determination) of the resources in the resource set associated with the sub-configuration associated with the CSI reporting configuration. The power parameter of the sub-configuration is used to indicate the power/power assumption (for CSI computation/CSI determination) of the resources in the resource set associated with the sub-configuration associated with the CSI reporting configuration. The UE determines/computes the CSI based on the power parameter indicated by the sub-configuration and the power parameter (e.g., powerControlOffset) with which the resources in the resource set associated with the CSI reporting configuration is configured. The frequency domain parameter associated with the sub-configuration may be for configuring the report in frequency domain. The frequency domain parameter associated with the sub-configuration is reportFreqConfiguration. The frequency domain parameter associated with the sub-configuration may be used to indicate (consecutive or non-consecutive) subbands corresponding to the CSI report. The frequency domain parameter associated with the sub-configuration is csi-ReportingBand. This method may indicate specific content of the first time domain resource(s) via the sub-configuration, which improves the flexibility of indication and the performance of the communication system.

The UE may determine that the first time domain resource(s) are at least one of the SBFD time domain resource(s) and the non-SBFD time domain resource(s) based on the trigger state (for example, aperiodic CSI trigger state or semi-persistent CSI trigger state) corresponding to/associated with the CSI reporting configuration. The UE receives/detects DL control information (DCI) (including a CSI request field) (for example, DCI format 0_1 or DCI format 0_2 or DCI format 0_3), and the DCI triggers/indicates/initiates a CSI trigger state, and the CSI trigger state indicates/is associated with the CSI reporting configuration. The CSI trigger state may be used to indicate that the first time domain resource(s) are at least one of the SBFD time domain resource(s) and the non-SBFD time domain resource(s). The CSI trigger state is associated with the time domain resource selection parameter, and the UE determines that the first time domain resource(s) are at least one of the SBFD time domain resource(s) and the non-SBFD time domain resource(s) based on the time domain selection parameter. This method may trigger/activate the CSI associated with the CSI reporting configuration reporting via DCI signaling and indicate specific content of the corresponding first time domain resource(s) at the same time, which improves the flexibility of indication and the performance of the communication system.

The UE may determine that the first time domain resource(s) are at least one of the SBFD time domain resource(s) and the non-SBFD time domain resource(s) based on media access control (MAC)-control element (CE) activating the CSI associated with the CSI reporting configuration. The UE may receive the MAC-CE activating the CSI reporting associated with the CSI reporting configuration. The MAC-CE may include a field for indicating whether the first time domain resource(s) are at least one of the SBFD time domain resource(s) and the non-SBFD time domain resource(s). The size of the field may be 1 bit. The field is used to indicate that the first time domain resource(s) are one of the SBFD time domain resource(s) and the non-SBFD time domain resource(s). The size of the field may be 2 bits, The field is used to indicate that the first time domain resource(s) are at least one of the SBFD time domain resource(s) and the non-SBFD time domain resource(s). The first three codepoints of the field may be mapped one-to-one with the SBFD time domain resource(s), the non-SBFD time domain resource(s), the SBFD time domain resource(s) and the non-SBFD time domain resource(s). This method may activate the CSI associated with the CSI reporting configuration via MAC-CE signaling and indicate specific content of the corresponding first time domain resource(s) at the same time, which improves the flexibility of indication and the performance of the communication system.

The UE may determine that the first time domain resource(s) are at least one of the SBFD time domain resource(s) and the non-SBFD time domain resource(s) based on the time domain position of the CSI reference resource corresponding to/associated with the CSI report corresponding to/associated with the CSI reporting configuration. When the UL channel corresponding to/associated with the CSI report corresponding to/associated with the CSI reporting configuration is in the SBFD time domain resource(s), the first time domain resource(s) are the SBFD time domain resource(s). When the UL channel associated with the CSI report is in the non-SBFD time domain resource(s), the first time domain resource(s) are the non-SBFD time domain resource(s). This method may determine specific content of the first time domain resource(s) through the CSI reference resource, which saves the signaling overhead and improves the efficiency of the communication system.

Optionally, when the first time domain resource(s) are (determined as/indicated as) the SBFD time domain resource(s) and the non-SBFD time domain resource(s), the UE performs the above operations (for example, at least one of Operation 1, Operation 2 and Operation 3) based on the SBFD time domain resource(s) and the non-SBFD time domain resource(s), respectively. When the first time domain resource(s) are (determined as/indicated as) the SBFD time domain resource(s) and the non-SBFD time domain resource(s), respectively, the UE performs the above operations (for example, at least one of Operation 1, Operation 2 and Operation 3) based on the SBFD time domain resource(s), and the UE performs the above operations (for example, at least one of Operation 1, Operation 2 and Operation 3) based on the non-SBFD time domain resource(s). For example, respectively, the UE performs the above operations (e.g., at least one of Operation 1, Operation 2 and Operation 3) based on the SBFD time domain resource(s) and the reference signal associated with the SBFD time domain resource(s), and the UE performs the above operations (e.g., at least one of Operation 1, Operation 2 and Operation 3) based on the non-SBFD time domain resource(s) and the reference signal associated with the non-SBFD time domain resource(s). The reference signal associated with the SBFD time domain resource(s) may be a first resource subset of the resources in the resource set associated with the CSI resource setting associated with the CSI reporting configuration. The reference signal associated with the non-SBFD time domain resource(s) may be a second resource subset of the resources in the resource set associated with the CSI resource setting associated with CSI reporting configuration. The first subset and/or the second subset are determined in a predefined method. The UE determines the first subset and/or the second subset based on the order of the resources in the resource set. For example, if the resource set includes K resources, the first subset is the first K/2 resources in the resource set, and/or the second subset is the first K/2 resources in the resource set. The first subset and the second subset are indicated/configured by the CSI reporting configuration. The CSI reporting configuration includes one or more parameters for indicating the first subset and/or the second subset.

The UE may be configured with two report frequency domain configuration parameters (for example, reportFreqConfiguration) in the CSI reporting configuration. The first one of the two report frequency domain configuration parameters corresponds to/is associated with the SBFD time domain resource(s). The second one of the two report frequency domain configuration parameters corresponds to/is associated with the non-SBFD time domain resource(s). When the first time domain resource(s) are (determined as/indicated as) the SBFD time domain resource(s) and the non-SBFD time domain resource(s), respectively, the UE performs the above operation (for example, Operation 3) based on the SBFD time domain resource(s) and the first report frequency domain configuration parameter, and the UE performs the above operation (for example, Operation 3) based on the non-SBFD time domain resource(s) and the second report frequency domain configuration parameter.

Optionally, in the above description, if the time domain resource selection parameter is not configured, the UE determines that the first time domain resource(s) are at least one of the SBFD time domain resource(s) and the non-SBFD time domain resource(s) in a predefined method. For example, optionally, in the above description, if the time domain resource selection parameter is not configured, the UE determines that the first time domain resource(s) are the non-SBFD time domain resource(s). For example, optionally, in the above description, if the time domain resource selection parameter is not configured, the UE determines that the first time domain resource(s) are the SBFD time domain resource(s) and the non-SBFD time domain resource(s). This method may determine specific content of the first time domain resource(s) in the predefined method, which saves the signaling overhead and improves the efficiency of the communication system.

In some cases, Operation 1 may be that the UE may determine and/or report the CSI based on the CSI measurement associated with the CSI reporting configuration. The (latest) CSI measurement occasion may occur in the first time domain resource(s). The UE may determine and/or report the CSI based on CSI measurement in the first time domain resource(s). The UE may determine and/or report the CSI based on (the measurement of) the latest CSI measurement occasion in the first time domain resource(s). When the first time domain resource(s) are the SBFD time domain resource(s) and the non-SBFD time domain resource(s), the latest CSI measurement occasion may occur in the SBFD time domain resource(s) and the non-SBFD time domain resource(s), respectively. When the first time domain resource(s) are the SBFD time domain resource(s) and the non-SBFD time domain resource(s), the UE may determine and/or report the CSI based on (the measurement of) the latest CSI measurement occasion in the SBFD time domain resource(s), and the UE may determine and/or report the CSI based on (the measurement of) the latest CSI measurement occasion in the non-SBFD time domain resource(s). This method may determine CSI measurement based on the SBFD time domain resource(s)/time domain resource(s) on which the CSI is based, thus preventing the UE from averaging the CSI measurement result obtained in the SBFD time domain resource(s) and the CSI measurement result obtained in the non-SBFD time domain resource(s), causing the CSI determined by the UE to correspond to channels of the SBFD time domain resource(s) and the non-SBFD time domain resource(s), respectively, thus improving the accuracy of the CSI.

In some cases, Operation 1 may be that the UE may determine and/or report the CSI based on the reference signal resource associated with the resource set associated with the CSI reporting configuration. The UE may determine and/or report the CSI based on the reference signal resource associated with the resource set associated with the CSI reporting configuration in the first time domain resource(s). The UE obtains the CSI based on the assumption that the transmission occasion associated with the reference signal resource in the SBFD resources and the transmission occasion associated with the reference signal resource in the non-SBFD resources are not averaged. Optionally, when the first time domain resource(s) are the SBFD time domain resource(s) and the non-SBFD time domain resource(s), or the first time domain resource(s) are the SBFD time domain resource(s), or the first time domain resource(s) are the non-SBFD time domain resource(s), the UE obtains/computes the CSI based on the assumption that the transmission occasion associated with the reference signal resource in the SBFD resources and the transmission occasion associated with the reference signal resource in the non-SBFD resources are not averaged. Herein, transmission occasion may be used interchangeably with measurement occasion or measurement instance or occasion or instance. This method may prevent the UE from averaging the CSI measurement result obtained in the SBFD time domain resource(s) and the CSI measurement result obtained in the non-SBFD time domain resource(s), causing the CSI determined by the UE may correspond to the channels of the SBFD time domain resource(s) and the non-SBFD time domain resource(s), respectively, and improving the accuracy of the CSI.

In some cases, the CSI reporting configuration may include a channel measurement time domain restriction parameter and/or an interference measurement time domain restriction parameter. The channel measurement time domain restriction parameter (e.g., timeRestrictionForChannelMeasurements) is used to enable time domain restriction for channel measurements. The interference measurement time domain restriction parameter (TimeRestrictionForInterferenceMeasurements) is used to enable time domain restriction for interference measurements.

Optionally, Operation 1 may be that the UE obtains the measurement result based on the CSI reference resource associated with the CSI resource setting in the first time domain resource(s) and no later than the CSI reference resource corresponding to the CSI report associated with the CSI reporting configuration when the channel measurement time domain restriction parameter included in the CSI reporting configuration or the interference measurement time domain restriction parameter is set to notConfigured. The measurement result may be the channel measurement result and/or the interference measurement result. This method enables the UE to determine the CSI through the CSI measurement result obtained in the SBFD time domain resource(s) and the CSI measurement obtained in the non-SBFD time domain resource(s), respectively, causing the CSI determined by the UE may correspond to the channels of the SBFD time domain resource(s) and the non-SBFD time domain resource(s), respectively, and improving the accuracy of the CSI.
Optionally, if the channel measurement time domain restriction parameter in the CSI reporting configuration is set to notConfigured and/or the first condition is satisfied, the UE determines the channel measurement based on the CSI-RS (or a CSI-RS occasion) in the first time domain resource(s). The channel measurement may be the channel measurement for computing the CSI (for example, computing CQI). For example, if the channel measurement time domain restriction parameter in the CSI reporting configuration is set to notConfigured and/or the first condition is satisfied, the UE determines the channel measurement for computing the CSI based on only the CSI-RS (or the CSI-RS occasion) associated with the CSI resource setting associated with the CSI reporting configuration in the first time domain resource(s). Optionally, computing the CSI may be computing CQI or computing the CSI associated with CQI. The CSI-RS may be NZP CSI-RS. The CSI-RS occasion may be the CSI-RS transmission occasion. The CSI is reported in the UL slot n. Optionally, n may represent a slot number. Optionally, n≥0. The CSI-RS (or the CSI-RS occasion) refers to/includes/corresponds to at least one of the following:
The CSI-RS (or the CSI-RS occasion) no later than the CSI reference resource;
The CSI-RS (or the CSI-RS occasion) in the first time domain resource(s);
The CSI-RS (or the CSI-RS occasion) in DRX active time;
The CSI-RS (or the CSI-RS occasion) in the DRX active time when DRX is configured;
The CSI-RS (or the CSI-RS occasion) in cell DTX active time;
The CSI-RS (or the CSI-RS occasion) in the cell DTX active time of the serving cell where the CSI resource setting associated with the CSI reporting configuration is located when the cell DTX is activated on the serving cell.

If the channel measurement time domain restriction parameter in the CSI reporting configuration is set to notConfigured and/or the first condition is satisfied, the UE may determine the channel measurement based on the CSI-RS (or the CSI-RS occasion) in the first time domain resource(s). The channel measurement may be the channel measurement for computing the CSI (for example, computing L1-RSRP/L1-SINR). For example, when the channel measurement time domain restriction parameter in the CSI reporting configuration is set to notConfigured and/or the first condition is satisfied, and/or the resource settings associated with one or two CSI reporting configurations are configured for L1-SINR measurement, the UE determines the channel measurement for computing L1-RSRP/L1-SINR based on only the SSB or CSI-RS (or an SSB or CSI occasion) associated with the CSI resource setting associated with the CSI reporting configuration in the first time domain resource(s). The CSI-RS may be NZP CSI-RS. The CSI-RS occasion may be the CSI-RS transmission occasion. Optionally, L1-RSRP/L1-SINR is reported in the UL slot n. Optionally, n may represent the slot number. Optionally, n≥0. The SSB or CSI-RS (or the SSB or CSI-RS occasion) refers to/includes/corresponds to at least one of the following:
The SSB or CSI-RS (or the SSB or CSI-RS occasion) no later than the CSI reference resource;
The SSB or CSI-RS (or the SSB or CSI-RS occasion) in the first time domain resource(s); The SSB or CSI-RS (or the SSB or CSI-RS occasion) in the DRX active time;
The SSB or CSI-RS (or the SSB or CSI-RS occasion) in the DRX active time when DRX is configured;
The SSB or CSI-RS (or the SSB or CSI-RS occasion) in the cell DTX active time;
The SSB or CSI-RS (or the SSB or CSI-RS occasion) in the cell DTX active time of the serving cell where the CSI resource setting associated with the CSI reporting configuration is located when the cell DTX is activated on the serving cell.

If the interference measurement time domain restriction parameter in the CSI reporting configuration is set to notConfigured and/or the first condition is satisfied, the UE determines the interference measurement based on the CSI-IM and/or CSI-RS (or a CSI-IM and/or CSI-RS occasion) for interference measurement in the first time domain resource(s). The interference measurement may be the interference measurement for computing the CSI (for example, computing CQI). For example, if the interference measurement time domain restriction parameter in the CSI reporting configuration is set to notConfigured and/or the first condition is satisfied, the UE determines the interference measurement based on the CSI-IM and/or CSI-RS (or the CSI-IM and/or CSI-RS occasion) in the first time domain resource(s). Optionally, computing the CSI may be computing CQI or computing the CSI associated with CQI. The CSI-RS may be NZP CSI-RS. The CSI-RS occasion may be the CSI-RS transmission occasion. The CSI is reported in the UL slot n. Optionally, n may represent the slot number. Optionally, n≥0. The CSI-IM and/or CSI-RS (or the CSI-IM and/or CSI-RS occasion) refers to/includes/corresponds to at least one of the following:
The CSI-IM and/or CSI-RS (or the CSI-IM and/or CSI-RS occasion) no later than the CSI reference resource;
The CSI-IM and/or CSI-RS (or the CSI-IM and/or CSI-RS occasion) in the first time domain resource(s);
The CSI-IM and/or CSI-RS (or the CSI-IM and/or CSI-RS occasion) in DRX active time; The CSI-IM and/or CSI-RS (or the CSI-IM and/or CSI-RS occasion) in the DRX active time when DRX is configured;
The CSI-IM and/or CSI-RS (or the CSI-IM and/or CSI-RS occasion) in cell DTX active time;
The CSI-IM and/or CSI-RS (or the CSI-IM and/or CSI-RS occasion) in the cell DTX active time of the serving cell where the CSI resource setting associated with the CSI reporting configuration is located when the cell DTX is activated on the serving cell.

If the interference measurement time domain restriction parameter in the CSI reporting configuration is set to notConfigured and/or the first condition is satisfied, the UE determines the interference measurement based on the CSI-IM and/or CSI-RS (or a CSI-IM and/or CSI-RS occasion) in the first time domain resource(s). The interference measurement may be the interference measurement for computing the CSI (for example, computing L1-SINR). For example, if the interference measurement time domain restriction parameter in the CSI reporting configuration is set to notConfigured and/or the first condition is satisfied, and/or the resource settings associated with one or two CSI reporting configurations are configured for L1-SINR measurement, the UE determines the interference measurement for computing L1-SINR based on only the CSI-IM and/or CSI-RS (or a CSI-IM and/or CSI-RS occasion) associated with the CSI resource setting associated with the CSI reporting configuration in the first time domain resource(s). The CSI-RS may be NZP CSI-RS. The CSI-RS occasion may be the CSI-RS transmission occasion. Optionally, L1-SINR is reported in the UL slot n, which may represent the slot number. Optionally, n≥0. The CSI-IM and/or CSI-RS (or the CSI-IM and/or CSI-RS occasion) refers to/includes/corresponds to at least one of the following:
The CSI-IM and/or CSI-RS (or the CSI-IM and/or CSI-RS occasion) no later than the CSI reference resource;
The CSI-IM and/or CSI-RS (or the CSI-IM and/or CSI-RS occasion) in the first time domain resource(s);
The CSI-IM and/or CSI-RS (or the CSI-IM and/or CSI-RS occasion) in DRX active time; The CSI-IM and/or CSI-RS (or the CSI-IM and/or CSI-RS occasion) in the DRX active time when DRX is configured;
The CSI-IM and/or CSI-RS (or the CSI-IM and/or CSI-RS occasion) in cell DTX active time;
The CSI-IM and/or CSI-RS (or the CSI-IM and/or CSI-RS occasion) in the cell DTX active time of the serving cell where the CSI resource setting associated with the CSI reporting configuration is located when the cell DTX is activated on the serving cell.

Optionally, Operation 1 may be that the UE obtains the measurement result based on the CSI reference resource associated with the CSI resource setting in the first time domain resource(s) and is latest and no later than the CSI reference resource corresponding to the CSI report associated with the CSI reporting configuration when the channel measurement time domain restriction parameter included in the CSI reporting configuration or the interference measurement time domain restriction parameter is set to Configured. The measurement result may be the channel measurement result and/or the interference measurement result. This method enables the UE to determine the CSI through the CSI measurement result obtained in the SBFD time domain resource(s) and the CSI measurement obtained in the non-SBFD time domain resource(s), respectively, causing the CSI determined by the UE may correspond to the channels of the SBFD time domain resource(s) and the non-SBFD time domain resource(s), respectively, and improving the accuracy of the CSI.
Optionally, if the channel measurement time domain restriction parameter in the CSI reporting configuration is set to Configured and/or the first condition is satisfied, the UE determines the channel measurement based on the CSI-RS (or a CSI-RS occasion) in the first time domain resource(s). The channel measurement may be the channel measurement for computing the CSI (for example, computing CQI). For example, if the channel measurement time domain restriction parameter in the CSI reporting configuration is set to Configured and/or the first condition is satisfied, the UE determines the channel measurement for computing the CSI based on only the CSI-RS (or the CSI-RS occasion) associated with the CSI resource setting associated with the CSI reporting configuration in the first time domain resource(s). Optionally, computing the CSI may be computing CQI or computing the CSI associated with CQI. The CSI-RS may be NZP CSI-RS. The CSI-RS occasion may be the CSI-RS transmission occasion. The CSI is reported in the UL slot n, where n may represent a slot number or n≥0. The CSI-RS (or the CSI-RS occasion) refers to/includes/corresponds to at least one of the following:
The latest CSI-RS (or the CSI-RS occasion);
The CSI-RS (or the CSI-RS occasion) no later than the CSI reference resource;
The CSI-RS (or the CSI-RS occasion) in the first time domain resource(s);
The CSI-RS (or the CSI-RS occasion) in DRX active time;
The CSI-RS (or the CSI-RS occasion) in the DRX active time when DRX is configured;
The CSI-RS (or the CSI-RS occasion) in cell DTX active time;
The CSI-RS (or the CSI-RS occasion) in the cell DTX active time of the serving cell where the CSI resource setting associated with the CSI reporting configuration is located when the cell DTX is activated on the serving cell.

If the channel measurement time domain restriction parameter in the CSI reporting configuration is set to Configured and/or the first condition is satisfied, the UE may determine the channel measurement based on the SSB or CSI-RS (or the SSB or CSI-RS occasion) in the first time domain resource(s). The channel measurement may be the channel measurement for computing the CSI (for example, computing L1-RSRP/L1-SINR). For example, when the channel measurement time domain restriction parameter in the CSI reporting configuration is set to Configured and/or the first condition is satisfied, and/or the resource settings associated with one or two CSI reporting configurations are configured for L1-SINR measurement, the UE determines the channel measurement for computing L1-RSRP/L1-SINR based on only the SSB or CSI-RS (or an SSB or CSI occasion) associated with the CSI resource setting associated with the CSI reporting configuration in the first time domain resource(s). The CSI-RS may be NZP CSI-RS. The CSI-RS occasion may be the CSI-RS transmission occasion. L1-RSRP/L1-SINR is reported in the UL slot n, where n may represent the slot number or n≥0. The SSB or CSI-RS (or the SSB or CSI-RS occasion) refers to/includes/corresponds to at least one of the following:
The latest SSB or CSI-RS (or the SSB or CSI-RS occasion);
The SSB or CSI-RS (or the SSB or CSI-RS occasion) no later than the CSI reference resource;
The SSB or CSI-RS (or the SSB or CSI-RS occasion) in the first time domain resource(s); The SSB or CSI-RS (or the SSB or CSI-RS occasion) in the DRX active time;
The SSB or CSI-RS (or the SSB or CSI-RS occasion) in the DRX active time when DRX is configured;
The SSB or CSI-RS (or the SSB or CSI-RS occasion) in the cell DTX active time;
The SSB or CSI-RS (or the SSB or CSI-RS occasion) in the cell DTX active time of the serving cell where the CSI resource setting associated with the CSI reporting configuration is located when the cell DTX is activated on the serving cell.

If the interference measurement time domain restriction parameter in the CSI reporting configuration is set to Configured and/or the first condition is satisfied, the UE determines the interference measurement based on the CSI-IM and/or CSI-RS (or a CSI-IM and/or CSI-RS occasion) for interference measurement in the first time domain resource(s). The interference measurement may be the interference measurement for computing the CSI (for example, computing CQI). For example, if the interference measurement time domain restriction parameter in the CSI reporting configuration is set to Configured and/or the first condition is satisfied, the UE determines the interference measurement based on the CSI-IM and/or CSI-RS (or the CSI-IM and/or CSI-RS occasion) in the first time domain resource(s). Computing the CSI may be computing CQI or computing the CSI associated with CQI. The CSI-RS may be NZP CSI-RS. The CSI-RS occasion may be the CSI-RS transmission occasion. The CSI is reported in the UL slot n, where n may represent the slot number or n≥0. The CSI-IM and/or CSI-RS (or the CSI-IM and/or CSI-RS occasion) refers to/includes/corresponds to at least one of the following:
The latest CSI-IM and/or CSI-RS (or the CSI-IM and/or CSI-RS occasion);
The CSI-IM and/or CSI-RS (or the CSI-IM and/or CSI-RS occasion) no later than the CSI reference resource;
The CSI-IM and/or CSI-RS (or the CSI-IM and/or CSI-RS occasion) in the first time domain resource(s);
The CSI-IM and/or CSI-RS (or the CSI-IM and/or CSI-RS occasion) in DRX active time;
The CSI-IM and/or CSI-RS (or the CSI-IM and/or CSI-RS occasion) in the DRX active time when DRX is configured;
The CSI-IM and/or CSI-RS (or the CSI-IM and/or CSI-RS occasion) in cell DTX active time;
The CSI-IM and/or CSI-RS (or the CSI-IM and/or CSI-RS occasion) in the cell DTX active time of the serving cell where the CSI resource setting associated with the CSI reporting configuration is located when the cell DTX is activated on the serving cell.

If the interference measurement time domain restriction parameter in the CSI reporting configuration is set to Configured and/or the first condition is satisfied, the UE determines the interference measurement based on the CSI-IM and/or CSI-RS (or a CSI-IM and/or CSI-RS occasion) in the first time domain resource(s). The interference measurement may be the interference measurement for computing the CSI (for example, computing L1-SINR). For example, if the interference measurement time domain restriction parameter in the CSI reporting configuration is set to Configured and/or the first condition is satisfied, and/or the resource settings associated with one or two CSI reporting configurations are configured for L1-SINR measurement, the UE determines the interference measurement for computing L1-SINR based on only the CSI-IM and/or CSI-RS (or a CSI-IM and/or CSI-RS occasion) associated with the CSI resource setting associated with the CSI reporting configuration in the first time domain resource(s). The CSI-RS may be NZP CSI-RS. The CSI-RS occasion may be the CSI-RS transmission occasion. Optionally, L1-SINR is reported in the UL slot n, where n may represent the slot number or n≥0. The CSI-IM and/or CSI-RS (or the CSI-IM and/or CSI-RS occasion) refers to/includes/corresponds to at least one of the following:
The latest CSI-IM and/or CSI-RS (or the CSI-IM and/or CSI-RS occasion);
The CSI-IM and/or CSI-RS (or the CSI-IM and/or CSI-RS occasion) no later than the CSI reference resource;
The CSI-IM and/or CSI-RS (or the CSI-IM and/or CSI-RS occasion) in the first time domain resource(s);
The CSI-IM and/or CSI-RS (or the CSI-IM and/or CSI-RS occasion) in DRX active time; The CSI-IM and/or CSI-RS (or the CSI-IM and/or CSI-RS occasion) in the DRX active time when DRX is configured;
The CSI-IM and/or CSI-RS (or the CSI-IM and/or CSI-RS occasion) in cell DTX active time;
The CSI-IM and/or CSI-RS (or the CSI-IM and/or CSI-RS occasion) in the cell DTX active time of the serving cell where the CSI resource setting associated with the CSI reporting configuration is located when the cell DTX is activated on the serving cell.

Alternatively in step 2, the UE does not perform the CSI measurement (e.g., measurement of the reference signal) outside the first time domain resource(s) when the first time domain resource(s) are the SBFD time domain resource(s). For example, when the first time domain resource(s) are the non-SBFD time domain resource(s), the UE does not perform the CSI measurement (for example, measurement of the reference signal) outside the first time domain resource(s). Therefore, how the UE does not perform the CSI measurement outside the first time domain resource(s) when the first time domain resource(s) are the SBFD time domain resource(s) or the non-SBFD time domain resource(s) will be discussed below. Refraining from performing the CSI measurement outside the first time domain resource(s) may enable the UE minimize energy consumption and improve the efficiency of the communication system. Refraining from performing the CSI measurement may include refraining from receiving (or not expecting to receive) the reference signal (or the reference signal resource) associated with a CSI measurement corresponding to the CSI reporting configuration and/or associated with the CSI reporting configuration.

For example, when the first time domain resource(s) are the SBFD time domain resource(s), the UE does not receive (or is not expected to receive) the reference signal associated with the CSI resource setting associated with the CSI reporting configuration on the non-SBFD time domain resource(s). When the first time domain resource(s) are the non-SBFD time domain resource(s), the UE does not receive the reference signal associated with the CSI resource setting associated with the CSI reporting configuration on the SBFD time domain resource(s). The reference signal associated with the CSI reporting configuration may be (all) the reference signal(s) (or the reference signal resource(s)) in the resource set for channel measurement and/or interference measurement associated with the CSI resource setting associated with the CSI reporting configuration. The reference signal (or the reference signal resource) may be a semi-persistent or periodic reference signal (or the reference signal resource).

For example, when the first time domain resource(s) are the SBFD time domain resource(s) or the non-SBFD time domain resource(s), and/or a (or configured) report quantity parameter corresponding to/associated with the CSI reporting configuration includes at least ‘RI’, the UE does not receive (or is not expected to receive) the reference signal associated with the CSI resource setting associated with the CSI reporting configuration on time domain resource(s) other than the first time domain resource(s). The reference signal associated with the CSI reporting configuration may be (all) the reference signal(s) (or the reference signal resource(s)) in the resource set for channel measurement and/or interference measurement associated with the CSI resource setting associated with the CSI reporting configuration. The reference signal (or the reference signal resource) may be a semi-persistent or periodic reference signal (or the reference signal resource).

Since the UE does not receive the reference signal associated with the CSI resource setting associated with the CSI reporting configuration on the first time domain resource(s), the UE may receive/demodulate/process the PDSCH based on the assumption that resource elements (REs) of the reference signal may be used to map REs of the PDSCH, such that the resources corresponding to the CSI-RS may be used for data transmission, thereby improving the efficiency of the communication system. For example, the UE receives indication from the base station to determine the time domain resource(s) and/or frequency domain resource(s) of the PDSCH. For example, the UE receives indication from the base station to determine the REs corresponding to the PDSCH. If the PDSCH is in the first time domain resource(s), and the REs corresponding to the PDSCH have the REs of the reference signal associated with the CSI resource setting associated with the CSI reporting configuration (and the reference signal is a periodic reference signal or a semi-persistent reference signal), then the REs may be used to map information bits, for example, the REs may be used for RE mapping of information bits to VRB corresponding to the PDSCH. The REs corresponding to the PDSCH may be the REs on VRB corresponding to the PDSCH.

In some cases in step 3, the UE determines whether to report the CSI based on the first time domain resource(s) (and the CSI reporting configuration). For example, when the first time domain resource(s) are the SBFD time domain resource(s) or the non-SBFD time domain resource(s), when the UE receives at least one transmission occasion for channel measurement and/or one transmission occasion for interference measurement on the first time domain resource(s), the UE transmits the CSI report corresponding to the CSI reporting configuration. Otherwise, the UE drops the CSI report corresponding to the CSI reporting configuration. The transmission occasion is associated with the CSI resource settings. The transmission occasion may be the transmission occasion of the reference signal resource in the resource set for channel measurement and/or interference measurement associated with the CSI reporting configuration. For example, when a second condition is satisfied, the UE transmits the CSI report; otherwise, the UE drops the CSI report. The second condition includes at least one of the following:
After the CSI report (re) configuration, or serving cell activation, or BWP change, or activation of semi-persistent CSI (SP-CSI);
When the first time domain resource(s) are the SBFD time domain resource(s), at least one CSI-RS transmission occasion for channel measurement and/or one CSI-RS and/or CSI-IM occasion for interference measurement is received on the SBFD time domain resource(s);
The CSI-RS transmission occasion for channel measurement is for (one/all/each) resource(s) in the resource set; or, the CSI-RS transmission occasion for channel measurement is for (one/all/each) resource(s) in the first subset of the resource set, as previously described.

The CSI-RS and/or CSI-IM occasion for interference measurement is for (one/all/each) resource(s) in the resource set; the CSI-RS and/or CSI-IM occasion for interference measurement is for (one/all/each) resource(s) in the first subset of the resource set, as previously described.

The CSI-RS transmission occasion is no later than the CSI reference resource. For example, the CSI-RS transmission occasion is the CSI-RS transmission occasion no later than the CSI reference resource.

The CSI-RS and/or CSI-IM occasion is no later than the CSI reference resource. For example, the CSI-RS transmission occasion is the CSI-RS transmission no later than the CSI reference resource and/or the CSI-IM transmission occasion is the CSI-IM transmission occasion no later than the CSI reference resource.

When the first time domain resource(s) are the non-SBFD time domain resource(s), at least one CSI-RS transmission occasion for channel measurement and/or one CSI-RS and/or CSI-IM occasion for interference measurement is received on the non-SBFD time domain resource(s);

The CSI-RS transmission occasion for channel measurement is for (one/all/each) resource(s) in the resource set. Alternatively, the CSI-RS transmission occasion for channel measurement is for (one/all/each) resource(s) in the second subset of the resource set. Refer above for the description of the second subset.

The CSI-RS and/or CSI-IM occasion for interference measurement is for (one/all/each) resource(s) in the resource set; the CSI-RS and/or CSI-IM occasion for interference measurement is for (one/all/each) resource(s) in the second subset of the resource set. Refer above for the description of the second subset.

The CSI-RS transmission occasion is no later than the CSI reference resource. For example, the CSI-RS transmission occasion is the CSI-RS transmission occasion no later than the CSI reference resource.

The CSI-RS and/or CSI-IM occasion is no later than the CSI reference resource. For example, the CSI-RS transmission occasion is the CSI-RS transmission occasion no later than the CSI reference resource and/or the CSI-IM transmission occasion is the CSI-IM transmission occasion no later than the CSI reference resource.

When the first time domain resource(s) are the SBFD time domain resource(s) and the non-SBFD time domain resource(s), at least one CSI-RS transmission occasion for channel measurement and/or one CSI-RS and/or CSI-IM occasion for interference measurement is received on the SBFD time domain resource(s), and at least one CSI-RS transmission occasion for channel measurement and/or one CSI-RS and/or CSI for interference measurement is received on the non-SBFD time domain resource(s).

The CSI-RS transmission occasion for channel measurement is for (one/all/each) resource(s) in the resource set.

The CSI-RS transmission occasion for channel measurement in the SBFD time domain resource(s) is for (one/all/each) resource(s) in the first subset of the resource set, as previously described.

The CSI-RS transmission occasion for channel measurement in the non-SBFD time domain resource(s) is for (one/all/each) resource(s) in the second subset of the resource set, as previously described.

The CSI-RS and/or CSI-IM occasion for interference measurement is for (one/all/each) resource(s) in the resource set; the CSI-RS and/or CSI-IM occasion for interference measurement is for (one/all/each) resource(s) in the second subset of the resource set. Refer above for the description of the second subset.

The CSI-RS transmission occasion is no later than the CSI reference resource. For example, the CSI-RS transmission occasion is the CSI-RS transmission occasion no later than the CSI reference resource.

The CSI-RS and/or CSI-IM occasion is no later than the CSI reference resource. For example, the CSI-RS transmission occasion is the CSI-RS transmission occasion no later than the CSI reference resource and/or the CSI-IM transmission occasion is the CSI-IM transmission occasion no later than the CSI reference resource.

When discontinuous reception (DRX) (for example, UE DRX) is configured, enough measurements may not be received in the DRX active time, and accordingly, a meaningful report may not be generated due to incomplete measurement information, so the CSI reporting may not be performed to save UL transmission resources. Under what conditions the CSI report corresponding to the CSI reporting configuration disclosure herein should be transmitted or dropped is described below in detail. Based on the second condition, the UE transmits the CSI report or UE drops the CSI report. When the DRX is configured, the CSI-RS and/or CSI-IM occasion in the second condition refers to the CSI-RS and/or CSI-IM occasion in the DRX active time.

In cell discontinuous transmission (DTX) and/or UE DRX, enough measurements may not be received in the cell DTX active time and/or DRX active time for the CSI report. Accordingly, a meaningful report may not be generated due to incomplete measurement information for the CSI report. Therefore, such CSI report may not be fed back to save UL transmission resources. Under what conditions the CSI report corresponding to the CSI reporting configuration disclosure herein should be transmitted or dropped is described below in detail. When a third condition is satisfied, the UE transmits the CSI report; otherwise, the UE drops the CSI report. The third condition includes at least one of the following:
The report quantity corresponding to the CSI reporting configuration includes RI;
The cell DTX of the serving cell where the CSI reporting configuration is located is activated and/or the cell DTX is configured;
The cell DTX of the serving cell where the CSI resource setting (for example, CSI-ResourceConfig) associated with the CSI reporting configuration is located is activated and/or the cell DTX is configured;
The cell DTX of the serving cell where the resources for measurement corresponding to the CSI reporting configuration is activated and/or the cell DTX is configured;
The cell DTX of the serving cell where the resources for channel measurement (and/or interference measurement) corresponding to the CSI reporting configuration is located is activated and/or the cell DTX is configured;
DRX is configured;
After the CSI report (re) configuration, or serving cell activation, or BWP change, or activation of SP-CSI;
When the first time domain resource(s) are the SBFD time domain resource(s), at least one CSI-RS transmission occasion for channel measurement and/or one CSI-RS and/or CSI-IM occasion for interference measurement is received on the SBFD time domain resource(s) (and in the DRX active time and/or the cell DRX active time);
The CSI-RS transmission occasion for channel measurement is for (one/all/each) resource(s) in the resource set. Alternatively, the CSI-RS transmission occasion for channel measurement is for (one/all/each) resource(s) in the first subset of the resource set. Refer above for the description of the first subset.

The CSI-RS and/or CSI-IM occasion for interference measurement is for (one/all/each) resource(s) in the resource set; the CSI-RS and/or CSI-IM occasion for interference measurement is for (one/all/each) resource(s) in the first subset of the resource set. Refer above for the description of the first subset.

The CSI-RS transmission occasion is no later than the CSI reference resource. For example, the CSI-RS transmission occasion is the CSI-RS transmission occasion no later than the CSI reference resource.

The CSI-RS and/or CSI-IM occasion is no later than the CSI reference resource. For example, the CSI-RS transmission occasion is the CSI-RS transmission occasion no later than the CSI reference resource and/or the CSI-IM transmission occasion is the CSI-IM transmission occasion no later than the CSI reference resource.

When the first time domain resource(s) are the non-SBFD time domain resource(s), at least one CSI-RS transmission occasion for channel measurement and/or one CSI-RS and/or CSI-IM occasion for interference measurement is received on the non-SBFD time domain resource(s) (and in the DRX active time and/or the cell DRX active time);

The CSI-RS transmission occasion for channel measurement is for (one/all/each) resource(s) in the resource set; or, the CSI-RS transmission occasion for channel measurement is for (one/all/each) resource(s) in the second subset of the resource set. Refer above for the description of the second subset.

The CSI-RS and/or CSI-IM occasion for interference measurement is for (one/all/each) resource(s) in the resource set; the CSI-RS and/or CSI-IM occasion for interference measurement is for (one/all/each) resource(s) in the second subset of the resource set. Refer above for the description of the second subset.

The CSI-RS transmission occasion is no later than the CSI reference resource. For example, the CSI-RS transmission occasion is the CSI-RS transmission occasion no later than the CSI reference resource.

The CSI-RS and/or CSI-IM occasion is no later than the CSI reference resource. For example, the CSI-RS transmission occasion is the CSI-RS transmission occasion no later than the CSI reference resource and/or the CSI-IM transmission occasion is the CSI-IM transmission occasion no later than the CSI reference resource.

When the first time domain resource(s) are the SBFD time domain resource(s) and the non-SBFD time domain resource(s), at least one CSI-RS transmission occasion for channel measurement and/or one CSI-RS and/or CSI-IM occasion for interference measurement is received on the SBFD time domain resource(s) (and, in the DRX active time and/or the cell DRX active time), and at least one CSI-RS transmission occasion for channel measurement and/or one CSI-RS and/or CSI-IM occasion for interference measurement is received on the non-SBFD time domain resource(s) (and, in the DRX active time and/or the cell DRX active time);

The CSI-RS transmission occasion for channel measurement is for (one/all/each) resource(s) in the resource set.

The CSI-RS transmission occasion for channel measurement in the SBFD time domain resource(s) is for (one/all/each) resource(s) in the first subset of the resource set. Refer above for the description of the first subset.

The CSI-RS transmission occasion for channel measurement in the non-SBFD time domain resource(s) is for (one/all/each) resource(s) in the second subset of the resource set, as previously described.

The CSI-RS and/or CSI-IM occasion for interference measurement is for (one/all/each) resource(s) in the resource set; the CSI-RS and/or CSI-IM occasion for interference measurement is for (one/all/each) resource(s) in the second subset of the resource set, as previously described.

The CSI-RS transmission occasion is no later than the CSI reference resource. For example, the CSI-RS transmission occasion is the CSI-RS transmission occasion no later than the CSI reference resource.

The CSI-RS and/or CSI-IM occasion is no later than the CSI reference resource. For example, the CSI-RS transmission occasion is the CSI-RS transmission occasion no later than the CSI reference resource and/or the CSI-IM transmission occasion is the CSI-IM transmission occasion no later than the CSI reference resource.

The above method associated with step 3 may prevent the UE from reporting the CSI without obtaining enough measurements on the first time domain resource(s), ensure the accuracy of the reported CSI and improve the efficiency of the communication system.

In some cases, when the reference signal associated with the CSI resource setting associated with the CSI reporting configuration corresponding to at least one of seps 1, 2 and 3 is a semi-persistent or periodic reference signal, the reference signal is associated with a periodicity. For example, when the reference signal is a semi-persistent or periodic reference signal, the reference signal may be associated with/configured with a periodicity and offset parameter (for example, periodicity AndOffset) to indicate the periodicity of the reference signal, or periodicities corresponding to all resources in a resource set are equal. The periodicity corresponding to the reference signal is equal to the periodicity associated with the SBFD time domain resource(s). The periodicity corresponding to the reference signal is a multiple of the periodicity associated with the SBFD time domain resource(s). The periodicity corresponding to the reference signal is a positive integer multiple of the periodicity associated with the SBFD time domain resource(s). Limiting the periodicity corresponding to the reference signal may cause the transmission occasion corresponding to the reference signal to only occur in the SBFD time domain resource(s) or the non-SBFD time domain resource(s), such that the UE may average the measurement results corresponding to a plurality of measurement occasions of the same reference signal, thus improving the accuracy of the CSI.

In some cases, the time domain position of the CSI reference resource associated with/corresponding to the CSI report corresponding to the CSI reporting configuration is determined based on a valid DL slot. For example, in time domain, for periodic or semi-persistent CSI report, the UE may determine the CSI reference resource (the valid DL slot where the CSI reference resource is located) based on the number of the CSI-RS/SSB resources for channel measurement. For example, in a time domain, for aperiodic CSI report, the UE may determine the CSI reference resource (the valid DL slot where the CSI reference resource is located) based on the time domain position of the CSI request triggering the aperiodic CSI report. A method for the UE to determine the valid DL slot based on the SBFD configuration will be further explained below. Herein, valid DL slot may be used interchangeably with valid slot. For example, when a fourth condition is satisfied, a first slot for/in a second cell may be considered as a valid DL slot. The second cell is the serving cell. The second cell may be at least one of the SBFD cell, the cell in the same frequency band as the SBFD cell, the cell where the CSI resource setting is located, and the cell where the CSI reporting configuration is located. The fourth condition includes at least one of the following:
The first slot is not in a configured measurement gap for the UE;
The first slot includes at least one DL symbol or flexible symbol configured by the high layer;
The first slot includes at least one symbol in the first time domain resource(s);
The first time domain resource(s) are the SBFD time domain resource(s), and the first slot includes at least one symbol in the first time domain resource(s);
The first time domain resource(s) are the non-SBFD time domain resource(s), and the first slot includes at least one symbol in the first time domain resource(s);
The first time domain resource(s) are the SBFD time domain resource(s), and the first slot includes at least one symbol in the first time domain resource(s); or, the first time domain resource(s) are the non-SBFD time domain resource(s), and the first slot includes at least one symbol in the first time domain resource(s), and the first slot includes at least one DL symbol or flexible symbol configured by the high layer; or, the first time domain resource(s) are the SBFD time domain resource(s) and the non-SBFD time domain resource(s), and the first slot includes at least one DL symbol or flexible symbol configured by the high layer;
The first time domain resource(s) are the SBFD time domain resource(s), and the first slot only includes the symbol in the first time domain resource(s); or, the first time domain resource(s) are the non-SBFD time domain resource(s), and the first slot only includes the symbol in the first time domain resource(s), and the first slot includes at least one DL symbol or flexible symbol configured by the high layer; or, the first time domain resource(s) are the SBFD time domain resource(s) and the non-SBFD time domain resource(s), and the first slot includes at least one DL symbol or flexible symbol configured by the high layer.

The above method may determine the CSI reference resource corresponding to the CSI report based on the SBFD time domain resource(s), such that the UE may perform measurement for the SBFD time domain resource(s) and/or the non-SBFD time domain resource(s), so as to obtain the reference of the CSI measurement on the corresponding time domain resource(s), thereby improving the accuracy of the CSI.

In some cases, the report quantity parameter (e.g., reportQuantity) corresponding to the CSI reporting configuration (the report quantity parameter with which the CSI reporting configuration is configured) corresponding to at least one of steps 1, 2 and 3 may include at least ‘RI’. For example, when the report quantity parameter (e.g., reportQuantity) corresponding to the CSI reporting configuration (the report quantity parameter with which the CSI reporting configuration is configured) includes at least ‘RI’, the UE performs at least one of steps 1, 2 and 3 based on the first time domain resource(s). Herein, the report quantity parameter corresponding to the CSI reporting configuration (the report quantity parameter with which the CSI reporting configuration is configured) may include at least ‘RI’ may be used interchangeably with the CSI includes at least ‘RI’. For example, the report quantity parameter corresponding to the CSI reporting configuration (the report quantity parameter with which the CSI reporting configuration is configured) is set to at least one of ‘cri-RI-PMI-CQI’, ‘cri-RI-L1-PMI-CQI’, ‘cri-RI-i1’, ‘cri-RI-i1-CQI’ and ‘cri-RI-CQI’. For example, the report quantity parameter corresponding to the CSI reporting configuration (the report quantity parameter with which the CSI reporting configuration is configured) is set to at least one of ‘cri-RI-PMI-CQI’, ‘cri-RI-L1-PMI-CQI’, ‘cri-RI-i1-CQI’ and ‘cri-RI-CQI’. Adding the condition associated with the RI herein may restrict the CSI report for CSI/CQI computation by the CSI report being configured to report the RI, and because accurate CSI information is required for CSI/CQI computation, distinguishing the SBFD time domain resource(s) from the non-SBFD time domain resource(s) and then performing corresponding CSI-related operations may improve the accuracy of the CSI obtained by the UE and improve the efficiency of the communication system.

Herein, CSI subband may be used interchangeably with CSI reporting subband or subband for CSI reporting or subband for CSI report or subband associated with CSI.

CSI subbands in BWP may be used interchangeably with CSI subbands overlapping with BWP or CSI subbands overlapping with BWP frequency domain or CSI subbands partially/completely overlapping with BWP frequency domain. CSI subbands in DL subband(s) associated with SBFD configuration information may be used interchangeably with CSI subbands overlapping with DL subband(s) associated the SBFD configuration information or CSI subbands partially/completely overlapping with DL subband(s) associated with SBFD configuration information.

Possible CSI subband sizes may be used interchangeably with configurable CSI subband sizes.

Size of configured CSI subband may be used interchangeably with size of first CSI subband. Subset of CSI subbands may be used interchangeably with subset of a group of CSI subbands or subset of a group of subbands or subset in a group of subbands.

PRBs included in/corresponding to a PRB subset being non-consecutive may be used interchangeably with all PRBs included in/corresponding to a PRB subset being non-consecutive or all PRBs included in/corresponding to a PRB subset being not consecutive in frequency domain or numbers of all PRBs included in/corresponding to a PRB subset being non-consecutive or numbers of all PRBs included in/corresponding to a PRB subset being not non-consecutive or the number of all PRBs included in/corresponding to a PRB subset being less than (or not equal to) the difference between the corresponding PRB with the highest CRB/PRB number and the corresponding PRB with the lowest CRB/PRB number in (all) PRBs included in/corresponding to the PRB subset.

The carrier associated with the SBFD cell may correspond to/include one or more CSI subbands. The CSI subband may be defined as/may correspond to/may be associated with N_{SB} PRBs (for example, N_{SB} consecutive PRBs). The frequency domain unit of the CSI subband for the CSI report takes a PRB as an example, and may also be other units, but the disclosure is not limited thereto. The frequency domain position associated with the CSI subband (for example, the frequency domain position/frequency domain starting position of consecutive N_{SB} PRBs associated with the CSI subband) is determined based on/with reference to a common resource block (CRB) grid, for example, based on/with reference to the CRB with number of 0. For example, the CRB number corresponding to the starting PRB in consecutive N_{SB} PRBs associated with the CSI subband may be an integer multiple (for example, a non-negative integer multiple or a positive integer multiple) of N_{SB}, which corresponds to the size of the configured CSI subband. The size of the configured CSI subband (for example, N_{SB}) may be determined by the following methods. The UE may be configured with one of one or more possible CSI subband sizes via higher layer signaling. Two possible CSI subband sizes are described below as an example. For example, for CSI reporting, the UE may be configured via higher layer signaling with one of two possible CSI subband sizes. For example, the CSI reporting configuration may include/be configured with a subband size parameter (e.g., subbandsize), wherein the subband size parameter may indicate one of two configurable CSI subband sizes. For example, the subband size parameter may indicate one of two values corresponding to two configurable CSI subband sizes. The indicated value corresponds to N_{SB}, or the indicated value corresponds to the size of the configured CSI subband. The subband size parameter indicates the size of the configured CSI subband. The value indicated by the subband size parameter corresponds to N_{SB}. If the CSI reporting configuration does not include a CSI reporting band parameter (for example, csi-ReportingBand), the UE ignores the subband size parameter (or the UE ignores the field corresponding to the subband size parameter). The configurable CSI subband sizes may be determined based on the BWP and/or the SBFD frequency domain resource(s). The BWP is the DL BWP. The BWP is the BWP associated with the CSI reporting configuration. The BWP is the BWP corresponding to the CSI resource setting associated with the CSI reporting configuration. For example, the resources associated with the CSI reporting configuration are measured in the BWP.

Method 1: The configurable CSI subband sizes may be determined based on the number of PRBs included in the BWP. For example, when the number of PRBs included in the BWP is between 24 and 72, the corresponding configurable CSI subband sizes are 4 PRBs and 8 PRBs. For example, when the number of PRBs included in the BWP is between 73 and 144, the corresponding configurable CSI subband sizes are 8 PRBs and 16 PRBs. For example, when the number of PRBs included in the BWP is between 145 and 275, the corresponding configurable CSI subband sizes are 16 PRBs and 32 PRBs.

Method 2: The configurable CSI subband sizes may be determined based on the BWP and the SBFD frequency domain resource(s). For example, the configurable CSI subband sizes may be determined based on lesser or greater one of (e.g., the number of PRBs included in) the frequency domain resource(s) included in the BWP and (e.g., the number of PRBs included in) the frequency domain resource(s) included in the DL subband(s) associated with the SBFD frequency domain resource(s). For example, the configurable CSI subband sizes may be determined based on the intersection (e.g., overlapping part) of the BWP and the DL subband(s) associated with the SBFD frequency domain resource(s). For example, the configurable CSI subband sizes may be determined based on the number of PRBs in the BWP and in the DL subband(s) associated with the SBFD frequency domain resource(s). The PRB being in the DL subband(s) refers that the PRB is completely/partially in the DL subband(s). Optionally, when the number of PRBs determined based on the BWP and the SBFD frequency domain resource(s) is between 24 and 72, the corresponding configurable CSI subband sizes are 4 PRBs and 8 PRBs. Optionally, when the number of PRBs based on the BWP and the SBFD frequency domain resource(s) is between 73 and 144, the corresponding configurable CSI subband sizes are 8 PRBs and 16 PRBs. When the number of PRBs based on the BWP and the SBFD frequency domain resource(s) is between 145 and 275, the corresponding configurable CSI subband sizes are 16 PRBs and 32 PRBs. Method 2 may determine the granularity of the CSI subband for the SBFD frequency domain resource(s), improving the flexibility of the communication system.

Conditions for performing Method 2 may include at least one of the following: the UE is configured with the SBFD configuration information; the CSI reporting configuration is configured with parameters for enabling Method 2; the first time domain resource(s) are the SBFD time domain resource(s); the first condition.

The UE receives configuration information (for example, the CSI reporting band parameter csi-ReportingBand). The UE may determine/obtain the indicated one or more CSI subbands via the configuration information. The UE may determine/obtain the indicated one or more CSI subbands (in a group of the CSI subbands) from the group of the CSI subbands (for example, L CSI subbands) via the configuration information. The number of the CSI subbands included in the one or more CSI subbands is M. The one or more CSI subbands (e.g., M CSI subbands) may be referred to as the indicated one or more CSI subbands. Alternatively, 1≤M≤L. The one or more CSI subbands (e.g., M CSI subbands) may be consecutive or non-consecutive. The UE may determine the corresponding CSI based on the indicated one or more CSI subbands. Methods associated with the CSI subband are further explained below.

The CSI reporting configuration may include/be configured with a parameter for indicating the CSI subband. The parameter for indicating the CSI subband being the CSI reporting band parameter (for example, csi-ReportingBand) is taken as an example. Methods for configuration restrictions are described below.

Alternatively in Method 1, when the PRBs included in the BWP are less than (or equal to) a predefined number of PRBs, the CSI reporting configuration does not include the CSI reporting band parameter. When the PRBs included in the BWP are less than (or equal to) the predefined number of PRBs, the CSI reporting configuration has wideband granularity (and, if applicable, the CSI reporting configuration corresponds to/is associated with the type-I single-panel codebook). When the PRBs included in the BWP are greater than (or equal to) the predefined number of PRBs, the CSI reporting configuration includes the CSI reporting band parameter. The predefined number may be a positive integer. For example, the predefined number may be one of 4, 8, 12, 16, 24, 36, 48.

Alternatively in Method 2, when the (consecutive) PRBs included in the BWP in the DL subband(s) associated with the SBFD configuration information are less than (or equal to) the predefined number of PRBs, the CSI reporting configuration does not include the CSI reporting band parameter. When the (consecutive) PRBs included in the BWP in the DL subband(s) associated with the SBFD configuration information are less than (or equal to) the predefined number of PRBs, the CSI reporting configuration has wideband granularity (and, if applicable, the CSI reporting configuration corresponds to/is associated with the type-I single-panel codebook). When the (consecutive) PRBs included in the BWP in the DL subband(s) associated with the SBFD configuration information are greater than (or equal to) the predefined number of PRBs, the CSI reporting configuration includes the CSI reporting band parameter. The predefined number may be a positive integer. For example, the predefined number may be one of 4, 8, 12, 16, 24, 36, 48. This method may cause the bandwidth available for DL reception in the BWP (that is, the bandwidth of the BWP in the DL subband(s) associated with the SBFD configuration information) to indicate the subband only when it is greater than or equal to a specific value, avoiding inaccurate CSI caused by measurement bandwidth being too small resulting from subband division under the condition of small bandwidth, thus improving the reliability of the communication system.

Conditions for performing Method 2 for configuration restrictions may include at least one of the following: the UE is configured with the SBFD configuration information; the CSI reporting configuration is configured with parameters for enabling Method 2 for configuration restrictions; the first time domain resource(s) are the SBFD time domain resource(s); the first condition.

The CSI reporting configuration may include/be configured with the parameter for indicating the CSI subband. The parameter used to indicate the CSI subbands takes the CSI reporting band parameter (for example, csi-ReportingBand) as an example. CSI subband indication methods are described below.

Method 1: The CSI reporting configuration may include/be configured with the report frequency domain configuration parameter (for example, reportFreqConfiguration). The report frequency domain configuration parameter indicates/includes the CSI reporting band parameter (for example, csi-ReportingBand). The CSI reporting band parameter indicates/corresponds to one or more CSI subbands (e.g., M subbands) in the BWP. The CSI reporting band parameter indicates/corresponds to one or more consecutive or non-consecutive CSI subbands in the BWP. The reported CSI corresponding to the CSI reporting configuration is for the CSI subbands in the DL subband(s) associated with the SBFD frequency domain resource(s) in the one or more CSI subbands (e.g., M subbands). The CSI reporting band corresponding to/associated with the CSI reporting configuration corresponds to/refers to the CSI subbands in the DL subband(s) associated with the SBFD frequency domain resource(s) in the one or more CSI subbands (e.g., M subbands). M CSI subbands may include M′ CSI subbands in the DL subband(s) associated with the SBFD frequency domain resource(s). Optionally, M′≥1. The CSI reporting band parameter may include a bitmap. The UE may determine the number of the CSI subbands (e.g., L) based on the length of the bitmap. For example, the UE may determine the number of the CSI subbands (e.g., L) in the BWP/corresponding to the bitmap based on the length of the bitmap. The UE determines M CSI subbands from L CSI subbands based on the bitmap. The CSI reporting band parameter may include the bitmap, wherein each bit in the bitmap represents/indicates a CSI subband, for example, a CSI subband in the BWP. For example, a bit value of 1 indicates that the CSI subband is indicated; a bit value of 0 indicates that the CSI subband is not indicated. The first bit corresponds to the CSI subband with the lowest frequency domain position (for example, the lowest CRB number, or the lowest starting/ending CRB number) in the BWP. The z′-th bit corresponds to the CSI subband with the z′-th lowest frequency domain position (for example, the z′-th lowest CRB number, or the z′-th lowest starting/ending CRB number) in the BWP, where z′≥1. The rightmost bit in the bitmap (or least significant bit (LSB) of the bitmap or most significant bit (MSB) of the bitmap) represents the lowest/highest CSI subband in the BWP. The lowest/highest CSI subband may be the CSI subband with the lowest/highest frequency domain position. The lowest/highest CSI subband may be the corresponding CSI subband with the lowest/highest CRB number. The leftmost bit in the bitmap (or LSB of the bitmap, or MSB of the bitmap) represents the corresponding CSI subband with the lowest/highest frequency domain position in the BWP or with lowest/highest CRB number.

Methods for determining the CSI reporting band based on a subset of the indicated CSI subbands, are described below. The CSI reporting configuration may include/be configured with the report frequency domain configuration parameter (e.g., reportFreqConfiguration). The report frequency domain configuration parameter may indicate the frequency domain granularity of the CSI report corresponding to/associated with the CSI reporting configuration. The CSI reporting configuration may define the CSI reporting band as the CSI subband(s) that is from the indicated one or more CSI subband(s) and within the DL subband(s) associated with the SBFD frequency domain resource(s). The number of the CSI subbands corresponding to the CSI reporting band is M′. For example, the CSI subbands indicated by the CSI reporting band parameter are {CSI subband #1, CSI subband #2 and CSI subband #4}, where only CSI subband #1 and CSI subband #2 are in the DL subband(s) associated with the SBFD frequency domain resource(s), then the CSI reporting bands are CSI subband #1 and CSI subband #2.

The configuration restrictions associated with the CSI reporting configuration may be at least one of the following:

Alternatively in Method 1, all the indicated one or more CSI subbands (e.g., M CSI subbands) are in the DL subband(s). For example, the UE expects that all the indicated one or more CSI subbands (e.g., M CSI subbands) are in the DL subband(s). For example, the UE does not expect that at least one CSI subband in the indicated CSI subbands is not in the DL subband(s).

Method 2: The UE is not configured with (or is not expected to be configured with)/does not include/does not indicate/does not correspond to the CSI reporting band parameter including the CSI subband, wherein the frequency density of the reference signal (e.g., CSI-RS or CSI-IM) resource associated with the CSI reporting configuration in the CSI subband is less than that with which the configured reference signal resource is configured. The frequency density of the reference signal resource refers to the frequency density of each CSI-RS port per PRB. The frequency density is determined based on the SBFD frequency domain resource(s). The frequency density is determined based on the DL subband(s) and/or UL subband associated with the SBFD frequency domain resource(s). The frequency density is determined based on the frequency domain resource(s) (e.g., PRBs) in the DL subband(s) associated with the SBFD frequency domain resource(s) in the CSI subband. The frequency density is determined based on the frequency domain resource(s) (e.g., PRBs) other than the UL subband (and guardband) associated with the SBFD frequency domain resource(s) in the CSI subband.

Method 3: if the reference signal (e.g., CSI-RS or CSI-IM) resource is associated with the CSI reporting configuration, the UE is not configured with (or is not expected to be configured with)/does not include/does not indicate/does not correspond to the CSI reporting band parameter including the CSI subband, a which is a subband where not all PRBs in the subband have the CSI-IM REs present. Optionally, in the SBFD time domain resource(s), the UE determines/assumes that the reference signal only occurs in the DL subband(s) associated with the SBFD frequency domain resource(s) in the BWP. For example, in the SBFD time domain resource(s), UE operates on the assumption that reference signal only occurs in the DL subband(s) associated with the SBFD frequency domain resource(s) in the BWP. The UE determines/assumes that the reference signal does not occur outside the DL subband(s) associated with the SBFD frequency domain resource(s) in the BWP. The UE determines/assumes that the reference signal only occurs in the DL subband(s) associated with the SBFD frequency domain resource(s) in the BWP.

The above configuration restrictions may prevent the one or more CSI subbands indicated by the base station from being outside the DL subband(s) of SBFD operation, such that all CSI subbands may be measured, thus improving the reliability of the communication system.

Method 2: The CSI reporting configuration may include/be configured with the report frequency domain configuration parameter (for example, reportFreqConfiguration). The report frequency domain configuration parameter indicates/includes the CSI reporting band parameter (for example, csi-ReportingBand). The CSI reporting band parameter indicates/corresponds to one or more CSI subbands (e.g., M CSI subbands) in the BWP and within the DL subband(s) associated with the SBFD. The CSI reporting band parameter indicates/corresponds to one or more consecutive or non-consecutive CSI subbands in the BWP and within the DL subband(s) associated with the SBFD. The CSI reporting band parameter indicates/corresponds to one or more CSI subbands in the BWP and outside the UL subband (and guardband) associated with the SBFD. The CSI reporting band parameter indicates/corresponds to one or more consecutive or non-consecutive CSI subbands in the BWP and outside the UL subband (and guardband) associated with the SBFD. The reported CSI corresponding to the CSI reporting configuration is for the one or more CSI subbands (e.g., M subbands). The CSI reporting band corresponding to/associated with the CSI reporting configuration corresponds/refers to the one or more CSI subbands (e.g., M subbands). The CSI reporting band parameter may include a bitmap, wherein each bit in the bitmap represents/indicates a CSI subband, for example, a CSI subbands in the BWP and in the DL subband(s) associated with the SBFD. For example, a bit value of 1 indicates that the CSI subband is indicated; a bit value of 0 indicates that the CSI subband is not indicated. The UE may determine the number (L) of the CSI subbands based on the length of the bitmap. The UE determines the subset from L CSI subbands based on the bitmap. The first bit corresponds to the CSI subband with the lowest frequency domain position (for example, the lowest CRB number, or the lowest starting/ending CRB number) in the BWP and in the DL subband(s) associated with the SBFD. The z-th bit corresponds to the CSI subband with the z-th lowest frequency domain position (for example, the z-th lowest CRB number or the z-th lowest starting/ending CRB number) in the BWP and in the DL subband(s) associated with the SBFD, where z≥1.

The rightmost bit in the bitmap (or LSB of the bitmap or MSB of the bitmap) represents the lowest/highest CSI subband in the BWP and in the DL subband(s) associated with the SBFD. The lowest/highest CSI subband may be the CSI subband with the lowest/highest frequency domain position. The lowest/highest CSI subband may be the corresponding CSI subband with the lowest/highest CRB number. The leftmost bit in the bitmap (or LSB of the bitmap or MSB of the bitmap) represents the lowest/highest CSI subband with the lowest/highest frequency domain position (or corresponding CRB number) in the BWP and in the DL subband(s) associated with the SBFD. CSI subband indication Method 2 may determine the indicated one or more CSI subbands according to the BWP and the SBFD frequency domain resource(s), such that all the indicated CSI subbands may be used for DL reception, thus improving the efficiency of the communication system.

Conditions for performing CSI subband indication in Method 2 may include at least one of the following: the UE is configured with the SBFD configuration information; the CSI reporting configuration is configured with parameters for enabling CSI subband indication Method 2; the first time domain resource(s) are the SBFD time domain resource(s); the first condition.

Methods for determining the CSI reporting band associated with CSI subband indication are described below. The CSI reporting configuration may include/be configured with the report frequency domain configuration parameter (e.g., reportFreqConfiguration). The report frequency domain configuration parameter may indicate the frequency domain granularity of the CSI report corresponding to/associated with the CSI reporting configuration. The CSI reporting configuration may define/correspond that the CSI reporting band is a subset of the CSI subbands. The subset of the CSI subbands is the one or more CSI subbands indicated by the CSI reporting band parameter.

The CSI reporting configuration may include/be configured with the report frequency domain configuration parameter (e.g., reportFreqConfiguration). The report frequency domain configuration parameter may indicate the frequency domain granularity of the CSI report corresponding to/associated with the CSI reporting configuration. The CSI reporting configuration may define/correspond that the CSI reporting band is a subset of the CSI subbands. The subset of the CSI subbands is indicated by the CSI reporting band parameter. The subset of the CSI subbands is the CSI subbands in the DL subband(s) associated with the SBFD frequency domain configuration information in the CSI subbands indicated by the CSI reporting band parameter. The number of the CSI subbands corresponding to/included in the CSI reporting band may be M′.

Methods for determining the frequency domain resource(s) corresponding to the CSI subbands (corresponding to or indicated by the CSI reporting band) is described below. The frequency domain resource(s) corresponding to the CSI subbands may be frequency domain resource(s) of the CSI subbands, or frequency domain resource(s) occupied by the CSI subbands, or frequency domain resource(s) for the CSI report corresponding to the CSI subbands. The frequency domain resource(s) corresponding to the CSI subbands are determined based on at least one of the configured CSI subband size (N_{SB}), the BWP, and the DL subband(s) associated with the SBFD frequency domain resource(s). The UE determines and/or reports the CSI based on the CSI subbands. The UE determines and/or reports the CSI based on the frequency domain resource(s) corresponding to the CSI subbands. The UE determines and/or reports the CSI based on M′ CSI subbands. The UE determines and/or reports the CSI based on the frequency domain resource(s) corresponding to M′ CSI subbands. The UE may determine the frequency domain resource(s) corresponding to the CSI subbands based on at least one of the following methods.

Method 1: The frequency domain resource(s) corresponding to the CSI subbands are determined based on the PRB subset associated with the CSI subbands. The PRB subset may be a part of PRBs of N_{SB} (consecutive) PRBs associated with the CSI subbands. The PRB subset includes/corresponds to the PRBs of N_{SB} (consecutive) PRBs in the BWP and in the DL subband(s) associated with the SBFD frequency domain resource(s). The PRB subset includes/corresponds to the PRBs of N_{SB} (consecutive) PRBs that are not outside the BWP and not outside the DL subband(s) associated with the SBFD frequency domain resource(s). The method for determining the frequency domain resource(s) corresponding to the CSI subbands is that, for example, N_{SB} PRBs associated with subband #m are N_{SB} consecutive PRBs starting from the CRB number of N_{SB,start,m}, where m=0, 1, 2, . . . , M′−1; the frequency domain resource(s) (or the PRB subset) corresponding to subband #m are the PRBs of the PRBs starting from the CRB number of N_{SB,start,m} to the CRB number of N_{SB,start,m}+N_{SB}−1 in the BWP and in the DL subband(s) associated with the SBFD frequency domain resource(s).

If the PRBs included in/corresponding to the PRB subset are non-consecutive, for example, the PRBs included in/corresponding to the PRB subset include/correspond to two or more groups of consecutive PRBs, then the frequency domain resource(s) corresponding to the CSI subbands may be based on/are a predefined group of consecutive PRBs in the PRB subset. The frequency domain resource(s) corresponding to the CSI subbands may be based on/are a group of consecutive PRBs with the lowest/highest frequency domain position in the PRB subset. The frequency domain resource(s) corresponding to the CSI subbands may be based on/are a group of consecutive PRBs with the lowest/highest number (for example, PRB number or CRB number corresponding to the PRB) associated with the starting/ending PRB in the PRB subset. The frequency domain resource(s) corresponding to the CSI subbands may be based on/are a group of consecutive PRBs with the largest/smallest number of PRBs in the PRB subset. Because the subband may be divided into non-consecutive PRBs by the BWP and the DL subband(s), and processing non-consecutive PRBs in the subband will increase the processing complexity of the UE, the method for determining the frequency domain resource(s) corresponding to the CSI subbands based on the PRB subset here may cause the UE measure only consecutive PRBs in the subband, which reduces the processing complexity of the UE and improves the performance of the communication system.

The PRBs included in/corresponding to the PRB subset are consecutive. For example, the UE expects that the PRBs included in/corresponding to the PRB subset are consecutive. Because the subband may be divided into non-consecutive PRBs by the BWP and the DL subband(s), and processing non-consecutive PRBs in the subband will increase the processing complexity of the UE, performing configuration restrictions on the PRB subset here may avoid occurrence of the non-consecutive PRBs in the PRB subset, reducing the processing complexity of the UE and improving the performance of the communication system.

Conditions for performing Method 1 for determining the frequency domain resource(s) corresponding to the CSI subbands may include at least one of the UE being configured with the SBFD configuration information, the CSI reporting configuration being configured with parameters for enabling Method 1 for determining the frequency domain resource(s) corresponding to the CSI subbands, the first time domain resource(s) being the SBFD time domain resource(s), and the first condition.

Method 1 for determining the frequency domain resource(s) corresponding to the CSI subbands clarifies how to determine frequency domain resource(s) corresponding to subbands for CSI reporting based on the SBFD frequency domain resource(s), such that the UE may perform CSI determination and/or reporting in the SBFD DL band, improving the flexibility of the communication system.

The size of the CSI subbands (for example, the actual size of the CSI subbands) is determined based on at least one of the configured CSI subband size (N_{SB}), the BWP and (the DL subband(s) associated with) the SBFD frequency domain resource(s). The UE may determine the size of the subbands corresponding to the CSI subbands based on at least one of the following methods.

Method 1: The size of the CSI subbands may be the size of the frequency domain resource(s) corresponding to the CSI subbands. For example, the size of the CSI subbands is the numbers of (consecutive) PRBs in the frequency domain resource(s) corresponding to the CSI subbands. For example, the size of the CSI subbands is the bandwidth of the frequency domain resource(s) corresponding to the CSI subbands. Refer above for the determination method of the frequency domain resource(s)/bandwidth corresponding to the CSI subbands.

Conditions for performing Method 1 for determining the size of the CSI subbands may include at least one of the following: the UE is configured with the SBFD configuration information; the DL subband(s) associated with the SBFD configuration information does not completely overlap with the BWP, or the DL subband(s) associated with the SBFD configuration information is not completely in the BWP, or the UL subband (and guardband) associated with the SBFD configuration information is in the BWP; the CSI reporting configuration is configured with parameters for enabling Method 1 for determining the size of the CSI subband; the first time domain resource(s) are the SBFD time domain resource(s); the first condition.

Method 2: The size of the CSI subbands is determined based on the number of PRBs of N_{SB} (consecutive) PRBs associated with the subband in the BWP. For example, the size of the first CSI subband in the BWP may be N_{SB}−(N_{BWP,start} mod N_{SB}), where N_{BWP,start} corresponds/represents the CRB number corresponding to the starting of the BWP, and mod represents the remainder operation. For example, if (N_{BWP,start}+N_{BWP,size}) mod N_{SB} is not equal to 0, the size of the last CSI subband in the BWP may be (N_{BWP,start}+N_{BWP,size}) mod N_{SB}; or when (N_{BWP,start}+N_{BWP,size}) mod N_{SB} is equal to 0, the size of the last CSI subband in the BWP may be N_{SB}. N_{BWP,start} corresponds to/represents the number of CRB corresponding to the starting PRB of the BWP. N_{BWP,size} corresponds to/represents the bandwidth of the BWP or the size of the BWP or the number of PRBs included in the BWP. For example, the size of the CSI subbands other than the first CSI subband and the last CSI subbands in the BWP may be N_{SB}.

Conditions for performing Method 2 for determining the size of the CSI subbands may include at least one of the following: the UE is configured with the SBFD configuration information; the DL subband(s) associated with the SBFD configuration information completely overlap with the BWP, or the DL subband(s) associated with the SBFD configuration information is completely in the BWP, or the UL subband (and guardband) associated with the SBFD configuration information is not in the BWP; the CSI reporting configuration is configured with parameters for enabling Method 2 for determining the size of the CSI subbands; the first time domain resource(s) are the SBFD time domain resource(s); the first condition.

Numbering methods for the CSI subbands and/or CSI reporting/determination methods in some cases, for example, when at least one CSI subband of the indicated subset of the CSI subbands (for example, included in the one or more CSI subbands indicated by csi-ReportingBand) is not in the DL subband(s) associated with the SBFD configuration information, are described below.

For CSI reporting, for example, the CSI subbands in the CSI reporting band for the CSI report corresponding to/associated with the CSI reporting configuration may be numbered or renumbered. For CSI reporting, the CSI subbands of the indicated one or more CSI subbands (e.g., M subbands) in the DL subband(s) associated with the SBFD configuration information may be numbered or renumbered. The CSI subbands in the CSI reporting band for the CSI report (or the CSI subbands of the indicated one or more CSI subbands in the DL subband(s) associated with the SBFD configuration information) are numbered continuously. The CSI subbands in the CSI reporting band for the CSI report (or the CSI subbands of the indicated one or more CSI subbands in the DL subband(s) associated with the SBFD configuration information) are numbered continuously in ascending order. Being numbered continuously in ascending order may refer to being numbered continuously in ascending order according to corresponding bit position/frequency domain position. The first subband included in the CSI reporting band for the CSI report (or the CSI subbands of the indicated one or more CSI subbands in the DL subband(s) associated with the SBFD configuration information) may be numbered as subband #0. The lowest subband in the CSI reporting band (or the CSI subbands of the indicated one or more CSI subbands in the DL subband(s) associated with the SBFD configuration information) may be numbered as subband #0. The k+1-th subband included in the CSI reporting band (or the CSI subbands of the indicated one or more CSI subbands in the DL subband(s) associated with the SBFD configuration information) may be numbered as subband #k. The k+1-th lowest subband included in the CSI reporting band (or the CSI subbands of the indicated one or more CSI subbands in the DL subband(s) associated with the SBFD configuration information) may be numbered as subband #k. For example, the subband with the lowest k+1-th bit position (or corresponding frequency domain position) included in the CSI reporting band (or the CSI subbands of the indicated one or more CSI subbands in the DL subband(s) associated with the SBFD configuration information) may be numbered as subband #k. Optionally, k≥0, and if the CSI report includes the CSI corresponding to/associated with the CSI subbands, the mapping order of (the CSI fields associated with) the CSI is determined based on the numbers of the above CSI subbands/the numbered CSI subbands/the renumbered CSI subbands. When the indicated one or more CSI subbands are not in the DL subband(s) associated with the SBFD frequency domain resource(s), continuous numbering based on the indicated one or more CSI subbands will lead to discontinuous subband numbers of the subbands in the CSI reporting band. Because the CSI of odd subbands and the CSI of even subbands need to be processed separately in parallel in some cases, discontinuous numbering will lead to imbalance between odd subbands and even subbands, which will increase the time of parallel computation; the numbering methods ensure the continuity of subband numbering used for CSI reporting, reduces the time for the UE to compute the CSI and improves the efficiency of the communication system.

The UE determines wideband CQI reporting and/or subband CQI reporting based on the CSI reporting band. The UE may configure wideband CQI reporting or subband CQI reporting via the higher-layer parameter (e.g., cqi-FormatIndicator) included in/corresponding to/associated with the CSI reporting configuration. When wideband CQI is configured, a wideband CQI is reported for one/each codeword for the entire CSI reporting band. When the subband CQI is configured, a CQI (e.g., a subband CQI) is reported for one/each codeword for each subband in the CSI reporting band.

The UE determines wideband PMI reporting and/or subband PMI reporting based on the CSI reporting band. The UE may configure wideband PMI reporting or subband PMI reporting via higher-layer parameter (e.g., pmi-FormatIndicator) included in/corresponding to/associated with the CSI reporting configuration. When wideband PMI reporting is configured, a wideband PMI is reported for the entire CSI reporting band. When subband PMI reporting is configured, except for the case of two antenna ports, a wideband indicator (e.g., wideband PMI or, i1) is reported for the entire CSI reporting band, and a subband indicator (e.g., subband PMI or, i2) is reported for each subband in the CSI reporting band. When the subband PMI is configured and in 2 antenna ports, a subband indicator (or a subband PMI) is reported for each subband in the CSI reporting band.

Methods for determining, by the UE, the CSI reporting band when the BWP associated with/corresponding to (the CSI reporting setting associated with) the CSI reporting configuration is less than (or less than or equal to) a predefined number of PRBs, or when the number of PRBs of the BWP associated with/corresponding to (the CSI reporting setting associated with) the CSI reporting configuration in the DL subband(s) associated with the SBFD frequency domain resource(s) is less than or equal to the predefined number are discussed below. The predefined number may be a positive integer, such as one of 4, 8, 12, 16, 24, 36, 48.

Method 1: the CSI reporting band associated with the CSI reporting configuration is determined based on (the PRBs included in) the BWP and the SBFD frequency domain resource(s). The CSI reporting band is a subset of the PRBs in the BWP. The PRB subset is based on/refers to (all) the frequency domain resource(s) (for example, PRBs/CRBs) included in the BWP in the DL subband(s) associated with the SBFD frequency domain resource(s). The PRB subset is based on/refers to (all) the frequency domain resource(s) (for example, PRBs/CRBs) included in the BWP outside the UL subband (and guardband) associated with the SBFD frequency domain resource(s). Method 1 for determining the CSI reporting band provides a method for determining the CSI reporting band in the SBFD scenario, which clarifies the frequency domain resource(s) corresponding to the CSI reported by the UE and ensures the reliability of CSI measurement/CSI reporting.

If the PRBs included in/corresponding to the PRB subset are non-consecutive (for example, the PRBs included in/corresponding to the PRB subset include/correspond to two or more groups of consecutive PRBs), the CSI reporting band is a predefined group of consecutive PRBs in the PRB subset. For example, the CSI reporting band may be a group of consecutive PRBs with the lowest/highest frequency domain position in the PRB subset. The CSI reporting band may be a group of consecutive PRBs with the lowest/highest number (for example, PRB number or CRB number corresponding to the PRB) associated with the starting/ending PRB in the PRB subset. The CSI reporting band may be a group of consecutive PRBs with the largest/smallest number of PRBs in the PRB subset. Because the PRBs in the BWP may be divided into non-consecutive PRBs by the DL subband(s), and processing non-consecutive PRBs in the BWP will increase the processing complexity of the UE, the method for determining the frequency domain resource(s) corresponding to the CSI subbands based on the PRB subset here may cause the UE measure only consecutive PRBs in the BWP, which reduces the processing complexity of the UE and improves the performance of the communication system.

The PRBs included in/corresponding to the PRB subset are consecutive. For example, the UE expects that the PRBs included in/corresponding to the PRB subset are consecutive. Because the BWP may be divided into non-consecutive PRBs by the DL subband(s), and processing non-consecutive PRBs in the BWP will increase the processing complexity of the UE, performing configuration restrictions on the PRB subset proposed here can may occurrence of the non-consecutive PRBs in the PRB subset, reducing the processing complexity of the UE and improving the performance of the communication system.

Conditions for performing Method 1 for determining the CSI reporting band may include at least one of the following: the UE is configured with the SBFD configuration information; the DL subband(s) associated with the SBFD configuration information partially overlap with the BWP, or the DL subband(s) associated with the SBFD configuration information is not completely in the BWP, or the UL subband (and guardband) associated with the SBFD configuration information in in the BWP; the CSI reporting configuration is configured with parameters for enabling Method 2; the first time domain resource(s) are the SBFD time domain resource(s); the first condition.

Method 2: the CSI reporting band associated with the CSI reporting configuration is determined based on (the PRBs included in) the BWP. For example, the CSI reporting band refers to all PRBs included in the BWP. Alternatively, all PRBs included in the BWP are in the DL subband(s) associated with the SBFD frequency domain resource(s). The UE expects all PRBs included in the BWP to be in the DL subband(s) associated with the SBFD frequency domain resource(s). The BWP is not outside the DL subband(s) associated with the SBFD frequency domain resource(s). For example, the UE expects the BWP not to be outside the DL subband(s) associated with the SBFD frequency domain resource(s). For example, the UE does not expect the BWP to be outside the DL subband(s) associated with the SBFD frequency domain resource(s). The configuration restriction may prevent the BWP from being outside the DL subband(s) associated with the SBFD frequency domain resource(s), thus ensuring that the UE has enough bandwidth for CSI measurement/CSI reporting, and ensuring the reliability of CSI measurement/CSI report.

When the CSI report corresponding to the CSI reporting configuration is aperiodic and/or the measurement resource set associated with/corresponding to the CSI reporting configuration is aperiodic, the DCI format triggering the CSI report, the triggered measurement resources, and the PUSCH carrying the CSI report need to satisfy CSI computation delay requirement. The following describes a method for determining CSI computation time associated with the CSI reporting configuration. Herein, CSI computation time may be used interchangeably with CSI computation delay requirement or Z timeline. The definition of the CSI computation time is briefly explained below.

The UE may receive DL control information (DCI) which triggers the aperiodic report. The DCI (or the CSI request field contained in the DCI) may trigger one or more CSI reports (on physical UL shared channel (PUSCH)). For example, the one or more CSI reports are carried by the PUSCH. The one or more CSI reports include a first CSI report.

The one or more CSI reports include/correspond to a first CSI report. For example, the first CSI report represents the n-th (triggered) report in the one or more reports.

The UE determines/feeds back/reports the first CSI report (or the UE provides a (valid) CSI report for the first CSI report). The UE determines/feeds back/reports the first CSI report (or the UE provides a (valid) CSI report for the first CSI report) when at least one of the following conditions is satisfied:
The time unit (e.g., starting of the time unit or ending of the time unit) carrying the one or more CSI reports is no earlier than a first time unit. For example, the unit of the time unit may be a slot or a symbol. For example, the time unit carrying the one or more CSI reports may be the first UL symbol carrying the one or more CSI reports. The UL symbol includes (or needs to consider) the effect of the timing advance. Refer below for description of the first time unit (e.g., Z_{ref});
The time unit (e.g., starting of the time unit) carrying the first CSI report is no earlier than a second time unit. For example, the unit of the time unit may be a slot or a symbol. For example, the time unit carrying the first CSI report may be the first UL symbol carrying the first CSI report. The UL symbol includes (or needs to consider) the effect of the timing advance. Description of the second time unit (e.g., Z_{ref}′) is provided below.

The first time unit (e.g., Z_{ref}) is determined based on the time unit where the physical DL control channel (PDCCH) corresponding to the DCI (e.g., the DCI triggering the one or more CSI reports) is located and the CSI computation delay parameter corresponding to one (or each) CSI report of the one or more CSI reports. The first time unit may be a UL symbol (for example, the next UL symbol) (after a first specific time) after the last symbol where the PDCCH corresponding to the DCI (for example, the DCI triggering the one or more CSI reports) is located. The first specific time is determined based on the CSI computation delay parameter corresponding to one (or each) CSI report of the one or more CSI reports. For example, Z_{ref} is defined as the next UL symbol with its CP starting T_{proc,CSI}=(Z)(2048+144)·κ2^{-μ}·T_{C}+T_{switch} after the end of the last symbol of the PDCCH triggering the CSI report(s). Table 1 below describes the parameter μ. T_{C} represents the basic time unit for NR. κ represents the ratio between T_{S} and T_{C}. T_{S} represents the basic time unit for LTE. T_{switch} is a parameter used to indicate the UL switching time gap. For example, T_{switch} is equal to the switching gap duration or 0. Z represents or is equals to the maximum value of the CSI computation delay parameter corresponding to each CSI report in the updated CSI reports (in the one or more CSI reports). The updated CSI report(s) in the one or more CSI reports are determined according to CSI processing criteria (e.g., rules related to the CSI processing unit (CPU)). For example, the terminal device may determine which CSI reports need to be updated and which CSI reports are not required to be updated based on the total number of CPUs and the number of the occupied CPUs. The updated reports are represented as report 0, report 1, . . . , report M−1, where the number of the updated reports is M. Each report may correspond to a CSI computation delay parameter. For example, the CSI computation delay parameter corresponding to report m is Z(m), m=0, 1, . . . , M−1.

$$Z = {max}_{m = 0 , 1 , … , M - 1} Z ( m ) .$$

The second time unit (for example, Z_{ref}′) is determined based on the time unit of the measurement resource corresponding to the first CSI report and the CSI computation delay parameter corresponding to the first CSI report. The measurement resources include resources for channel measurement and/or resources for interference measurement. The measurement resources may be aperiodic resources. The measurement resource corresponding to the first CSI report may be the latest resource in the measurement resources. For example, in the case that there are a plurality of measurement resources corresponding to the first CSI report, the measurement resource corresponding to the first CSI report refers to the latest resource (in time domain) in the measurement resources used for the first CSI report. For example, the time unit of the measurement resource corresponding to the first CSI report refers to the last symbol of the latest resource (in time domain) in the measurement resources used for the first CSI report. The second time unit may be a UL symbol (after a second specific time) after the last symbol of the latest resource in the measurement resources for the first CSI report. The second specific time is determined based on the CSI computation delay parameter corresponding to one (or each) CSI report of the one or more CSI reports. For example, taking the first CSI report as an example, Z_{ref}′ is defined as the next UL symbol with its CP starting T′_{proc,CSI}=(Z′) (2048+144)·κ2^{μ}·T_{C} after the end of the last symbol in time of the latest of: aperiodic CSI-RS resource for channel measurements, aperiodic CSI-IM used for interference measurements, and aperiodic NZP CSI-RS for interference measurement, when aperiodic CSI-RS is used for channel measurement for the first CSI report. Table 1 below describes the parameter u. T_{C} represents the basic time unit for NR. K represents the ratio between T_{S} and T_{C}. T_{S} represents the basic time unit for LTE. Z′ represents the maximum value of the CSI computation delay parameter corresponding to each CSI report in the updated CSI reports (in the one or more CSI reports). The updated CSI report(s) in the one or more CSI reports are determined according to CSI processing criteria (e.g., rules related to the CPU. For example, the terminal device may determine which CSI reports need to be updated and which CSI reports are not required to be updated based on the total number of CPUs) and the number of the occupied CPUs. The updated reports are represented as report 0, report 1, . . . , report M−1, where the number of the updated reports is M. Optionally, each report may correspond to a CSI computation delay parameter. For example, the CSI computation delay parameter corresponding to report m is Z′(m), m=0, 1, . . . , M−1.

$${Z}^{′} = {max}_{m = 0 , 1 , … , M - 1} {Z}^{′} ( m ) .$$

The UE may receive DCI. The DCI triggers aperiodic report. The DCI (or the CSI request field contained in the DCI) may trigger the one or more CSI reports (on the PUSCH).

Optionally, when the time unit carrying the one or more CSI reports is earlier than the first time unit, the UE ignores the DCI (or scheduling DCI). For example, the DCI is the DCI triggering the one or more CSI reports. The time unit carrying the one or more CSI reports includes (or needs to consider) the effect of the timing advance. Here, refer to above description for the first time unit.

Optionally, when (the starting of) the time unit carrying the first CSI report is earlier than the second time unit, the UE performs at least one of the following operations:
if there is no hybrid automatic repeat request-acknowledgement (HARQ-ACK) or a transport block is multiplexed on the PUSCH and the number of the reported CSI report(s) is 1, the UE ignores the DCI (or scheduling the DCI);
otherwise, the UE is not required to update the first CSI report.

The time unit carrying the first CSI report includes (or needs to consider) the effect of the timing advance. Here, refer to above description for the second time unit.

For example, Z₁, Z₂, Z₁, Z₂ may be represented by the Table 1 below, where Z₁ and Z₂ are parameters associated with Z(m), and Z₁′ and Z₂′ are parameters associated with Z′(m). Here, μ in Table 1 corresponds to the minimum value min (μ_{PDCCH}, μ_{CSI-RS}, μ_{UL}) of μ_{PDCCH}, μ_{CSI-RS} and μ_{UL}. Here, μ_{PDCCH} corresponds to the subcarrier spacing of the physical DL control channel (PDCCH) where the DCI (for example, the DCI triggering the one or more CSI reports) is carried/transmitted. JUL corresponds to the subcarrier spacing of the PUSCH where the one or more CSI reports is carried/transmitted. μ_{CSI-RS} corresponds to the smallest/largest subcarrier spacing in aperiodic CSI-RS triggered by the DCI. The aperiodic CSI-RS triggered by the DCI refers to the resource(s) (e.g., CSI-RS resource(s)) indicated by (all) the sub-configuration(s) triggered by the DCI. In addition, Xu is determined based on the capability parameter (for example, beamReportTiming) reported by the UE. KB_{I} is determined based on the capability parameter (for example, beamSwitchTiming) reported by the UE.

TABLE 1

| | |
|---|---|
| [symbol] | [symbol] |

| μ | Z₁ | Z′₁ | Z₂ | Z′₂ |
|---|---|---|---|---|
| 0 | 22 | 16 | 40 | 37 |
| 1 | 33 | 30 | 72 | 69 |
| 2 | 44 | 42 | 141 | 140 |
| 3 | 97 | 85 | 152 | 140 |
| 5 | 388 | 340 | 608 | 560 |
| 6 | 776 | 680 | 1216 | 1120 |

Methods for determining the CSI computation time (for example, Z(m) and Z′(m)) corresponding to the CSI reporting configuration is described below, taking the CSI reporting configuration (e.g., the CSI reporting configuration associated with the SBFD configuration information) corresponding to a report m as an example.

In some cases, the DL subband(s) (e.g., the DL subband(s) indicated by the SBFD configuration information) may include one or two groups of consecutive PRBs. The one or two groups of PRBs may be called one or two subbands. When the DL subband(s) includes two subbands, the frequency domain resource(s) of CSI-RS for channel measurement associated with the CSI reporting configuration may be across two subbands (for example, the frequency domain resource(s) of the CSI-RS are not only in the first subband but also in the second subband of these two subbands). Since the two subbands in the DL subband(s) are non-consecutive, the frequency domain resource(s) of the CSI-RS are also non-consecutive correspondingly. The measurement report for the frequency domain non-consecutive CSI-RS needs higher complexity, so that the corresponding CSI report needs more computing resources and/or computing time. The following provides a method for determining the computing resources and/or computing time associated with the CSI report in this case, so that the UE may have enough time and/or enough computing resources to determine the CSI/report the CSI, thus ensuring the reliability of the communication system.

The reference signal resource (for example, CSI-RS) (for channel measurement) associated with the CSI reporting configuration may be in the DL subband(s). The reference signal resource associated with the CSI reporting configuration may be one or more resources in the reference signal set for channel measurement associated with the CSI reporting configuration. The number (for example, O_{CPU}) of CPUs occupied by the CSI report associated with the CSI reporting configuration may be determined based on the number (Q) of the subbands in the DL subband(s) associated with frequency domain resource(s) of the reference signal (for channel measurement) associated with the CSI reporting configuration. Refer below for the description of the CPU. The CSI computation time of the CSI report associated with the CSI reporting configuration may be determined based on the number (Q) of the subbands in the DL subband(s) associated with the frequency domain resource(s) of the reference signal (for channel measurement) associated with the CSI reporting configuration. Optionally, Q may be 1 or 2. Refer above for the description of the CSI computation time. The number of subbands in the DL subband(s) associated with the frequency domain resource(s) of the reference signal may be: the number of the subbands in the DL subband(s) included in the frequency domain resource(s) of the reference signal, or the number of subbands in the DL subband(s) overlapping with the frequency domain resource(s) of the reference signal. The number of the subbands in the DL subband(s) associated with the frequency domain resource(s) of the reference signal may be: the number of subbands in the DL subband(s) included in the frequency domain resource(s) of the reference signal in DL BWP, or the number of the subbands in the DL subband(s) overlapping with the frequency domain resource(s) of the reference signal in DL BWP. The DL BWP may be the BWP in the SBFD cell. The BWP may be an active BWP. Optionally, when the frequency domain resource(s) of the reference signal are (only) in one of the two subbands included in the DL subband(s), Q=1. Optionally, when the frequency domain resource(s) of the reference signal are in the two subbands included in the DL subband(s), Q-2. Optionally, when the part of the frequency domain resource(s) of the reference signal in the DL BWP is (only) in one of the two subbands included in the DL subband(s), Q=1. Optionally, when the part of the frequency domain resource(s) of the reference signal in the DL BWP is in the two subbands included in the DL subband(s), Q=2. Optionally, when the frequency domain resource(s) of the reference signal (only) overlap with one of the two subbands included in the DL subband(s), Q=1. Optionally, when the frequency domain resource(s) of the reference signal overlap with both subbands included in the DL subband(s), Q=2. Optionally, when the part of the frequency domain resource(s) of the reference signal in the DL BWP (only) overlaps with one of the two subbands included in the DL subband(s), Q=1. Optionally, when the part of the frequency domain resource(s) of the reference signal in the DL BWP overlaps with both subbands included in the DL subband(s), Q=2.

Optionally, O_{CPU} of the CSI report associated with the CSI reporting configuration may be a first value or a second value. The second value is greater than or equal to the first value. The second value may be Q times the first value. Optionally, O_{CPU} of the CSI report associated with the CSI reporting configuration may be determined based on Q. Optionally, O_{CPU}=K*Q or Q. Here, K may be the number of resources in the resource set (for channel measurement associated with CSI reporting configuration). Optionally, when Q=1, O_{CPU} is equal to the first value (n1), and when Q=2, O_{CPU} is equal to the second value (n2). The second value is Q times the first value (for example, n2=Q*n1). The second value is greater than or equal to the first value (for example, n2≥n1). Optionally, when Q=1 or Q=2, O_{CPU} is based on/equal to the first value. Optionally, O_{CPU} of the CSI report associated with the CSI reporting configuration may be the first value. Optionally, n1 is based on/equal to K or 1.

The CSI computation time of the CSI report associated with the CSI reporting configuration may be a third value or a fourth value. The fourth value is greater than or equal to the third value. The fourth value is Q times the third value. The CSI computation time (of the CSI report associated with the CSI reporting configuration) may refer to: Z and/or Z(m). The CSI computation time of the corresponding CSI report associated with the CSI reporting configuration may be determined based on Q. The CSI computation time is based on/equal to Z₂. The CSI computation time is based on/equal to Z₂*Q. Optionally, when Q=1, the CSI computation time is equal to/based on the third value (n3), and when Q=2, the CSI computation time is equal to/based on the fourth value (n4). The fourth value is greater than or equal to the third value (for example, n4≥n3), or the fourth value is Q times the third value (for example, n4=Q*n3). Optionally, when Q=1 or Q=2, the CSI computation time is equal to/based on the third value (n3). Optionally, n3=Z₂.

The CSI computation time of the CSI report associated with the CSI reporting configuration may be a fifth value or a sixth value. The sixth value is greater than or equal to the fifth value. The sixth value is Q times the fifth value. The CSI computation time (of the CSI report associated with the CSI reporting configuration) may refer to Z′ and/or Z′(m). The CSI computation time of the corresponding CSI report associated with the CSI reporting configuration may be determined based on Q. The CSI computation time is based on/equal to Z′₂. The CSI computation time is based on/equal to Z′₂*Q. Optionally, when Q=1, the CSI computation time is equal to/based on the fifth value (n5), and when Q=2, the CSI computation time is equal to/based on the sixth value (n6). The sixth value is greater than or equal to the fifth value (for example, n6≥n5), or the sixth value is Q times the fifth value (for example, n6=Q*n5). The CSI computation time of the CSI report associated with the CSI reporting configuration is equal to/based on the fifth value (n5). Optionally, n5=Z′₂. Optionally, when Q=1 or Q=2, the CSI computation time is equal to/based on the fifth value (n5). Optionally, n5=Z′₂.

For the computation of frequency domain resource(s) of non-consecutive CSI-RS, to effectively utilize the computation resources (for example, computation time and the number of CPUs used in computation), when the computation time is extended, the number of corresponding CPUs used may not need to be increased, or when the number of CPUs occupied by the CSI report increases, the time for CSI computation may not need to be extended. Optionally, O_{CPU} of the CSI report associated with the CSI reporting configuration and the CSI computation time of the CSI report may be based on at least one of the following:
Method 1: O_{CPU} of the CSI report associated with CSI reporting configuration is determined based on Q. Optionally, when Q=1, O_{CPU} of the CSI report is equal to the first value. Optionally, when Q=1, O_{CPU} of the CSI report is equal to the first value, and the CSI computation time of the CSI report is equal to the third value (or the CSI computation time of the CSI report is equal to the fifth value). When Q=2, O_{CPU} of the CSI report is equal to the second value, or O_{CPU} of the CSI report is equal to the second value, and the CSI computation time of the CSI report is equal to the third value (or the CSI computation time of the CSI report is equal to the fifth value). The CSI computation time of the CSI report is equal to the third value (or, the CSI computation time of the CSI report is equal to the fifth value). The second value is greater than or equal to the first value. The second value may be Q times the first value;
Method 2: the CSI computation time of the CSI report associated with the CSI reporting configuration is determined based on Q. Optionally, when Q=1, the CSI computation time of the CSI report is equal to the third value (or, the CSI computation time of the CSI report is equal to the fifth value). Optionally, when Q=1, O_{CPU} of the CSI report is equal to the first value, and the CSI computation time of the CSI report is equal to the third value (or the CSI computation time of the CSI report is equal to the fifth value). Optionally, when Q=2, the CSI computation time of the CSI report is equal to the fourth value (or, the CSI computation time of the CSI report is equal to the sixth value), or O_{CPU} of the CSI report is equal to the first value, and the CSI computation time of the CSI report is equal to the fourth value (or the CSI computation time of the CSI report is equal to the sixth value). The fourth value is greater than or equal to the third value. The fourth value is Q times the third value. The sixth value is greater than or equal to the fifth value. The sixth value is Q times the fifth value;
Method 3: O_{CPU} of the CSI report is equal to the first value, and/or the CSI computation time of the CSI report is equal to the third value (or the CSI computation time of the CSI report is equal to the fifth value). Optionally, when Q=1 and/or Q=2, O_{CPU} of the CSI report is equal to the first value, and/or the CSI computation time of the CSI report is equal to the third value (or the CSI computation time of the CSI report is equal to the fifth value).

The CSI report corresponding to/being based on at least one of Methods 1, 2 and 3 is determined based on the UE capability. For example, the UE reports the UE capability signaling, which indicates Method 1 or 2. For example, the UE reports the UE capability signaling, which indicates Method 1, 2 or 3. The CSI report corresponding to/being based on at least one of Methods 1, 2 and 3 is determined based on the indication of the base station or the indication of the base station. For example, the UE receives/obtains the indication information from the base station, the indication information indicates Methods 1 or 2, or the indication information indicates Method 1, 2 or 3.

The disclosure provides several methods to enable the UE to perform CSI-related operations based on the SBFD configuration information, such that the UE/the base station may obtain CSI for the SBFD, and the flexibility of the CSI reporting is improved.

In some cases, the UE may receive/be configured with the CSI reporting configuration. The report quantity parameter (for example, reportQuantity) associated with the CSI reporting configuration is not set to none. The UE determines the CSI and/or reports the CSI and/or reports the CSI report based on the CSI reporting configuration.

The UE determines the CSI and/or reports the CSI based on the reference signal resource associated with the CSI reporting configuration. The reference signal resource associated with the CSI reporting configuration refers to the resource in the reference signal resource set for channel measurement indicated by/configured by/corresponding to the CSI reporting configuration, and/or the resource in the reference signal resource set for interference measurement indicated by/configured by/corresponding to the CSI reporting configuration, and/or the reference signal resource for link quality assessment. The size of the reference signal resource set for channel measurement is K (K≥1). The reference signal resource may be the SSB resource or CSI-RS resource. When the reference signal resource is the CSI-RS resource, the reference signal resource or the reference signal resource set is periodic/semi-persistent.

The UE may be configured with a high-layer parameter (e.g., dl-OrJointTCI-StateList) associated with a TCI state. The higher-layer parameter (for example, dl-OrJointTCI-StateList) associated with the TCI state is in a higher-layer parameter PDSCH-Config. The higher-layer parameter (e.g., dl-OrJointTCI-StateList) associated with the TCI state is for providing a reference signal for the quasi co-location for DM-RS of PDSCH and DM-RS of PDCCH in a BWP/CC, for CSI-RS, and to provide a reference, if applicable, for determining UL transmission spatial filter. The UL transmission spatial filter is for dynamic-grant and configured-grant based PUSCH and PUCCH resource, and SRS. The UE receives/applies an indication of the TCI state. The UE receives/applies/has the indicated TCI state. The UE applies/uses the indicated TCI state after receiving TCI state indication information. The reference signal associated with/corresponding to the indicated TCI state is an SSB that is quasi-co-located with the QCL (quasi-co-location) reference signal of the indicated TCI state, or the reference signal associated with/corresponding to/included in the indicated TCI state is a QCL (quasi-co-location) reference signal of the indicated TCI state. Optionally, if a TCI state is associated with/includes/corresponds to two QCL reference signals, the reference signal(s) associated with/corresponding to/included in the TCI state are the QCL type-D reference signal(s) included in/corresponding to the TCI state. Optionally, if the resource(s) in the resource set is SSB resource(s), the reference signal associated with/corresponding to the indicated TCI state is an SSB that is quasi-co-located with the QCL (quasi-co-location) reference signal of the indicated TCI state. Optionally, if the resource(s) in the resource set is CSI-RS resource(s), the reference signal associated with/corresponding to the indicated TCI state is a QCL (quasi-co-location) reference signal associated with/corresponding to/included in the indicated TCI state, wherein the reference signal is a CSI-RS. The indicated TCI state may be an indicated unified TCI state.

The UE transmits a first UL channel or a first UL signal. The first UL channel may be one of PUCCH, PUSCH and PRACH. The first UL signal may be one of SRS, demodulation reference signal (DM-RS) of PUSCH and DM-RS of PUCCH. The first UL channel or the first UL signal indicates/notifies a second UL channel to carry the CSI report. The second UL channel is determined based on the first UL channel/first UL signal. The serving cell (or component carrier) where the second UL channel is located is determined based on the first UL channel/first UL signal. The slot (e.g., starting slot) where the second UL channel is located and/or the starting symbol (of each slot in slots where the second UL channel is located) is determined based on the first UL channel/first UL signal. The second UL channel may be PUSCH or PUCCH.

The first UL channel or the first UL signal is triggered based on the resource set (for example, the resource set for channel measurement associated with the CSI reporting configuration) and/or the indicated TCI state. The first UL channel or the first UL signal is triggered based on the reference signal associated with/corresponding to the resources in the resource set and/or the reference signal associated with/corresponding to the indicated TCI state. The first UL channel or the first UL signal is triggered based on the difference between the measured L1-RSRP corresponding to the reference signal associated with/corresponding to the resources in the resource set and/or the measured L1-RSRP corresponding to the indicated TCI state being greater than or equal to a threshold configured by RRC. For example, the threshold configured by RRC is 6 dB, and the L1-RSRP corresponding to CSI-RS #1 in the measurement resource set is higher than the L1-RSRP corresponding to the reference signal associated with/corresponding to the TCI state by 7 dB, then the first UL channel or the first UL signal may be triggered. The UE applies the threshold to the measured L1-RSRP after scaling. The measured L1-RSRP after scaling refers to the measured L1-RSRP after scaling the received power of the CSI-RS using a power offset parameter (e.g., powerControlOffsetSS) with which the corresponding CSI-RS resource is configured. Optionally, scaling the received power of the CSI-RS refers to subtracting the value corresponding to powerControlOffsetSS from the L1-RSRP corresponding to the CSI-RS. For example, the threshold configured by RRC is 6 dB, and the L1-RSRP corresponding to SSB #1 in the measurement resource set is higher than the L1-RSRP corresponding to the CSI-RS associated with/corresponding to the TCI state by 4 dB, at this time, the L1-RSRP corresponding to the CSI-RS needs to be scaled according to powerControlOffsetSS (for example, 3 dB). After scaling, the L1-RSRP corresponding to SSB #1 is higher than the L1-RSRP corresponding to the CSI-RS associated with/corresponding to the TCI state by 7 dB, which is higher than the threshold, so the first UL channel or the first UL signal may be triggered. This method may cause the transmission power of CSI-RS and SSB the same through corresponding scaling operation while comparing the L1-RSRPs among different types of reference signals (for example, CSI-RS and SSB), thus ensuring the accuracy of the comparison result and improving the reliability of the communication system.

The first UL channel or the first UL signal is transmitted when at least one of the following conditions is satisfied:
Condition 1: the difference between the measured L1-RSRP corresponding to at least one same reference signal in the resource set in each of the latest consecutive Y_{win} measurement windows (earlier/no later than the first UL channel or the first UL signal) and the measured L1-RSRP corresponding to the reference signal associated with/corresponding to the indicated TCI state is greater than or equal to T_thr. Y_{win} and/or T_thr is configured by RRC, or Y_{win} is predefined (for example, Y_{win} is 1 or 2). The indicated TCI state refers to the indicated TCI state used/applied in the slot where the first UL channel or the first UL signal is located.
Condition 2: the difference between the measured L1-RSRP corresponding to at least one same reference signal in the resource set in each of the latest consecutive Y_{win} measurement windows (with X_eva symbols being earlier than the first symbol of the first UL channel or the first UL signal) and the measured L1-RSRP corresponding to the reference signal associated with/corresponding to the indicated TCI state is greater than or equal to T_thr. Optionally, Y_{win} and/or T_thr are configured by RRC. Optionally, Y_{win} is predefined (for example, Y_{win} is 1 or 2). Optionally, X_eva may be configured by RRC, or predefined, or based on the UE capability. The indicated TCI state refers to the indicated TCI state used/applied in the slot where the first UL channel or the first UL signal is located.
The UE receives/detects feedback for the first UL channel (or, the first UL signal). The feedback may be one of PDCCH and PDSCH. The PDCCH corresponds to/is associated with DCI format 0_1 or 0_2.
The UE transmits the second UL channel. The second UL channel carries the CSI/CSI report associated with the CSI reporting configuration.

The time domain position of the second UL channel is determined based on the feedback for the first UL channel (or the first UL signal).

The time domain position of the second UL channel is determined based on the first UL channel or the first UL signal. The slot offset between the second UL channel and the first UL channel/first UL signal is predefined, or based on the indication of the base station or based on the UE capability. For example, the slot offset is configured by the CSI reporting configuration.

The UE is not expected to measure channel/interference on the CSI-RS/SSB. The last symbol of the CSI-RS/SSB is received up to Z′ symbols before transmission time of the first symbol of the CSI reporting on the second UL channel.

The UE may be indicated by the base station whether to report the reference signal information (for example, CRI/SSBRI) associated with the indicated TCI state and/or the corresponding L1-RSRP. Optionally, when the UE is indicated to report the reference signal information associated with the indicated TCI state, the UE reports the reference signal resource associated with the indicated TCI state and/or the CSI associated with the reference signal resource associated with/corresponding to the resource set for channel measurement in one report instance. The CSI includes CRI/SSBRI and/or (corresponding) L1-RSRP. The size of the CSI field corresponding to CRI/SSBRI may be determined based on K. For example, the size of the CSI field corresponding to CRI/SSBRI is equal to ┌log₂ (K+1)┐. The value of CRI/SSBRI is k (k≥0). Optionally, CRI/SSBRI k corresponds to the k+1-th resource configured in the resource set. Optionally, when the value of CRI/SSBRI is equal to the size of the resource set (for example, k=K), the CRI/SSBRI corresponds to the reference signal associated with/corresponding to the indicated TCI state (or the resource corresponding to the reference signal associated with/corresponding to the indicated TCI state). This method clarifies the reporting method for the beam associated with the indicated TCI state, such that the base station may obtain the measurement of the current beam indicated by the UE, facilitating the scheduling of the base station and improving the flexibility of the communication system. In addition, because the indicated TCI state may be different at different time points, it is necessary to clarify that which time point the reported information associated with the indicated TCI state is based on/for. The indicated TCI state associated with the CSI included in the CSI report on the second UL channel may be the indicated TCI state applied by/used by/corresponding to/associated with the slot where the CSI reference resource corresponding to the CSI report is located. The indicated TCI state associated with the CSI included in the CSI report on the second UL channel may be the indicated TCI state applied by/used by/corresponding to/associated with the slot where the first UL channel/first UL signal is located. The indicated TCI state associated with the CSI included in the CSI report on the second UL channel may be the indicated TCI state applied by/used by/corresponding to/associated with the slot where the feedback for the first UL channel/first UL signal is located; or the TCI state indicated by the feedback for the first UL channel/the first UL signal. The indicated TCI state associated with the CSI included in the CSI report on the second UL channel may be the indicated TCI state applied/indicated TCI state used/corresponding indicated TCI state/associated indicated TCI state before the first UL channel/first UL signal; or the TCI state indicated by the feedback for the first UL channel/the first UL signal. The above methods clarify the time points corresponding to the information associated with the indicated TCI state associated with the reported CSI, ensures that the UE and the base station have the same understanding of the indicated TCI state, and improves the reliability of the communication system.

The CSI report on the second UL channel includes the CSI (for example, CRI/SSBRI and/or L1-RSRP) associated with the reference signal resource. The reference signal satisfies at least one of the following conditions/features:
Condition 1/Feature 1: the difference between the measured L1-RSRP corresponding to the reference signal in each of the latest consecutive Y_{win} measurement windows (earlier/no later than the first UL channel or the first UL signal) and the measured L1-RSRP corresponding to the reference signal associated with/corresponding to the indicated TCI state is greater than or equal to T_thr. Optionally, Y_{win} and/or T_thr are configured by RRC. Optionally, Y_{win} is predefined (for example, 1 or 2). The indicated TCI state refers to the indicated TCI state used/applied in the slot where the first UL channel or the first UL signal is located.
Condition 2/Feature 2: the difference between the measured L1-RSRP corresponding to the reference signal resource in each of the latest consecutive Y_{win} measurement windows (with X_eva symbols being earlier than the first symbol of the first UL channel or the first UL signal) and the measured L1-RSRP corresponding to the resource associated with/corresponding to the indicated TCI state is greater than or equal to T_thr. Optionally, Y_{win} and/or T_thr are configured by RRC. Optionally, Y_{win} is predefined (for example, 1 or 2). Optionally, X_eva may be configured by RRC or predefined. The indicated TCI state refers to the indicated TCI state used/applied in the slot where the first UL channel or the first UL signal is located.

The procedure/method associated with CSI processing unit (CPU) are described below. The UE indicates the number of supported simultaneous CSI calculations N_{CPU} with parameter simultaneousCSI-ReportsPerCC in a component carrier, and simultaneous (SI-ReportsAllCC across all component carriers.

The UE supporting N_{CPU} parallel CSI computations refers to the UE has N_{CPU} CSI processing units for processing the CSI report(s). If a UE supports N_{CPU} simultaneous CSI computations it is said to have N_{CPU} CSI processing units for processing CSI reports. If L CPUs are occupied for computation of CSI reports in a given OFDM symbol, the UE has N_{CPU}−L unoccupied CPUs.

If N CSI reports start occupying their respective CPUs on the same OFDM symbol on which N_{CPU}−L CPUs are unoccupied, where each CSI report n=0, . . . , N−1 corresponds to O_{CPU} (n), the UE is not required to update the N-M requested CSI reports with lowest priority, where 0≤M≤N is the largest value such that Σₙ₌₀^{M-1}O_{CPU}(n)≤N_{CPU}−L holds. Processing of a CSI report (e.g., the CSI report corresponding to the CSI reporting configuration) occupies a number of CPUs on time domain resource(s).

In order for the base station to manage the CSI computing resources of the UE, the time domain resource(s) on which the CSI report on the second UL occupies the CSI processing units (CPUs) need to be clarified. Methods provided below may define the time domain resource(s) on which the CSI report on the second UL occupies the CPUs, such that the UE and the base station have the same understanding of the CPU occupation and improve the reliability of the communication system. The time domain resource(s) on which the CSI report on the second UL occupies the CPUs may be a number of OFDM symbols or a number of slots.
The time domain resource(s) on which the CSI report on the second UL occupies the CPUs may be determined based on at least one of the first UL channel/first UL signal, feedback for the first UL channel/first UL signal and the reference signal resource (for example, the reference signal resource in the resource set).

Optionally, if the UE receives or detects the feedback for the first UL channel/the first UL signal, the starting point of the time domain resource(s) on which the CSI report on the second UL occupies the CPUs is based on the time resources after the feedback (for example, the first symbol/earliest symbol/first slot/earliest slot after the feedback, or the first symbol/earliest symbol/first slot/earliest slot after the last symbol of the feedback, or the first symbol/earliest symbol/first slot/earliest slot overlapped with the last symbol of the feedback).

The starting point of the time domain resource(s) on which the CSI report on the second UL occupies the CPUs may be determined based on the first UL channel/first UL signal. Because the base station needs certain time to decode after receiving the first UL channel/first UL signal, in some cases, the base station may only know that the UE will generate/transmits the CSI report on the second channel after a certain interval of the first UL channel/first UL signal. Therefore, the CSI report needs to start occupying CPUs after the certain interval of the first UL channel and the first UL signal, otherwise the base station may not know the use of CPU resources by the UE. Following methods may reserve enough time for the demodulation of the base station, ensure that the base station and UE have the consistent understanding of the time of the CPUs occupied by the CSI report on the second UL channel, and ensure the reliability of the communication system. The CSI report on the second channel occupies the CPUs from the first symbol (starting) after X symbols of the last symbol of the first UL channel/first UL signal. Here, the last symbol of the first UL channel/first UL signal is referred to as a UL ending symbol. The first symbol/earliest symbol occupied by the CSI report on the second channel is referred to as a CPU starting symbol.
The CPU starting symbol is the first symbol after at least X symbols of the UL ending symbol. Optionally, the first symbol after at least X symbols of the UL ending symbol may be called a first reference symbol. The subcarrier spacing corresponding to/associated with the first symbol is based on/equal to: the subcarrier spacing of the second UL channel, or the subcarrier spacing of the first UL channel, or the greater/lesser subcarrier spacing between the subcarrier spacing of the first UL channel and the subcarrier spacing of the second UL channel. The subcarrier spacing corresponding to/associated with X symbols is based on/equal to: the subcarrier spacing of the second UL channel, or the subcarrier spacing of the first UL channel, or the greater/lesser subcarrier spacing between the subcarrier spacing of the first UL channel and the subcarrier spacing of the second UL channel. Since the first UL channel and the second UL channel may be in different CCs, above methods may clearly determine the subcarrier spacing on which the CPU starting symbol is based, such that the base station and the UE have the same understanding and improve the reliability of the communication system.
The symbol offset between the CPU starting symbol and the UL ending symbol is X symbols. Optionally, the symbol with the symbol offset of X symbols from the UL ending symbol may be referred as the first reference symbol. For example, the UL ending symbol is at symbol n, and the CPU starting symbol is at symbol n+X. The subcarrier spacing corresponding to/associated with at least one of X, symbol n, symbol n+X and CPU starting symbol is based on the subcarrier spacing of the second UL channel, or the subcarrier spacing of the first UL channel, or the greater/lesser subcarrier spacing between the subcarrier spacing of the first UL channel and the subcarrier spacing of the second UL channel. Because the first UL channel and the second UL channel may be in different CCs, above methods may clearly determine the subcarrier spacing on which the CPU starting symbol is based, such that the base station and the UE have the same understanding and improve the reliability of the communication system.
The CPU starting symbol is the first/earliest symbol whose starting is no earlier than (the starting/ending of) the symbol n+X. The CPU starting symbol is the first/earliest symbol whose starting is no earlier than (the starting/ending of) the symbol n+X+1. The subcarrier spacing corresponding to/associated with symbol n (and/or symbol n+1 and/or symbol n+X+1 and/or X) is the subcarrier spacing of the first UL channel. Optionally, the first/earliest symbol whose starting is no earlier than (the starting/ending of) the symbol n+X or the first/earliest symbol whose starting is no earlier than (the starting/ending of) the symbol n+X+1 may be called the first reference symbol. The subcarrier spacing corresponding to/associated with the CPU starting symbol (or the first/earliest symbol) is the subcarrier spacing of the second UL channel.
The value of X may be at least one of 1, 2, 4, 7, 14, 28, 42, 56, 70, 84, 98, 112, 224 and 336. Optionally, X may be predefined. Optionally, X may be indicated by the base station, for example, indicated/configured by the base station via the CSI reporting configuration. Optionally, when the base station does not configure/indicate X, the value of X is 0. Optionally, X may be based on the UE capability. For example, X is indicated by the reported UE capability signaling.

The starting point of the time domain resource(s) on which the CSI report on the second UL occupies the CPUs may be determined based on the first UL channel/first UL signal and the reference signal resource (for example, the resources in the resource set and/or the reference signal/reference signal resource associated with/corresponding to the indicated TCI state). The starting point of the time domain resource(s) on which the CSI report on the second UL occupies the CPUs may be determined based on the first reference symbol and a second reference symbol. Refer above for the description of the first reference symbol. The second reference symbol is determined based on the reference signal resource (e.g., the resource in the resource set and/or the reference signal/reference signal resource associated with/corresponding to the indicated TCI state). The time domain resource(s) on which the CSI report on the second UL occupies the CPUs starts from the later/earlier one of the first reference symbol and the second reference symbol. The starting symbol of the time domain resource(s) on which the CSI report on the second UL occupies the CPUs is the later/earlier one of the first reference symbol and the second reference symbol. This scheme considers the influence of the reference signal measurement on the CPU occupation time, such that the UE and the base station have accurate and same understanding of the CPU occupation time of the CSI report carried on the second channel, thus improving the reliability of the communication system.
The second reference symbol is determined based on the CSI reference resource corresponding to the CSI report and the reference signal resource (in the resource set and associated with/corresponding to the indicated TCI state). For example, the second reference symbol is the first symbol of the earliest reference signal resource (in the resource set and associated with/corresponding to the indicated TCI state) in the latest transmission occasion no later than the CSI reference resource. For example, the second reference symbol is the first symbol of the earliest reference signal resource (in the resource set and/or in the reference signal resource associated with the indicated TCI state) in the latest transmission occasion no later than the CSI reference resource. For example, the second reference symbol is the first symbol of the earliest reference signal resource (in the resource set and associated with/corresponding to the indicated TCI state) in the latest transmission occasion no later than the CSI reference resource corresponding to the reference signal resource (in the resource set and associated with/corresponding to the indicated TCI state).
The ending point of the time domain resource(s) on which the CPUs are occupied is determined based on the second UL channel. For example, the CSI report on the second UL channel occupies the CPUs until the last symbol/first symbol of the second UL channel. For example, the CSI report on the second UL channel occupies the CPUs until the last slot/first slot of the second UL channel. The subcarrier spacing corresponding to/associated with the last symbol/first symbol of the second UL channel is based on/equal to the subcarrier spacing of the second UL channel, or the subcarrier spacing of the first UL channel, or the greater/lesser subcarrier spacing in the subcarrier spacing of the first UL channel and the subcarrier spacing of the second UL channel.

The subcarrier spacing of the first UL channel/first UL signal refers to the subcarrier spacing of the (active) UL BWP that transmits the first UL channel/first UL signal. The subcarrier spacing of the second UL channel refers to the subcarrier spacing of the (active) UL BWP that transmits the second UL channel.

In order for the base station to manage the CSI computing resources of the UE, the number of CSI Processing Units (CPUs) occupied by the CSI report on the second UL needs to be clarified. The number (for example, O_{CPU}) of CPUs occupied by the CSI report on the second UL channel is predefined. For example, O_{CPU}=1 or 2. The number (for example, O_{CPU}) of CPUs occupied by the CSI report on the second UL channel is based on the UE capability. For example, O_{CPU}=X_{cap}. Here, X_{cap} represents a parameter associated with the number of CPUs occupied by the CSI report on the second UL channel. Optionally, X_{cap} is determined based on the reported UE capability information. The value of X_{cap} may be one of 1, 2, 3 and 4. The number (for example, O_{CPU}) of CPUs occupied by the CSI report on the second UL channel is indicated/configured by the base station. The method provided above may specify the number of CPUs occupied by the CSI report on the second UL channel, such that the UE and the base station have the same understanding of CPU occupation, thus improving the reliability of the communication system.

The time domain position of the second UL channel is determined based on (the last symbol of) the first UL channel/first UL signal and/or Y. Y is based on X, Y≥X, Y and X may be the same parameters, or Y is Configured by RRC or predefined. The second UL channel is the closest UL channel (e.g., the closest in time domain, or the closest in time domain from the first UL channel) satisfying at least one of the following conditions:
The serving cell/CC where the second UL channel is located is the serving cell/CC determined based on the first UL channel/first UL signal;
The offset between the slot where the second UL channel is located and the slot where the first UL channel/first UL signal is located is greater than or equal to Y; or the symbol offset between the first symbol of the second UL channel and the last symbol of the first UL channel/first UL signal is greater than or equal to Y;
The slot number of the slot where the second UL channel is located satisfies (N_frame_slot*n_sfn+n_slot−T_{offset}) mod T_{CSI}, where N_frame_slot is the number of slots in a frame, n_sfn is the system frame number, n_slot is the slot number in a frame, T_{offset} is the slot offset, and T_{CSI} represents the periodicity. T_{offset} may be predefined or configured by the base station. T_{CSI} may be predefined or configured by the base station. N_frame_slot is the number of slots in a frame for the subcarrier spacing of the second UL channel. The n_slot is the slot number in a frame for the subcarrier spacing of the second UL channel;
The second UL channel does not overlap with a DL symbol. The DL symbol may be a DL symbol configured by higher layer signaling;
The second UL channel symbol offset in the slot where the second UL channel is located is equal to a specific value or one of one or more specific values. The second UL channel symbol offset refers to the symbol offset between the starting symbol of the second UL channel and the first symbol in the slot where the second UL channel is located. The value of the symbol offset is ranged from 0 to 13. The one or more specific values may be predefined. The one or more specific values may be indicated by the base station (for example, configured by the CSI reporting configuration).

The above method may reduce the time separation between the second UL channel and the first UL channel/first UL signal, reducing the delay of UL transmission and improving the performance of the communication system.

A procedure/method associated with the CSI reference resource corresponding to/associated with the CSI report (for example, the CSI report on the second UL channel) will be described below.

The slot where the CSI report (for example, the CSI report on the second UL channel) is located may be the UL slot n′. In time domain, the CSI reference resource corresponding to the CSI report (for example, the CSI report on the second UL channel) is defined as single

$$DL slot n - {n}_{CSI \_ ref} - {K}_{offset} \cdot \frac{{2}^{μ} DL}{{2}^{{μ}_{{K}_{offset}}}}$$

or a DL n−n_{CSI_ref}. K_{offset} is a parameter configured by higher-layer, and μ_{K}_{_{offset}} is the subcarrier spacing configuration of parameter μ_{K}_{_{offset}}. In frequency range 1 (FR1), the value of μ_{K}_{_{offset}} is 0 or the value of K_{offset} is 0. For example, K_{offset}=K_{cell,offset}−K_{UE,offset}, where K_{cell,offset} may be configured by a higher-level parameter (e.g., cellSpecificKoffset) and/or K_{UE,offset} may be indicated by a MAC-CE command (e.g., by a MAC-CE indicating a differential K_{offset}); otherwise, if not respectively provided, K_{cell,offset}=0 or

$${K}_{UE , offset} = 0.$$

$$n = ⌊ {n}^{′} \cdot \frac{{2}^{{μ}_{DL}}}{{2}^{{μ}_{UL}}} ⌋ + ⌊ ( \frac{{N}_{slot , offset , UL}^{CA}}{{2}^{{μ}_{offset , UL}}} - \frac{{N}_{s lot , offset , DL}^{CA}}{{2}^{{μ}_{offset , DL}}} ) \cdot {2}^{{μ}_{DL}} ⌋ ,$$

where μ_{DL} and μ_{UL} are subcarrier spacing configurations for DL and UL, respectively, (for a cell transmitting UL and DL) N_{slot,offset}^{CA} and μ_{offset} are determined based on a parameter (for example, ca-SlotOffset) configured by higher-layer. Methods for determining the CSI reference resource (for example, the CSI reference resource corresponding to the CSI report on the second UL channel) will be described in detail below.

Method 1: the CSI reference resource corresponding to the CSI report on the second UL channel is determined based on the slot associated with the first UL channel (or the first UL signal). The CSI reference resource corresponding to the CSI report on the second UL channel is in the latest valid DL slot no later than the slot associated with the first UL channel (or the first UL signal). The slot associated with the first UL channel (or the first UL signal) refers to the DL slot determined based on the UL slot where the first UL channel (or the first UL signal) is located. The UL slot where the first UL channel (or the first UL signal) is located may be the UL slot n″. For example, the slot associated with the first UL channel (or the first UL signal) is:

$$DL slot ⌊ {n}^{″} \cdot \frac{{2}^{μ} DL}{{2}^{μ} UL} ⌋ ,$$

$$or DL slot ⌈ {n}^{″} \cdot \frac{{2}^{μ} DL}{{2}^{μ} UL} ⌉ or DL slot ⌊ {n}^{″} \cdot \frac{{2}^{μ} DL}{{2}^{μ} UL} ⌋ + K 1 ,$$

$$or DL slot ⌈ {n}^{″} \cdot \frac{{2}^{μ} DL}{{2}^{μ} UL} ⌉ + K 1.$$

K1 may be predefined or configured by the base station or based on the UE capability. The value of K1 may be one of −2, −1, 0, 1 and 2. K1 may be based on/equal to

$$⌊ ( \frac{{N}_{slot , offset , UL}^{CA}}{{2}^{{μ}_{offset , UL}}} - \frac{{N}_{s lot , offset , DL}^{CA}}{{2}^{{μ}_{offset , DL}}} ) \cdot {2}^{{μ}_{DL}} ⌋ .$$

Below is described by taking the slot associated with the first UL channel (or the first UL signal) being the

$$DL slot ⌊ {n}^{″} \cdot \frac{{2}^{μ} DL}{{2}^{μ} UL} ⌋$$

as an example. Herein,

$$⌊ {n}^{″} \cdot \frac{{2}^{μ} DL}{{2}^{μ} UL} ⌋$$

may be interchangeable with

$$⌈ {n}^{″} \cdot \frac{{2}^{μ} DL}{{2}^{μ} UL} ⌉ , or ⌊ {n}^{″} \cdot \frac{{2}^{μ} DL}{{2}^{μ} UL} ⌋ + K 1 , or ⌈ {n}^{″} \cdot \frac{{2}^{μ} DL}{{2}^{μ} UL} ⌉ + K 1.$$

The CSI reference resource corresponding to the CSI report on the second UL channel is on the latest valid DL slot no later than the

$$DL slot ⌊ {n}^{″} \cdot \frac{{2}^{μ} DL}{{2}^{μ} UL} ⌋ .$$

The UE determines a specific value (e.g., minimum value/maximum value) of n_{CSI_ref}, wherein the specific value such that the CSI reference resource is in a valid DL slot no later than the

$$DL slot ⌊ {n}^{″} \cdot \frac{{2}^{μ} DL}{{2}^{μ} UL} ⌋ ,$$

or the specific value such that the slot n−n_{CSI,ref} is in a valid DL slot no later than the

$$DL slot ⌊ {n}^{″} \cdot \frac{{2}^{μ} DL}{{2}^{μ} UL} ⌋ .$$

The UE determines a specific value (for example, the minimum value greater than

$$⌊ {n}^{′} \cdot \frac{{2}^{μ} DL}{{2}^{μ} UL} ⌋ - ⌊ {n}^{″} \cdot \frac{{2}^{μ} DL}{{2}^{μ} UL} ⌋ ,$$

or greater than

$$n - ⌊ {n}^{″} \cdot \frac{{2}^{μ} DL}{{2}^{μ} UL} ⌋ ) of n - {n}_{CSI \_ ref} ,$$

wherein the specific value such that the CSI reference resource is in a valid DL slot, or the specific value such that the slot n−n_{CSI,ref} is in a valid DL slot. The μ_{UL} may be the subcarrier spacing configuration of the first UL channel (or, the first UL signal or may be the DL subcarrier spacing configuration. Since the CSI report is determined based on the measurement of the CSI reference resource no later than the first UL channel, this method may cause the CSI on the second UL channel to be determined based on measurement of the first UL channel or measurement before the first UL channel, prevent the channel change between the first UL channel and the second UL channel from affecting the result of the CSI report, such that the UE and the base station have the same understanding on the measurement on which the CSI report is based, thus improving the reliability of the communication system.

Method 2: the CSI reference resource corresponding to the CSI report on the second UL channel is determined based on a parameter associated with delay requirement and/or based on the UE capability and/or based on the first UL channel (or the first UL signal). The slot where the second UL channel is located is the UL slot n′. The slot associated with the second UL channel may be the DL slot n. The slot (e.g., DL slot or valid DL slot) corresponding to the CSI reference resource is based on n_{CSI_ref} or n−n_{CSI_ref}. The n_{CSI_ref} may be a value greater than or equal to X_{ref}, may be a minimum value/maximum value (for example, an integer value) greater than or equal to X_{ref} such that the slot n−n_{CSI,ref} corresponds to a DL slot (for example, a valid DL slot), or may be a minimum value/maximum value (for example, an integer value) greater than or equal to X_{ref} such that the CSI reference resource corresponds to a DL slot (for example, a valid DL slot). X_{ref} may be based on a parameter (for example, Z or Z′) associated with delay requirement. X_{ref} may be based on/equal to a parameter (for example, Z′₁ or Z′₃) associated with delay requirement. X_{ref} may be based on/equal to a parameter (for example, Z₁ or Z₃) associated with delay requirement. Below is described by taking the parameter associated with delay requirement being Z′₃ as an example to describe. Z′₃ may be based on the (reported) UE capability (e.g., beamReportTiming). X_{ref} may be based on or equal to └Z′₃/N_{symb}^{slot}┘ or └Z′₃/N_{symb}^{slot}┘. The CSI reference resource is determined by Z′₃, which enables UEs with different capabilities to determine the CSI reference resource based on corresponding hardware capability, thus improving the flexibility of UE hardware. N_{symb}^{slot} represents the number of symbols per slot/a slot. X_{ref} may be based on the UE capability. For example, the UE indicates/reports the value of X_{ref} via capability signaling. For example, the UE indicates/reports the value of X′ via capability signaling, and X_{ref} may be based on or equal to └X′/N_{symb}^{slot}┘ or ┌X′/N_{symb}^{slot}┐ may be based on or equal to

$$⌊ {n}^{′} \cdot \frac{{2}^{μ} DL}{{2}^{μ} UL} ⌋ - ⌊ {n}^{″} \cdot \frac{{2}^{μ} DL}{{2}^{μ} UL} ⌋ .$$

X_{ref} may be based on or equal to

$$n - ⌊ {n}^{″} \cdot \frac{{2}^{μ} DL}{{2}^{μ} UL} ⌋ .$$

X_{ref} may be based on or equal to the greater/lesser value between

$$⌊ {n}^{′} \cdot \frac{{2}^{μ} DL}{{2}^{μ} UL} ⌋ - ⌊ {n}^{″} \cdot \frac{{2}^{μ} DL}{{2}^{μ} UL} ⌋$$

and └X′/N_{symb}^{slot}┘, for example,

$$max ( ⌊ {n}^{′} \cdot \frac{{2}^{μ} DL}{{2}^{μ} UL} ⌋ - ⌊ {n}^{″} \cdot \frac{{2}^{μ} DL}{{2}^{μ} UL} ⌋ , ⌊ {X}^{′} / {N}_{symb}^{slot} ⌋ ) or$$

$$min ( ⌊ {n}^{′} \cdot \frac{{2}^{μ} DL}{{2}^{μ} UL} ⌋ - ⌊ {n}^{″} \cdot \frac{{2}^{μ} DL}{{2}^{μ} UL} ⌋ , ⌊ {X}^{′} / {N}_{symb}^{slot} ⌋ ) .$$

└X′/N_{symb}^{slot}┘). X_{ref} may be based on or equal to the greater/lesser value between

$$⌊ {n}^{′} \cdot \frac{{2}^{μ} DL}{{2}^{μ} UL} ⌋ - ⌊ {n}^{″} \cdot \frac{{2}^{μ} DL}{{2}^{μ} UL} ⌋$$

and └Z′₃/N_{symb}^{slot}┘, for example,

$$max ( ⌊ {n}^{′} \cdot \frac{{2}^{μ} DL}{{2}^{μ} UL} ⌋ - ⌊ {n}^{″} \cdot \frac{{2}^{μ} DL}{{2}^{μ} UL} ⌋ ,$$

└Z′₃/N_{symb}^{slot}┘ and

$$min ( ⌊ {n}^{′} \cdot \frac{{2}^{μ} DL}{{2}^{μ} UL} ⌋ - ⌊ {n}^{″} \cdot \frac{{2}^{μ} DL}{{2}^{μ} UL} ⌋ ,$$

└Z′₃/N_{symb}^{slot}┘). X_{ref} may be based on or equal to

$$n - ⌊ {n}^{″} \cdot \frac{{2}^{μ} DL}{{2}^{μ} UL} ⌋ .$$

X_{ref} may be based on or equal to the greater/lesser value between

$$n - ⌊ {n}^{″} \cdot \frac{{2}^{μ} DL}{{2}^{μ} UL} ⌋$$

and └X′/N_{symb}^{slot}┘, for example,

$$max ( n - ⌊ {n}^{″} \cdot \frac{{2}^{μ} DL}{{2}^{μ} UL} ⌋ , ⌊ {X}^{′} / {N}_{symb}^{slot} ⌋ ) or min ( n - ⌊ {n}^{″} \cdot \frac{{2}^{μ} DL}{{2}^{μ} UL} ⌋ , ⌊ {X}^{′} / {N}_{symb}^{slot} ⌋ ) .$$

X_{ref} may be example, based on or equal to the greater/lesser value between

$$n - ⌊ {n}^{″} \cdot \frac{{2}^{μ} DL}{{2}^{μ} UL} ⌋$$

and └Z′₃/N_{symb}^{slot}┘, for example,

$$max ( n - ⌊ {n}^{″} \cdot \frac{{2}^{μ} DL}{{2}^{μ} UL} ⌋ , ⌊ {Z}_{3}^{′} / {N}_{symb}^{slot} ⌋ ) or min ( n - ⌊ {n}^{″} \cdot \frac{{2}^{μ} DL}{{2}^{μ} UL} ⌋ , ⌊ {Z}_{3}^{′} / {N}_{symb}^{slot} ⌋ ) .$$

X_{ref} may be based on or equal to the maximum/minimum value of at least one of

$$n - ⌊ {n}^{″} \cdot \frac{{2}^{μ} DL}{{2}^{μ} UL} ⌋ , ⌊ {Z}_{3}^{′} / {N}_{symb}^{slot} ⌋ )$$

and └X′/N_{symb}^{slot}┘. The above methods take the slot corresponding to the earlier CSI reference resource, such that the UE may have as much time as possible to prepare the CSI report, which facilitates to reduce the hardware complexity of the UE. The above methods take the slot corresponding to the later CSI reference resource, such that the UE may determine the CSI report based on the later measurement of the reference signal, which facilitates to derive accurate CSI.

When the UL slot associated with the first UL channel and the UL slot associated with the second UL channel are the same (for example, when n″=n′), or when the UL slot associated with the first UL channel and the UL slot associated with the second UL channel overlap, the UE performs Method 1. When the DL slot

$$( e . g . , slot ⌊ {n}^{″} \cdot \frac{{2}^{μ} DL}{{2}^{μ} UL} ⌋ )$$

associated with the first UL channel and the DL slot

$$( e . g . , slot ⌊ {n}^{′} \cdot \frac{{2}^{μ} DL}{{2}^{μ} UL} ⌋ )$$

associated with the second UL channel are in the same DL slot, the UE performs Method 1. In this manner, the conditions to perform Method 1 are clarified, so that the base station and the UE have the same understanding of the conditions for the CSI reporting, thus improving the reliability of the communication system.

When the UL slot associated with the first UL channel and the UL slot associated with the second UL channel are different (for example, when n′ is not equal to n″), when the UL slot associated with the first UL channel and the UL slot associated with the second UL channel do not overlap, when the UL slot associated with the second UL channel is after the UL slot associated with the first UL channel, or when the DL slot associated with the second UL channel is after the DL slot associated with the first UL channel, the UE performs Method 2. When the DL slot

$$( e . g . , slot ⌊ {n}^{″} \cdot \frac{{2}^{μ} DL}{{2}^{μ} UL} ⌋ )$$

associated with the first UL channel and the DL slot

$$( e . g . , slot ⌊ {n}^{′} \cdot \frac{{2}^{μ} DL}{{2}^{μ} UL} ⌋ )$$

associated with the second UL channel are in different DL slots, the UE performs Method 2. In this manner, conditions to perform Method 2 are clarified, so that the base station and the UE have the same understanding of the conditions for the CSI reporting, thus improving the reliability of the communication system.

The method for determining the CSI reference resource may be the combination of Method 1 and Method 2. For the CSI report carried on the second UL channel, the UE may determine a first slot corresponding to the corresponding CSI reference resource through Method 1, and the UE may determine a second slot corresponding to the corresponding CSI reference resource through Method 2, and the UE may determine that the slot where the CSI reference resource corresponding to the CSI report carried on the second UL channel is located/corresponds is the earlier/later slot in the first slot and the second slot. For the CSI report carried on the second UL channel, the UE may determine the n_{CSI_ref} corresponding to the corresponding CSI reference resource through Method 1, and the UE may determine the n_{CSI,ref} corresponding to the corresponding CSI reference resource through Method 2, wherein the n_{CSI_ref} corresponding to the CSI reference resource is the greater/lesser value of the n_{CSI_ref} determined by Method 1 and the n_{CSI_ref} determined by Method 2. For example, for CSI report #a, the UE determines that the CSI reference resource corresponding to CSI report #a is in slot #5 through Method 1, and determines that the CSI reference resource corresponding to CSI report #a is in slot #7 through Method 2, then the CSI reference resource corresponding to CSI report #a is in slot #7 (for example, the UE takes the later slot). For example, for CSI report #a, the UE determines that the value of n_{CSI_ref} corresponding to the CSI reference resource corresponding to CSI report #a is 3 through Method 1, and that the value of n_{CSI_ref} corresponding to the CSI reference resource corresponding to CSI report #a is 5 through Method 2, then the value of n_{CSI_ref} corresponding to the CSI reference resource corresponding to CSI report #a is 3 (e.g., the UE takes the lesser value). By taking the slot corresponding to the earlier CSI reference resource through combination of Method 1 and Method 2 may cause the UE to have more time to prepare the CSI report, which facilitates to reduce the hardware complexity of the UE. By taking the slot corresponding to the later CSI reference resource through combination of Method 1 and Method 2 may cause the UE to determine the CSI report based on the later measurement of the reference signal, which facilitates to derive an accurate CSI.

Herein, the DL subcarrier spacing configuration may be the subcarrier spacing associated with the CSI report for measuring the (active) BWP of the reference signal. Herein, the DL subcarrier spacing configuration may be the subcarrier spacing associated with the CSI report for measuring the (active) BWP of the serving cell of the reference signal.

A slot in a serving cell may be considered as a valid DL slot if at least one of the following conditions is satisfied:

The slot includes at least one higher-layer configured DL or flexible symbol.

The slot does not fall within a configured measurement gap. The configured measurement gap is for the UE.

The above methods may define the CSI reference resource on which the CSI in the CSI report is based, such that the UE and base station have the same understanding of the CSI, thus improving the reliability of the communication system.

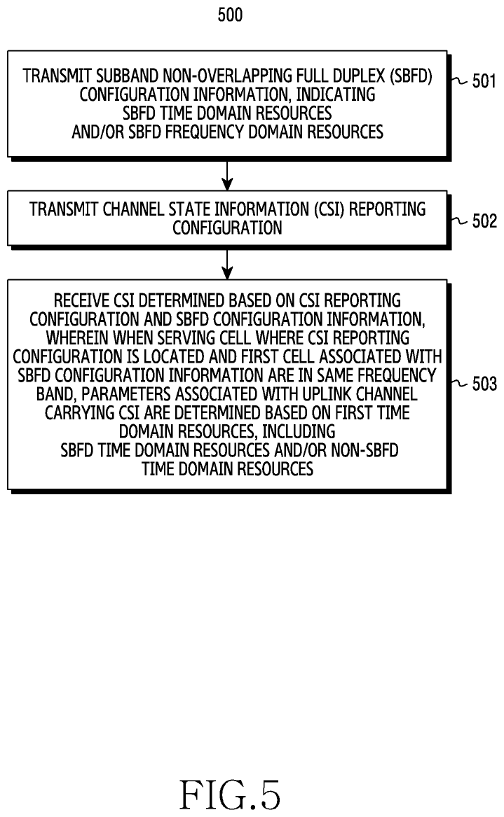

FIG. 5 illustrates a method 500 performed by a base station according to an embodiment. Referring to FIG. 5, in step 501, the base station transmits SBFD configuration information to a user equipment, wherein the SBFD configuration information indicates SBFD time domain resource(s) and/or SBFD frequency domain resource(s). In step 502, the base station transmits a CSI reporting configuration to the user equipment. In step 503, the base station receives, from the UE, CSI determined based on the CSI reporting configuration and the SBFD configuration information, wherein when a serving cell where the CSI reporting configuration is located and a first cell associated with the SBFD configuration information are in a same frequency band, parameters associated with a UL channel carrying the CSI are determined based on first time domain resource(s), wherein the first time domain resource(s) include the SBFD time domain resource(s) and/or the non-SBFD time domain resource(s).

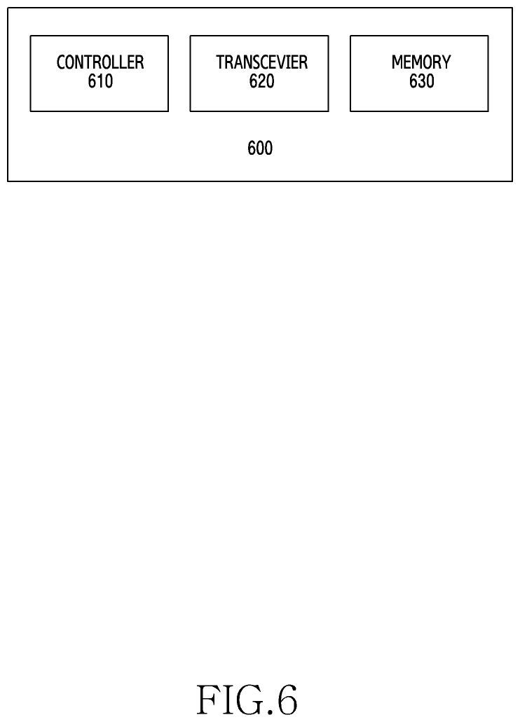

FIG. 6 illustrates a structure 600 of a UE according to an embodiment. Referring to FIG. 6, the UE 600 includes a controller 610, a transceiver 620 and a memory 630, wherein the controller 610 is configured to perform various methods disclosed herein and performed by the user equipment, and the transceiver 620 is configured to transceive channels or signals. Additionally, the components of the UE 600 are not limited thereto and may be fewer or more components than those described above. The controller 610 and the transceiver 620 and the memory 630 may be implemented as a single chip and may include at least one processor. The UE 600 may correspond to the UE of FIG. 3A, the controller 610 may correspond to a processor 340 of FIG. 3A, and the transceiver 620 may correspond to the RF transceiver 310 of FIG. 3A.

The transceiver 620 collectively refers to a UE receiver and a UE transmitter, and may transmit/receive a signal to/from a base station or a network entity. The signal transmitted or received to or from the base station or a network entity may include control information and data. The transceiver 620 may include a RF transmitter for up-converting and amplifying a frequency of a transmitted signal, and a RF receiver for amplifying low-noise and down-converting a frequency of a received signal. However, this is only an example of the transceiver 620 and components of the transceiver 620 are not limited to the RF transmitter and the RF receiver.

The transceiver 620 may receive and output, to the controller 610, a signal through a wireless channel, and transmit a signal output from the controller 610 through the wireless channel.

The memory 630 may store a program and data required for operations of the user equipment 600. Also, the memory 630 may store control information or data included in a signal obtained by the user equipment 600. The memory 630 may be a storage medium, such as a ROM, RAM, a hard disk, a CD-ROM, and a DVD, or a combination of storage media.

The controller 610 may control a series of controllers such that the UE 600 operates as described above. For example, the transceiver 620 may receive a data signal including a control signal transmitted by the base station or the network entity, and the controller 610 may determine a result of receiving the control signal and the data signal transmitted by the base station or the network entity.

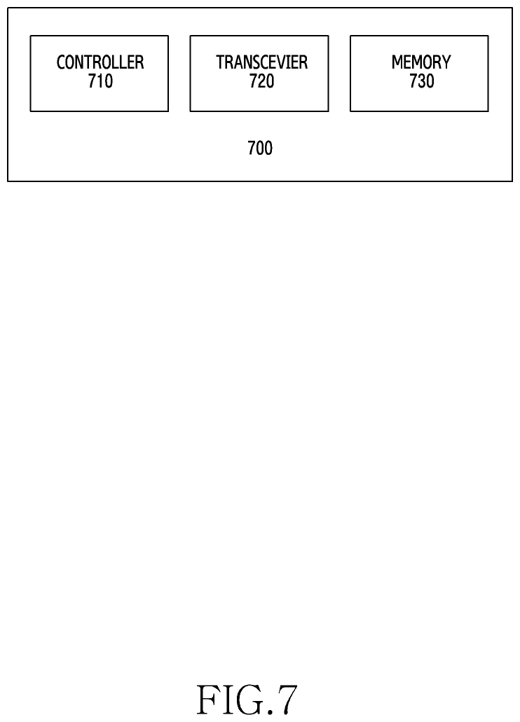

FIG. 7 illustrates a structure 700 of a base station according to an embodiment. Referring to FIG. 7, the network device 700 includes a controller 710, a transceiver 720 and a memory 730, wherein the controller 710 is configured to perform various methods performed by the network device as disclosed herein above, and the transceiver 720 is configured to transceive channels or signals. The base station 700 further includes a memory 730. Additionally, the components of the base station 700 are not limited thereto. For example, the base station 700 may include more or fewer components than those described above. The controller 710 and the transceiver 720 and the memory 730 may be implemented as a single chip and may include at least one processor.

The base station 700 may correspond to UE of FIG. 3B, the controller 710 may correspond to a processor 378 of FIG. 3B, and the transceiver 720 may correspond to the RF transceiver 372a-372n of FIG. 3B.

The transceiver 720 collectively refers to a base station receiver and a base station transmitter, and may transmit/receive a signal to/from a UE or a network entity. The signal transmitted or received to or from the UE or a network entity may include control information and data. The transceiver 720 may include a RF transmitter for up-converting and amplifying a frequency of a transmitted signal, and a RF receiver for amplifying low-noise and down-converting a frequency of a received signal. However, this is only an example of the transceiver 720 and components of the transceiver 720 are not limited to the RF transmitter and the RF receiver.

The transceiver 720 may receive and output, to the controller 710, a signal through a wireless channel, and transmit a signal output from the controller 710 through the wireless channel.

The memory 730 may store a program and data required for operations of the base station. Also, the memory 730 may store control information or data included in a signal obtained by the base station. The memory 730 may be a storage medium, such as read-only memory (ROM), random access memory (RAM), a hard disk, a CD-ROM, and a DVD, or a combination of storage media.

The controller 710 may control a series of processes such that the base station operates as described above. For example, the transceiver 720 may receive a data signal including a control signal transmitted by the UE, and the controller 710 may determine a result of receiving the control signal and the data signal transmitted by the UE.

As described above, disclosed herein is a method performed by UE in a wireless communication system, including receiving configuration information for subband non-overlapping full duplex SBFD, wherein the configuration information indicates SBFD time domain resource(s), and receiving a CSI reporting configuration, wherein when a serving cell where the CSI reporting configuration is located and a first cell associated with the configuration information are in the same frequency band, determining parameters associated with a UL channel for carrying CSI associated with the CSI reporting configuration based on first time domain resource(s), or when a serving cell where CSI resource setting associated with the CSI reporting configuration is located and the first cell are in the same frequency band, performing at least one of the following operations based on the first time domain resource(s): obtain measurement result based on reference signal resource associated with the CSI resource setting, do not receive the reference signal resource associated with the CSI resource setting, and determine and/or reporting the CSI associated with the CSI reporting configuration, wherein the first time domain resource(s) include the SBFD time domain resource(s) and/or non-SBFD time domain resource(s).

The first time domain resource(s) are determined based on at least one of the following: CSI trigger state associated with the CSI reporting configuration, a CSI reference resource corresponding to the CSI associated with the CSI reporting configuration, the UL channel for carrying the CSI associated with the CSI reporting configuration, a first parameter included in the CSI reporting configuration for indicating the first time domain resource(s), a MAC-CE for indicating the CSI reporting configuration.

When the UL channel is in the SBFD time domain resource(s), the first time domain resource(s) are SBFD time domain resource(s); or when the UL channel is in the non-SBFD time domain resource(s), the first time domain resource(s) are non-SBFD time domain resource(s); or when the UL channel is in the SBFD time domain resource(s) and the non-SBFD time domain resource(s), the first time domain resource(s) are the SBFD time domain resource(s) or the non-SBFD time domain resource(s).

When the CSI reference resource is in the SBFD time domain resource(s), the first time domain resource(s) are the SBFD time domain resource(s); or when the CSI reference resource is in the non-SBFD time domain resource(s), the first time domain resource(s) are the non-SBFD time domain resource(s); or when the CSI reference resource is in the SBFD time domain resource(s) and the non-SBFD time domain resource(s), the first time domain resource(s) are the SBFD time domain resource(s) or the non-SBFD time domain resource(s).

The CSI reporting configuration comprises a first group of parameters and a second group of parameters, when the UL channel is in the SBFD time domain resource(s), the parameters associated with the UL channel are the first group of parameters; or when the UL channel is in the non-SBFD time domain resource(s), the parameters associated with the UL channel are the second group of parameters; and wherein each group of parameters of the first group of parameters and the second group of parameters includes at least one of UL power control parameter(s), quasi-co-location QCL parameter(s), and a parameter associated with the resources corresponding to the UL channel.

Obtaining the measurement result based on the reference signal resource associated with the CSI resource setting includes when a channel measurement time domain restriction parameter or an interference measurement time domain restriction parameter included in the CSI reporting configuration is set to Configured, obtaining channel measurement result based on the reference signal resource associated with the CSI resource setting which are latest and no later than the CSI reference resource within the first time domain resource(s), or when the channel measurement time domain restriction parameter or the interference measurement time domain restriction parameter included in the CSI reporting configuration is set to notConfigured, obtaining the channel measurement result based on the reference signal resource associated with the CSI resource setting no later than the CSI reference resource within the first time domain resource(s).

Not receiving the reference signal resource associated with the CSI resource setting includes when the first time domain resource(s) are SBFD time domain resource(s) or the non-SBFD time domain resource(s), not receiving the reference signal resource associated with CSI resource settings outside the first time domain resource(s).

Reporting the CSI associated with the CSI reporting configuration includes when the first time domain resource(s) are the SBFD time domain resource(s) or the non-SBFD time domain resource(s), and the UE receives transmission occasion(s) for measurement in the first time domain resource(s), reporting the CSI associated with the CSI reporting configuration; or when the first time domain resource(s) include the SBFD time domain resource(s) and the non-SBFD time domain resource(s), and the UE receives transmission occasion(s) for measurement within the SBFD time domain resource(s), and the UE receives a transmission occasion for measurement outside the non-SBFD time domain resource(s), reporting the CSI associated with the CSI reporting configuration.

The transmission occasion(s) for measurement includes at least one transmission occasion for channel measurement and/or at least one transmission occasion for interference measurement.

When the first time domain resource(s) include the SBFD time domain resource(s) and the non-SBFD time domain resource(s), the CSI associated with the CSI reporting configuration includes CSI determined based on the SBFD time domain resource(s) and CSI determined based on the non-SBFD time domain resource(s).

Determining the CSI associated with the CSI reporting configuration includes determining the CSI associated with the CSI reporting configuration based on an assumption that the transmission occasion for measurement in the SBFD time domain resource(s) and the transmission occasion for measurement in the non-SBFD time domain resource(s) are not averaged.

The CSI reference resource corresponding to the CSI associated with the CSI reporting configuration is determined based on a valid DL slot. When at least one of the following conditions is satisfied, a first slot in one of the first cell, a cell in the same frequency band as the first cell, a cell where the CSI resource setting is located and a cell where the CSI reporting configuration is located is determined as the valid DL slot: the first time domain resource(s) are the SBFD time domain resource(s), and the first slot includes at least one symbol in the first time domain resource(s), and the first slot is not within a configured measurement gap for the UE, the first time domain resource(s) are the non-SBFD time domain resource(s), and the first slot includes at least one symbol in the first time domain resource(s) and at least one DL symbol or flexible symbol configured by a higher layer, and the first slot is not within the configured measurement gap for the UE, the first time domain resource(s) include the SBFD time domain resource(s) and the non-SBFD time domain resource(s), and the first slot includes at least one DL symbol or flexible symbol configured by a high layer, and the first slot is not within the configured measurement gap for the UE.

As described above, a method performed by a base station in a wireless communication system includes transmitting configuration information for subband non-overlapping full duplex SBFD, wherein the configuration information indicates SBFD time domain resource(s), transmitting a CSI reporting configuration, and receiving CSI determined based on the CSI reporting configuration and the configuration information, wherein when a serving cell where the CSI reporting configuration is located and a first cell associated with the configuration information are in a same frequency band, parameters associated with a UL channel for carrying CSI associated with the CSI reporting configuration is determined based on first time domain resource(s), wherein the first time domain resource(s) include the SBFD time domain resource(s) and/or non-SBFD time domain resource(s).

The illustrative logical blocks, modules, and circuits described in the disclosure may be implemented in a general-purpose processor, a digital signal processor (DSP), an application specific integrated circuit, ASIC), field programmable gate array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such Configuration.

The steps of a method or algorithm described in the disclosure may be embodied directly in hardware, in a software module executed by a processor, or in a combination of the two. Software modules may reside in RAM, flash memory, ROM, EPROM, EEPROM, registers, hard disks, removable disks, or any other form of storage media known in the art. A storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more exemplary designs, the described functions may be implemented in hardware, software, firmware, or any combination thereof. If implemented in software, each function may be stored on or transmitted by a computer-readable medium as one or more instructions or codes. Computer-readable media include both computer storage media and communication media, and the latter includes any media that facilitates the transfer of computer programs from one place to another. The storage medium may be any available medium that may be accessed by a general-purpose or special-purpose computer.

The description set forth herein, taken in conjunction with the drawings, describes example Configurations, methods and devices, and does not represent all examples that may be realized or are within the scope of the claims. As used herein, example indicates serving as an example, instance or illustration rather than preferred or superior to other examples. The detailed description includes specific details to provide an understanding of the described technology. However, these techniques may be practiced without these specific details. In some cases, well-known structures and devices are shown in block diagram form to avoid obscuring the concepts of the described examples.

Although this specification contains many specific implementation details, these should not be interpreted as limitations on any invention or the scope of the claimed protection, but as descriptions of specific features of specific embodiments of specific inventions. Some features described in this specification in the context of separate embodiments can also be combined in a single embodiment. On the contrary, various features described in the context of a single embodiment can also be implemented separately in a plurality of embodiments or in any suitable sub-combination. Although features may be described above as functioning in certain combinations, and even initially claimed as such, in some cases, one or more features may be deleted from the combination, and the combination may be directed to one or more subcombinations.

The order or hierarchy of steps in the method of the present disclosure is illustrative of an exemplary process. Based on design preferences, it can be understood that a specific order or hierarchy of steps in a method can be rearranged. Although elements may be described in the singular, the plural is also contemplated unless the limitation on the singular is explicitly stated. Therefore, the present disclosure is not limited to the illustrated examples.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by user equipment UE in a wireless communication system, the method comprising:
receiving configuration information for a subband non-overlapping full duplex (SBFD), the configuration information indicating SBFD time domain resources; and
receiving a channel state information (CSI) reporting configuration,
wherein, when a serving cell where the CSI reporting configuration is located and a first cell associated with the configuration information are in the same frequency band, parameters associated with an uplink (UL) channel for carrying CSI associated with the CSI reporting configuration are determined based on first time domain resources; or
wherein, when a serving cell where a CSI resource setting associated with the CSI reporting configuration is located and the first cell are in the same frequency band, at least one of the following operations is performed based on the first time domain resources:
obtain measurement result based on reference signal resource associated with the CSI resource setting;
do not receive the reference signal resource associated with the CSI resource setting; and
determine and/or reporting the CSI associated with the CSI reporting configuration, and
wherein the first time domain resources include the SBFD time domain resources and/or non-SBFD time domain resources.

2. The method of claim 1, wherein the first time domain resources are determined based on at least one of the following:
a CSI trigger state associated with the CSI reporting configuration,
a CSI reference resource corresponding to the CSI associated with the CSI reporting configuration,
the UL channel for carrying the CSI associated with the CSI reporting configuration,
a first parameter included in the CSI reporting configuration for indicating the first time domain resources, and
a media access control control element (MAC-CE) for indicating the CSI reporting configuration.

3. The method of claim 2, wherein
when the UL channel is in the SBFD time domain resources, the first time domain resources are SBFD time domain resources;
when the UL channel is in the non-SBFD time domain resources, the first time domain resources are non-SBFD time domain resources; or
when the UL channel is in the SBFD time domain resources and the non-SBFD time domain resources, the first time domain resources are the SBFD time domain resources or the non-SBFD time domain resources.

4. The method of claim 2, wherein
when the CSI reference resource is in the SBFD time domain resources, the first time domain resources are the SBFD time domain resources,
when the CSI reference resource is in the non-SBFD time domain resources, the first time domain resources are the non-SBFD time domain resources, or
when the CSI reference resource is in the SBFD time domain resources and the non-SBFD time domain resources, the first time domain resources are the SBFD time domain resources or the non-SBFD time domain resources.

5. The method of claim 3, wherein the CSI reporting configuration comprises a first group of parameters and a second group of parameters,
when the UL channel is in the SBFD time domain resources, the parameters associated with the UL channel are the first group of parameters, or
when the UL channel is in the non-SBFD time domain resources, the parameters associated with the UL channel are the second group of parameters; and
wherein each group of parameters of the first group of parameters and the second group of parameters includes at least one of UL power control parameters, quasi-co-location (QCL) parameters, and a parameter associated with the resources corresponding to the UL channel.

6. The method of claim 2, wherein obtaining the measurement result based on the reference signal resource associated with the CSI resource setting comprises:
when a channel measurement time domain restriction parameter or an interference measurement time domain restriction parameter included in the CSI reporting configuration is set to Configured, obtaining channel measurement result based on the reference signal resource associated with the CSI resource setting which are no later than the CSI reference resource within the first time domain resources, or
when the channel measurement time domain restriction parameter or the interference measurement time domain restriction parameter included in the CSI reporting configuration is set to notConfigured, obtaining the channel measurement result based on the reference signal resource associated with the CSI resource setting no later than the CSI reference resource within the first time domain resources.

7. The method of claim 1, wherein not receiving the reference signal resource associated with the CSI resource setting comprises:
when the first time domain resources are SBFD time domain resources or the non-SBFD time domain resources, the reference signal resource associated with CSI resource settings outside the first time domain resources are not received.

8. The method of claim 1, wherein reporting the CSI associated with the CSI reporting configuration comprises:
when the first time domain resources are the SBFD time domain resources or the non-SBFD time domain resources, and the UE receives transmission occasion(s) for measurement in the first time domain resources, the CSI associated with the CSI reporting configuration is reported; or
when the first time domain resources include the SBFD time domain resources and the non-SBFD time domain resources, and the UE receives transmission occasion(s) for measurement within the SBFD time domain resources, and the UE receives a transmission occasion for measurement outside the non-SBFD time domain resources, the CSI associated with the CSI reporting configuration is reported.

9. The method of claim 8, wherein the transmission occasion(s) for measurement includes at least one transmission occasion for channel measurement and/or at least one transmission occasion for interference measurement.

10. The method of claim 1, wherein when the first time domain resources include the SBFD time domain resources and the non-SBFD time domain resources, the CSI associated with the CSI reporting configuration includes CSI determined based on the SBFD time domain resources and CSI determined based on the non-SBFD time domain resources.

11. The method of claim 1, wherein the CSI associated with the CSI reporting configuration is determined based on the transmission occasion for measurement in the SBFD time domain resources and the transmission occasion for measurement in the non-SBFD time domain resources not being averaged.

12. The method of claim 2, wherein the CSI reference resource corresponding to the CSI associated with the CSI reporting configuration is determined based on a valid downlink (DL) slot,
wherein when at least one of the following conditions is satisfied, a first slot in one of the first cell, a cell in the same frequency band as the first cell, a cell where the CSI resource setting is located and a cell where the CSI reporting configuration is located is determined as the valid DL slot:
the first time domain resources are the SBFD time domain resources, the first slot includes at least one symbol in the first time domain resources, and the first slot is not within a configured measurement gap for the UE;
the first time domain resources are the non-SBFD time domain resources, the first slot includes at least one symbol in the first time domain resources and at least one DL symbol or flexible symbol configured by a higher layer, and the first slot is not within the configured measurement gap for the UE; and
the first time domain resources include the SBFD time domain resources the non-SBFD time domain resources, and the first slot includes at least one DL symbol or flexible symbol configured by a high layer, and the first slot is not within the configured measurement gap for the UE.

13. A method performed by a base station in a wireless communication system, the method comprising:
transmitting configuration information for a subband non-overlapping full duplex (SBFD), wherein the configuration information indicates SBFD time domain resources;
transmitting a channel state information (CSI) reporting configuration; and
receiving CSI determined based on the CSI reporting configuration and the configuration information,
wherein, when a serving cell where the CSI reporting configuration is located and a first cell associated with the configuration information are in a same frequency band, parameters associated with an uplink (UL) channel for carrying CSI associated with the CSI reporting configuration are determined based on first time domain resources, and
wherein the first time domain resources include the SBFD time domain resources and/or non-SBFD time domain resources.

14. The method of claim 13, wherein the first time domain resources are determined based on at least one of the following:
a CSI trigger state associated with the CSI reporting configuration,
a CSI reference resource corresponding to the CSI associated with the CSI reporting configuration,
the UL channel for carrying the CSI associated with the CSI reporting configuration, a first parameter included in the CSI reporting configuration for indicating the first time domain resources, and
a media access control control element (MAC-CE) for indicating the CSI reporting configuration.

15. The method of claim 14, wherein
when the UL channel is in the SBFD time domain resources, the first time domain resources are SBFD time domain resources;
when the UL channel is in the non-SBFD time domain resources, the first time domain resources are non-SBFD time domain resources; or
when the UL channel is in the SBFD time domain resources and the non-SBFD time domain resources, the first time domain resources are the SBFD time domain resources or the non-SBFD time domain resources.

16. The method of claim 14, wherein
when the CSI reference resource is in the SBFD time domain resources, the first time domain resources are the SBFD time domain resources;
when the CSI reference resource is in the non-SBFD time domain resources, the first time domain resources are the non-SBFD time domain resources; or
when the CSI reference resource is in the SBFD time domain resources and the non-SBFD time domain resources, the first time domain resources are the SBFD time domain resources or the non-SBFD time domain resources.

17. The method of claim 15, wherein the CSI reporting configuration includes a first group of parameters and a second group of parameters,
when the UL channel is in the SBFD time domain resources, the parameters associated with the UL channel are the first group of parameters; or
when the UL channel is in the non-SBFD time domain resources, the parameters associated with the UL channel are the second group of parameters; and
wherein each group of parameters of the first group of parameters and the second group of parameters includes at least one of UL power control parameters, quasi-co-location (QCL) parameters, and a parameter associated with the resources corresponding to the UL channel.

18. The method of claim 17,
wherein the CSI includes at least one of a CSI reference signal resource indicator, a rank indicator, a precoding matrix indicator, a channel quality indicator, a layer indicator (L1), a synchronization signal/physical broadcast channel resource indicator, a layer 1-reference signal received power, a layer 1-signal to interference and noise ratio, and a capability index.

19. A user equipment in a wireless communication system, comprising:
a transceiver; and
a controller coupled to the transceiver and configured to:
receive configuration information for a subband non-overlapping full duplex (SBFD), wherein the configuration information indicates SBFD time domain resources; and
receive a channel state information (CSI) reporting configuration, wherein when a serving cell where the CSI reporting configuration is located and a first cell associated with the configuration information are in the same frequency band, parameters associated with an uplink (UL) channel for carrying CSI associated with the CSI reporting configuration are determined based on first time domain resources; or
when a serving cell where CSI resource setting associated with the CSI reporting configuration is located and the first cell are in the same frequency band, at least one of the following operations is performed based on the first time domain resources:
obtain measurement result based on reference signal resource associated with the CSI resource setting;
do not receive the reference signal resource associated with the CSI resource setting; and
determine and/or report the CSI associated with the CSI reporting configuration, and
wherein the first time domain resources include the SBFD time domain resources and/or non-SBFD time domain resources.

20. A base station in a wireless communication system, comprising:
a transceiver; and
a controller coupled to the transceiver and configured to:
transmit configuration information for a subband non-overlapping full duplex (SBFD), wherein the configuration information indicates SBFD time domain resources;
transmit a channel state information (CSI) reporting configuration; and
receive the CSI determined based on the CSI reporting configuration and the configuration information,
wherein, when a serving cell where the CSI reporting configuration is located and a first cell associated with the configuration information are in a same frequency band, parameters associated with an uplink (UL) channel for carrying CSI associated with the CSI reporting configuration are determined based on first time domain resources, and
wherein the first time domain resources include the SBFD time domain resources and/or non-SBFD time domain resources.
